(19) United States
(12) Patent Application Publication
(10) Pub. No.: US 2013/0290198 A1
(43) Pub. Date: Oct. 31, 2013

(54) ESTATE AND LIFE EVENT ORGANIZATION AND MANAGEMENT SYSTEM

(71) Applicant: Lenore VASSIL, Charlotte, NC (US)

(72) Inventor: Lenore VASSIL, Charlotte, NC (US)

(21) Appl. No.: 13/844,107

(22) Filed: Mar. 15, 2013

Related U.S. Application Data
(60) Provisional application No. 61/635,807, filed on Apr. 19, 2012.

(51) Int. Cl. G06Q 50/18; G06Q 10/10

(52) U.S. Cl. CPC G06Q 50/186; G06Q 10/10
USPC 705/312

(57) ABSTRACT

An estate organization system includes a plurality of user computers, a plurality of entity computers, a network, and one or more server computers implementing a software environment. The software environment provides checklists, “to do” lists, and a scoring methodology to encourage a user to organize his or her estate. At least one user computer is used by a person organizing their estate, at least one user computer is used by a person who is a loved one of the person organizing their estate, and at least one computer is used by a professional services provider who is interested in providing estate planning or related services to the person organizing their estate and/or the loved one.

### CROSS-REFERENCE TO RELATED APPLICATION

The present application is a U.S. nonprovisional patent application of, and claims priority under 35 U.S.C. §119(e) to, U.S. provisional patent application Ser. No. 61/635,807, filed Apr. 19, 2012 and entitled “ESTATE MANAGEMENT SYSTEM,” which provisional patent application is incorporated by reference herein in its entirety.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE PRESENT INVENTION

1. Field of the Present Invention

The present invention relates generally to estate and life event organization and management systems.

2. Background

Estate planning is very important but people often put it off because they are overwhelmed by both the complexity of the process and the somber nature of the topic. In addition to a comprehensive estate plan, people need a holistic way to organize high level instructions for their family.

If something happens to a person, temporarily or permanently, the person's family often has difficulties managing the person's day-to-day affairs. Even if the person has a will, trust or powers of attorney, their loved ones often do not know where they are or how to use them; they do not know how the bills are paid, the person's doctor's name or the name of the school their child attends. Most people have never managed, much less settled, someone else's estate before and are unaware of role and responsibilities of an executor.

A person's estate is more than just their money and legal documents; it includes their health, children, pets, household, vehicles, and the like. While people may feel that they have their affairs in order, after more probing, it has been found that people commonly have not shared basic information about their lives with their closest family members. People are reluctant to share this critical information for fear of revealing the intimate details of their medical and financial affairs.

A need exists for a comprehensive online estate organizer that the estate owner shares with their loved ones so they can navigate that person's life if something happens to them. Such an application could help a person share minimal non-confidential yet vital pieces of information with select people of their own choosing and confirm a common understanding regarding their affairs. An intuitive interface plus gaming or “scoring” functionality would motivate people to organize, maintain and share this important information so that should anything happen to the estate owner, their loved ones can more easily step in to help with their affairs.

### SUMMARY OF THE PRESENT INVENTION

Broadly defined, the present invention according to one aspect is an estate and life event organization and management system that includes a plurality of user computers, a plurality of entity computers, a network, and one or more server computers implementing a software environment. The software environment provides a graphical user interface and background functionality to: receive, from a user, input representative of information describing an estate of the user; organize the received information for subsequent presentation back to the user; automatically analyze the received information to determine, based on the received information and on criteria predefined within the software environment, action items to be performed, by a person other than the user, with regard to various portions of the estate; and automatically organize the action items into a checklist for use by the person other than the user.

In features of this aspect, the user is a first user, and the software environment further provides a graphical user interface and background functionality to present the checklist back to a second user; the second user is the same as the first user; the second user is different than the first user, wherein each user is identified and distinguished within the software environment by a unique system account; and/or the second user is the person for whom the action items have been organized into the checklist.

In another feature of this aspect, the software environment further provides a graphical user interface and background functionality to organize the action items into a plurality of different checklists for use by the person other than the user.

In still another feature of this aspect, the software environment further provides a graphical user interface and background functionality to organize the action items into at least two of: a checklist for action items to be performed upon the death of the first user; a checklist for action items to be performed upon a medical emergency of the first user; and a checklist for action items to be performed upon a financial emergency of the first user.

In still other features of this aspect, the software environment further provides a graphical user interface and background functionality to present the checklist back to a second user in graphical format; the software environment further provides a graphical user interface and background functionality for the second user to select the checklist from a graphical dashboard interface; and/or the software environment further provides a graphical user interface and background functionality for the second user to select the checklist from a plurality of checklists.

In still other features of this aspect, the action items to be performed are action items to be performed on the occurrence of a particular event, and the action items are organized into a checklist for use by the person other than the user on the occurrence of the particular event; the action items to be performed are action items to be performed on the occurrence of a particular life event, and the action items are organized into a checklist for use by the person other than the user on the occurrence of the particular life event; the action items to be performed are action items to be performed on the occurrence of the death of the user, and the action items are organized into a checklist for use by the person other than the user on the occurrence of the death of the user; the action items to be performed are action items to be performed on the occurrence of a medical emergency of the user, and the action items are organized into a checklist for use by the person other than the user on the occurrence of the medical emergency of the user; and/or the action items to be performed are action items to be performed on the occurrence of a financial emergency of the user, and the action items are organized into a checklist for use by the person other than the user on the occurrence of the financial emergency of the user.

In still another feature of this aspect, the one or more server computers operate in a cloud environment.

Broadly defined, the present invention according to another aspect is an estate and life event organization and management system that includes a plurality of user computers, a plurality of entity computers, a network, and one or more server computers implementing a software environment. The software environment provides a graphical user interface and background functionality to: receive, from a user, input representative of information describing a plurality of different dimensions of an estate of the user; organize the received information into a plurality of groups, wherein each group pertains to exactly one of the different dimensions of the estate of the user; after organizing the received information, presenting all of the groups to the user such that each group represents a selectable option; and upon selection, by the user, of a particular group, presenting the information that was organized into the selected group to the user.

In features of this aspect, the graphical user interface and background functionality is further adapted to receive, as a preliminary step, an indication of the particular dimensions of the estate of the user for which the user wishes to provide input; and/or the only groups presented to the user are the groups for which a preliminary indication was received from the user.

In other features of this aspect, the graphical user interface and background functionality is further adapted to prompt the user for the specific input to be received from the user; the graphical user interface and background functionality is further adapted to prompt the user, for the specific input to be received from the user, by asking the user questions; and/or the graphical user interface and background functionality is further adapted to prompt the user, for the specific input to be received from the user, by carrying out a conversation with the user.

In still other features of this aspect, the graphical user interface and background functionality is further adapted to accept specific input, if provided by the user, in response to each prompt, but to alternatively allow the user to proceed to a different prompt without providing specific input responsive to the prompt; and/or the graphical user interface and background functionality is further adapted to generate a list of action items, representative of a “to do” list, corresponding to all prompts to which the user failed to provide specific input response to the prompt.

In still other features of this aspect, the graphical user interface and background functionality is further adapted to display the list of action items, representative of a “to do” list, to the user; the action items on the represent items of information that a user should provide to the software environment in order to complete organization of the estate of the user; the action items correspond to prompts to which a user has failed to respond; and/or the action items correspond to prompts to which a user has indicated that he or she is unsure of how to respond to the prompts.

In still another feature of this aspect, the one or more server computers operate in a cloud environment.

Broadly defined, the present invention according to still another aspect is an estate and life event organization and management system that includes a plurality of user computers, a plurality of entity computers, a network, and one or more server computers implementing a software environment. The software environment provides a scoring methodology to organize or manage a user's estate.

In a feature of this aspect, points are given for completion of mandatory elements of an estate plan.

In other features of this aspect, bonus points are given for completion of non-mandatory elements of an estate plan; and/or the bonus points are awarded only if all mandatory elements of the estate plan are completed.

In still other features of this aspect, points are given when a second user confirms their understanding of a first user's estate plan; and/or after first providing a total score, the scoring methodology later removes points at least partly as a function of time.

In still other features of this aspect, the software environment provides means for a second user to confirm their understanding of a first user's estate plan; at least one user computer is used by a person organizing their estate, at least one user computer is used by a person who is a loved one of the person organizing their estate, and at least one computer is used by a professional services provider who is interested in providing estate planning or related services to the person organizing their estate and/or the loved one; and/or the one or more server computers operate in a cloud environment.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Further features, embodiments, and advantages of the present invention will become apparent from the following detailed description with reference to the drawings, wherein:

FIG. 1 is a block diagram of an estate and life event organization and management system in accordance with one or more preferred embodiments of the present invention;

FIG. 2 is a flowchart illustrating the general operation of the system of FIG. 1;

FIG. 3 is a flowchart illustrating the operation of the system of the present invention at initial set-up;

FIGS. 4A and 4B are tabular illustrations that together summarize the estate (“notebook”) organizer concept;

FIG. 5 is an exemplary graphical display of the individual's relationship information;

FIG. 6 is a flowchart illustrating the operation of the system of the present invention during ongoing maintenance activities;

FIG. 7 is a flowchart illustrating the operation of the system of the present invention during life event activities triggered by the occurrence of a life event;

FIG. 8 is a graphical depiction of a notebook display screen of one exemplary graphical user interface in accordance with one or more preferred embodiments of the present invention;

FIGS. 9A and 9B collectively depict a flowchart illustrating the operation of a one-time setup wizard for new users;

FIG. 10 is a graphical depiction of one notebook conversation screen of one exemplary graphical user interface in accordance with one or more preferred embodiments of the present invention;

FIG. 11 is a graphical depiction of a personal notebook profile section of one exemplary graphical user interface in accordance with one or more preferred embodiments of the present invention;

FIG. 12 is a graphical depiction of a personal notebook documents section of one exemplary graphical user interface in accordance with one or more preferred embodiments of the present invention;

FIG. 13 is a graphical depiction of a personal notebook finances section of one exemplary graphical user interface in accordance with one or more preferred embodiments of the present invention;

FIG. 14 is a graphical depiction of a personal notebook contacts section of one exemplary graphical user interface in accordance with one or more preferred embodiments of the present invention;

FIG. 15 is a graphical depiction of an additional personal notebook section of one exemplary graphical user interface in accordance with one or more preferred embodiments of the present invention;

FIG. 16 is a graphical depiction of a dependent notebook profile section of one exemplary graphical user interface in accordance with one or more preferred embodiments of the present invention;

FIG. 17 is a graphical depiction of a dependent notebook documents section of one exemplary graphical user interface in accordance with one or more preferred embodiments of the present invention;

FIG. 18 is a graphical depiction of a dependent notebook finances section of one exemplary graphical user interface in accordance with one or more preferred embodiments of the present invention;

FIG. 19 is a graphical depiction of a dependent notebook contacts section of one exemplary graphical user interface in accordance with one or more preferred embodiments of the present invention;

FIG. 20 is a graphical depiction of an additional dependent notebook section of one exemplary graphical user interface in accordance with one or more preferred embodiments of the present invention;

FIG. 21 is a graphical depiction of a pet notebook profile section of one exemplary graphical user interface in accordance with one or more preferred embodiments of the present invention;

FIG. 22 is a graphical depiction of a pet notebook documents section of one exemplary graphical user interface in accordance with one or more preferred embodiments of the present invention;

FIG. 23 is a graphical depiction of a pet notebook finances section of one exemplary graphical user interface in accordance with one or more preferred embodiments of the present invention;

FIG. 24 is a graphical depiction of a pet notebook contacts section of one exemplary graphical user interface in accordance with one or more preferred embodiments of the present invention;

FIG. 25 is a graphical depiction of an additional pet notebook documents section of one exemplary graphical user interface in accordance with one or more preferred embodiments of the present invention;

FIG. 26 is a graphical depiction of a vehicle notebook profile section of one exemplary graphical user interface in accordance with one or more preferred embodiments of the present invention;

FIG. 27 is a graphical depiction of a vehicle notebook documents section of one exemplary graphical user interface in accordance with one or more preferred embodiments of the present invention;

FIG. 28 is a graphical depiction of a vehicle notebook finances section of one exemplary graphical user interface in accordance with one or more preferred embodiments of the present invention;

FIG. 29 is a graphical depiction of a vehicle notebook contacts section of one exemplary graphical user interface in accordance with one or more preferred embodiments of the present invention;

FIG. 30 is a graphical depiction of an additional vehicle notebook section of one exemplary graphical user interface in accordance with one or more preferred embodiments of the present invention;

FIG. 31 is a graphical depiction of a real estate notebook profile section of one exemplary graphical user interface in accordance with one or more preferred embodiments of the present invention;

FIG. 32 is a graphical depiction of a real estate notebook documents section of one exemplary graphical user interface in accordance with one or more preferred embodiments of the present invention;

FIG. 33 is a graphical depiction of a real estate notebook finances section of one exemplary graphical user interface in accordance with one or more preferred embodiments of the present invention;

FIG. 34 is a graphical depiction of a real estate notebook contacts section of one exemplary graphical user interface in accordance with one or more preferred embodiments of the present invention;

FIG. 35 is a graphical depiction of an additional real estate notebook documents section of one exemplary graphical user interface in accordance with one or more preferred embodiments of the present invention;

FIG. 36 is a tabular illustrations that together summarize the estate executor checklist concept;

FIG. 37 is a graphical depiction of a sample emergency checklist screen of one exemplary graphical user interface in accordance with one or more preferred embodiments of the present invention;

FIG. 38 is a graphical depiction of a “To Do List” display screen of one exemplary graphical user interface in accordance with one or more preferred embodiments of the present invention;

FIG. 39 is a graphical depiction of a “Your Torch Scores” display screen of one exemplary graphical user interface in accordance with one or more preferred embodiments of the present invention;

FIG. 40 is a graphical illustration of a portion of an exemplary point scoring structure;

FIG. 41 is graphical illustration of a portion of an exemplary sample of importance weighting by notebook type;

FIG. 42 is graphical illustration of a portion of an exemplary mandatory and non-mandatory items;

FIG. 43 is a graphical illustration of a portion of an exemplary point scoring structure by priority;

FIG. 44 is a graphical illustration of a portion of an exemplary point scoring structure mandatory and non-mandatory items;

FIG. 45 is tabular illustration of a portion of an exemplary point scoring structure a notebook;

FIG. 46 is a graphical illustration of a portion of a portion of an exemplary point scoring structure overall weighted score with multiple notebooks;

FIG. 47 is a graphical depiction of a first network requests display screen of one exemplary graphical user interface in accordance with one or more preferred embodiments of the present invention;

FIG. 48 is a graphical depiction of a second network requests display screen of one exemplary graphical user interface in accordance with one or more preferred embodiments of the present invention;

FIG. 49 is a graphical depiction of a network messages display screen of one exemplary graphical user interface in accordance with one or more preferred embodiments of the present invention;

FIG. 50 is a graphical depiction of a message details display screen of one exemplary graphical user interface in accordance with one or more preferred embodiments of the present invention;

FIG. 51 is a graphical depiction of a local resources display screen of one exemplary graphical user interface in accordance with one or more preferred embodiments of the present invention;

FIG. 52 is a graphical depiction of an online resources display screen of one exemplary graphical user interface in accordance with one or more preferred embodiments of the present invention;

FIGS. 53-57 are illustrations of an alternative scoring structure; and

FIGS. 58-119 are wireframe diagrams illustrating portions of another exemplary graphical user interface in accordance with one or more preferred embodiments of the present invention.

### DETAILED DESCRIPTION

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. As should be understood, any embodiment may incorporate only one or a plurality of the above-disclosed aspects of the invention and may further incorporate only one or a plurality of the above-disclosed features. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers,” “a picnic basket having crackers without cheese,” and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, in which like numerals represent like components throughout the several views, one or more preferred embodiments of the present invention are next described. The following description of one or more preferred embodiments is merely exemplary in nature and is in no way intended to limit the invention, its implementations, or uses.

### Overview of System

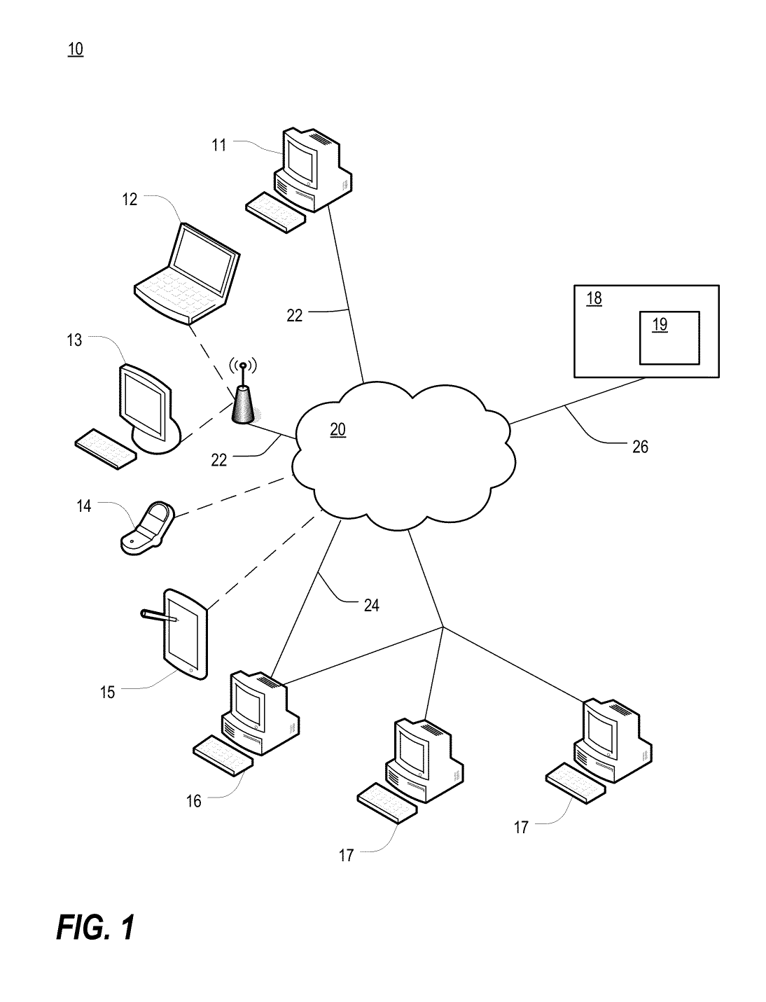

FIG. 1 is a block diagram of an estate and life event organization and management system 10 in accordance with one or more preferred embodiments of the present invention. The system includes a plurality of user computers or computer devices 11,12,13,14,15, a plurality of entity computers 16, a network 20, such as the internet, and one or more server computers 18 implementing a software environment 19.

Each user computer or computer device 11,12,13,14,15 can be a personal computer, for example, a desktop or notebook computer. It will also be appreciated that various other devices, including include cell phones, smart phones, PDAs, tablet notebooks, and the like, may in at least some embodiments likewise be used as user computers.

Each user computer or computing device 11,12,13,14,15 can be stand-alone or part of a computer network, depending on the implementation of the present invention. Each user computer or computing device 11,12,13,14,15 and server computer 18 can be connected to a computer network, for example a local area network (LAN) or a wide area network (WAN), through a variety of interfaces, including, but not limited to dial-in connections, cable modems, high-speed lines, and hybrids thereof. According to FIG. 1, each user computer or computing device 11,12,13,14,15 can be connected to the server computer 18 through communication lines 22,24 and the internet or other network 20.

One example of a first user computer 11 is a computer used by an individual having estate organization needs. One example of a second user computer 12 is a computer used by an individual who is a “loved one” for an individual having estate organization needs. One example of a third user computer 13 is a computer used by a professional services provider, often generally referred to hereinafter as an “advisor,” who is interested in providing estate planning or related services, for example, to individuals with estate organization needs or their loved ones. In at least some circumstances, loved ones and advisors may each serve as decision makers for an estate owner.

The server computer 18 can be a database server, an application server, a web server, a directory server, a mail server, a cloud server, and/or hybrids thereof. It will be apparent that the type of server computer 18 depends on the nature and implementation of estate organization system 10.

According to the embodiment depicted in FIG. 1, the user computers 11,12,13,14,15 and the server computer 18 may support TCP/IP protocol which has input and access capabilities via respective two-way communication lines 22,26. One example of a supportable protocol suitable for use in the present invention is voice over Internet protocol, otherwise referred to as VoIP. Each communication line 22 is preferably an intranet-adaptable communication line, for example, a dedicated line, a satellite link, an Ethernet link, a public telephone network, a private telephone network, and/or a hybrid thereof. The server communication line 26 is preferably adaptable to connect to the internet 20. Examples of suitable communication lines include, but are not limited to, public telephone networks, public cable networks, and hybrids thereof. It is understood that the communication lines 22,26 can be purely internet-adaptable, purely intranet-adaptable, or hybrids thereof. For example, each user communication line 22 can include an internet-adaptable portion and an intranet-adaptable portion. In certain embodiments, firewalls (not shown) can be situated between each user computer or computing device 11,12,13,14,15 and the internet 20, and between the server computer 18 and the internet 20, for security purposes.

Each entity computer 16 can be a computer interconnected to a number of affiliated computers 17. As used herein, an entity computer 16 is a computer or computing device designed to be used by an entity, such as a law firm, a financial services entity, or the like. In at least some embodiments, each entity computer 16 is configured to display one or more graphical user interfaces (GUIs) and/or to install and execute software for implementing embodiments of the present invention. In one embodiment, an individual having estate organization needs may use an affiliated computer 17 to access an entity computer 16 and to input personal information through the entity computer 16. In this embodiment, from the point of view of the individual, the entity computer 16 functions as a server computer. In some embodiments, if an entity installs a software package enabling it to have a stand-alone system, then the entity computer 16 may not operate as a server computer. In certain embodiments, the entity computer 16 is accessible only by the clients of the entity and those working for the entity (e.g. an owner, an employee, an independent contractor hired by the entity), wherein access to entity computer 16 may be controlled by the entity. In other embodiments, an agent of the entity (i.e., an owner, employee or independent contractor) can input the personal information of the estate-owning individual using affiliated computer 17. The information can be received by the agent of the entity either electronically, by mail, by phone, by fax, by personal interview, etc. In certain embodiments, an estate-owning individual can enter information about himself or herself or about another individual such as a parent, dependent child, etc, for whom the first individual may be a loved one (decision maker). This method may contemplate using a home or personal computer as opposed to an entity computer. In some embodiments, a software product may enable an individual to use a stand-alone system without a server computer hosting one or more GUIs for display on computers 11,12,13,14,15,16,17.

The entity computers 16 and server computer 18 can preferably support TCP/IP protocol which has input and access capabilities via two-way communication lines 24,26. The communication line 26 is preferably an intranet-adaptable communication line, such as, for example, a dedicated line, a satellite link, an Ethernet link, a public telephone network, a private telephone network, and/or a hybrid thereof. The communication line 24 is preferably adaptable to connect to the internet 20. In at least some embodiments of the present invention, each entity computer 16 can function as a server.

Each server computer 18 can preferably serve a number of GUIs via estate organization software 19 which can be accessed and displayed by client computer 12, entity computer 16, and/or affiliated computers 17. The GUIs can be used by the users to input and/or view personal estate information and/or to input and/or view information about professional services. This data is transmitted by the various computers 11,12,13,14,15,16,17 to the server computer 18 and received by the server computer 18. In at least some embodiments, the data transmitted through the communication lines 22,24,26 is encrypted, for example using 128-bit encryption, to enhance the security of the system 10.

The system configuration depicted in FIG. 1 is but one example of many embodiments of the present invention. As another example (not illustrated), an entity computer can function as a server computer for serving affiliated computers with a number of GUIs to implement certain features of the present invention. Moreover, an entity computer and/or an affiliated computer and/or a user computer can be configured with computer software embodying aspects of the present invention. In the latter example, a computer network may or may not be needed.

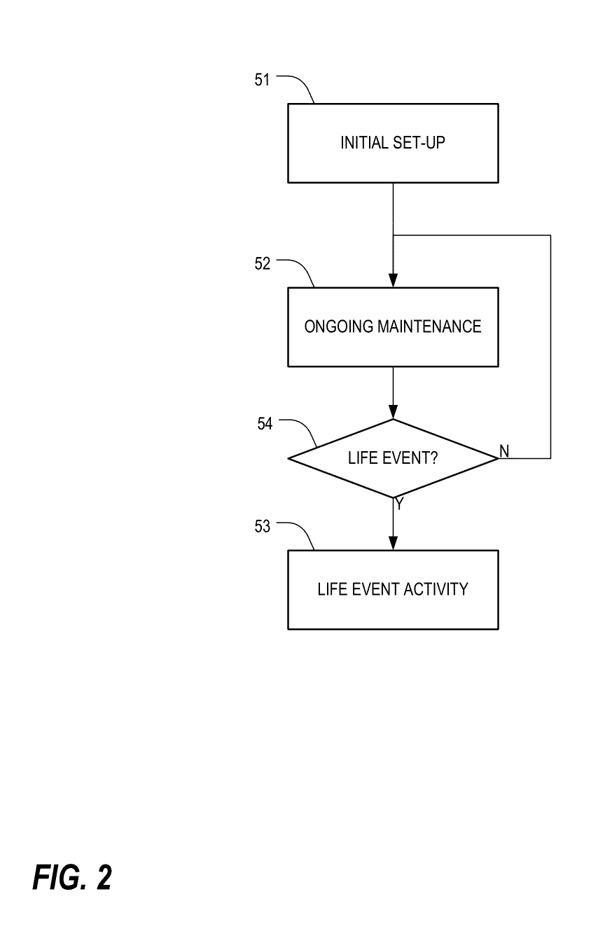

FIG. 2 is a flowchart illustrating general operation of the system 10 of FIG. 1. In at least some embodiments, the functionality described therein is carried out by the estate organization software 19 residing or implemented by the server 18. However, it will be apparent that the functionality may be implemented in other ways.

In general, system operation includes functionality related to initial setup 51, ongoing maintenance 52, and when a life event occurs as represented at step 54, life event activity 53. According to one aspect, individuals interested in organizing their estate are encouraged to enter information about their estate and about their current state of affairs using the initial set-up functionality 51. At the end of this phase, other people relevant to the individual's estate and/or estate organization activities are notified of the individual's participation in the system and are encouraged to participate in the estate organization process using the ongoing maintenance functionality 52.

Meanwhile, advisors (service providers) wishing to participate in the system 10 are encouraged to do so in initial set-up phase 51. They, too, interact with the system 10 in the ongoing maintenance phase 52 as well as after the occurrence of a life event, and information about these advisors may be provided to both the individual and the people relevant to that individual's estate during either or both of the initial set-up phase 51 and the ongoing maintenance phase 52.

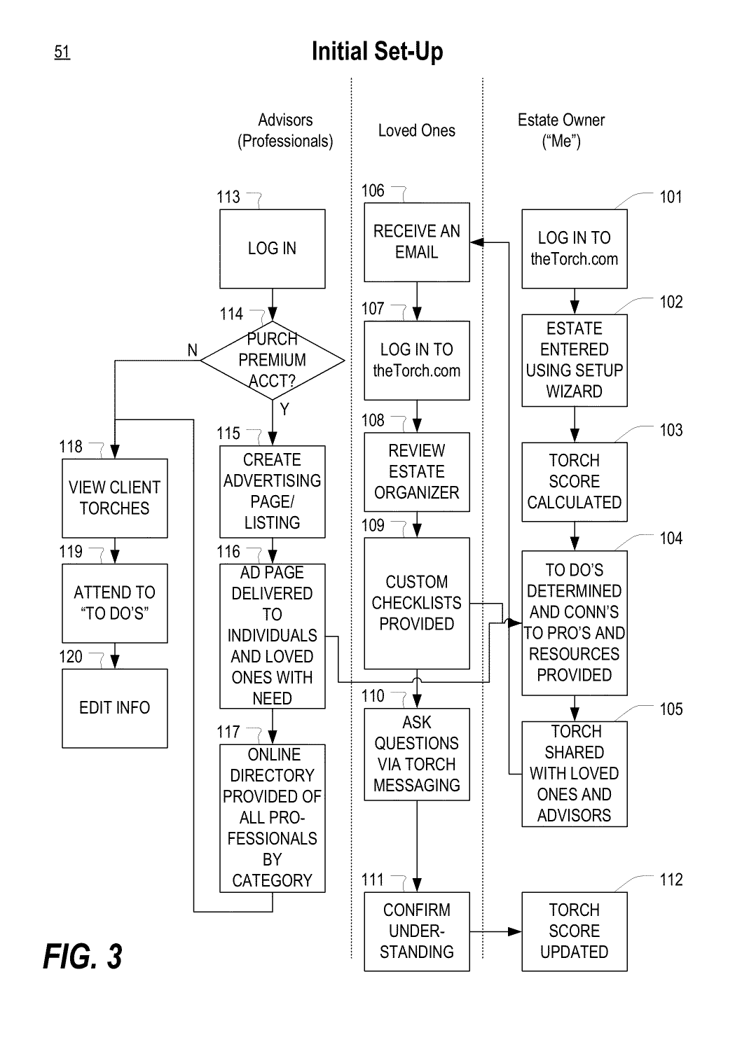

FIG. 3 is a flowchart illustrating operation of the system 10 of the present invention at initial set-up 51. As shown therein, an individual having an estate logs in to a system website at step 101 and enters information about their estate into the system at step 102 using a software wizard provided via the website. In at least some embodiments, the wizard is an intuitive wizard that asks the individual to enter information about various dimensions in their life (such as dependents, pets, vehicles, real estate, and the like) and then presents a customized inventory of documents, finances, contacts and other items necessary for an organized estate. It will be appreciated that not all of these dimensions need to be included, and that further dimensions might alternatively or additionally be included. Such additional dimensions may include, for example, any businesses for which the individual may have responsibility. Furthermore, as will be described below, users may be invited to provide information about all of the included dimensions, but may also be given the option of omitting one or more of the dimensions, either because they are inapplicable or because they do not wish to include such dimensions in their planning. Once users have entered their information the first item on their “To Do List” is to “pass their Torch” to the people they named in the startup wizard. Any loved one or advisor with whom the user has “passed their Torch” will be able to view, not edit, the notebooks and checklists of the user, ask questions via a messaging feature and confirm their understanding. Advisors who purchase a premium membership will have a client dashboard where they will be able to easily monitor their client's score and outstanding “To Do's”. If granted by the user, the advisor may also be able to update the users' information for them.

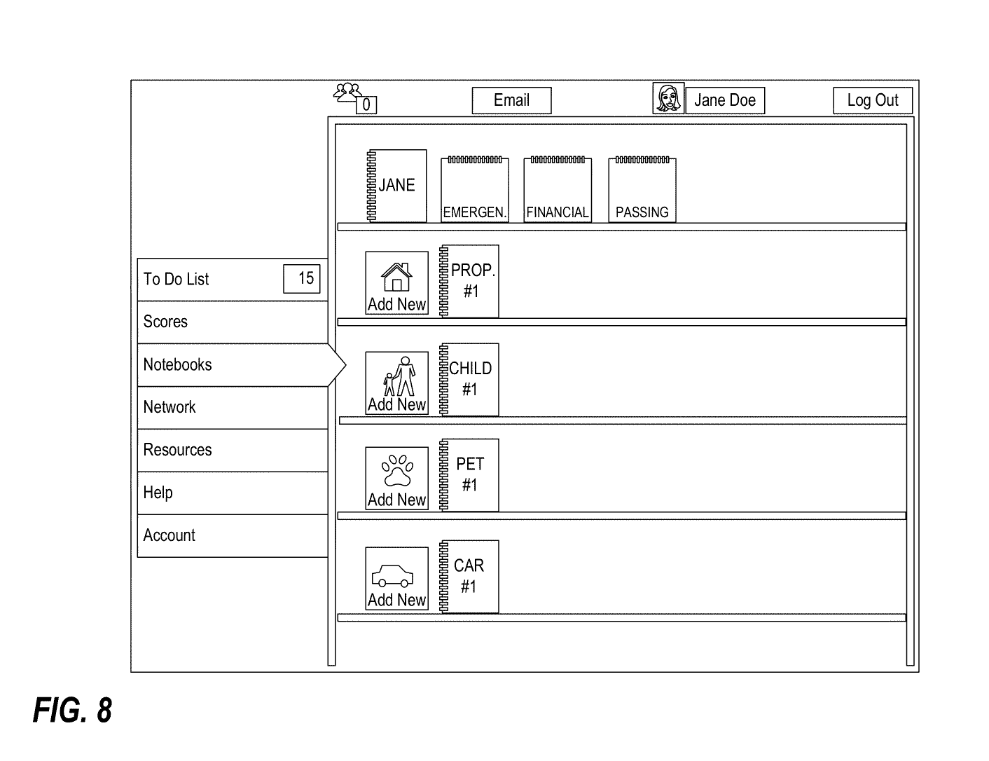

A collection of estate items will be organized into groups and presented to the individual. In at least some embodiments, the groups may be referred to as “notebooks,” and in at least some of these embodiments, a GUI makes use of visual depictions of notebooks to illustrate and reinforce this concept. In this regard, FIG. 8 is a graphical depiction of a notebook display screen of one exemplary graphical user interface in accordance with one or more preferred embodiments of the present invention. As shown therein, a plurality of notebooks, of different categories, are shown resting on the shelves of a bookcase. This screen serves as a “dashboard” for controlling much of the operation of the system 10 of the present invention, including that of the graphical user interface itself.

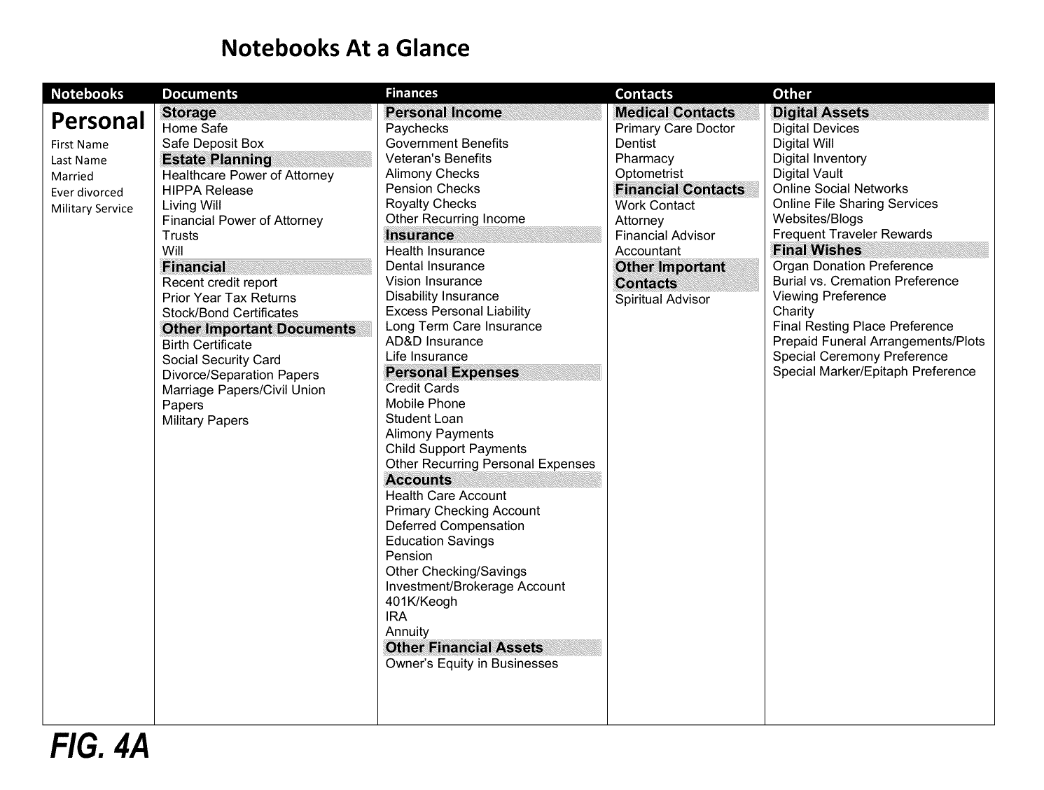

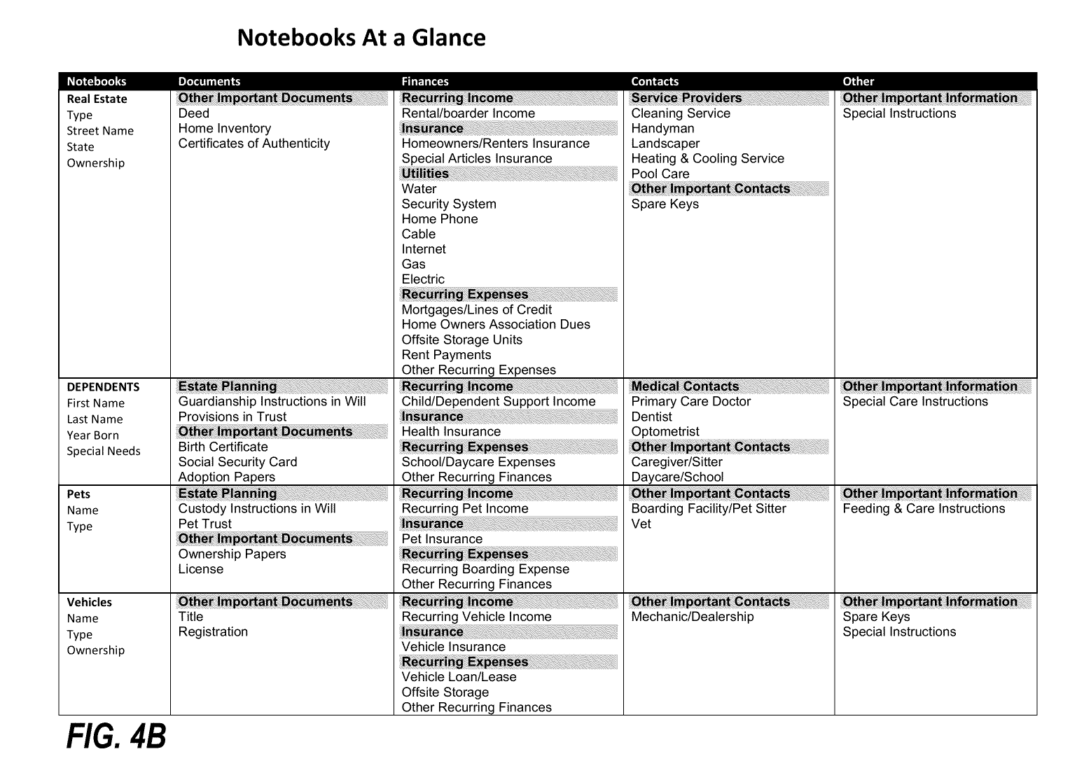

FIGS. 4A and 4B are tabular illustrations that together summarize the estate (“notebook”) organizer concept. In particular, FIG. 4A is a tabular illustration summarizing the personal estate organizer concept, and FIG. 4B is a tabular illustration summarizing the real estate, dependents, pets and vehicles organizer concept. In the summary of FIGS. 4A and 4B, columns are preferably the same for all customers because everyone should preferably have some level of documents, finances, insurance, and contacts, as well as various other details or information. However, rows are preferably unique for each customer and change over time. All customers will have the personal dimension, but the other dimensions, such as dependents, pets, businesses, vehicles, and real estate, depend on their particular life situation. Showing a customer's information this way makes it easy to notice if something needs to be updated based on changes in the customer's life.

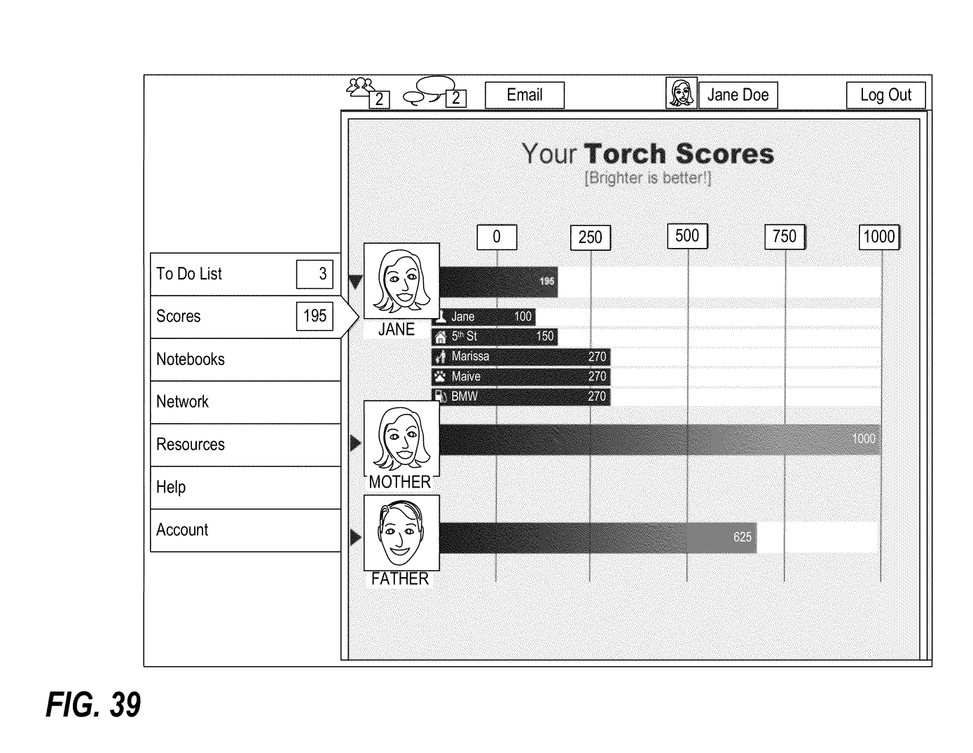

It will be appreciated that in at least some embodiments, the estate organizer and the torch score for this individual may be viewed by both the individual himself or herself, or by the individual's network of people to whom they passed their Torch (sometimes referred to herein as “loved ones” or “decision makers”), as will be further discussed hereinbelow. As shown in FIG. 39 (discussed below), a graphical representation is preferably presented of the customer's score and all of the Torch Scores of the people relaying their estate's to the customer's, in keeping with a theme of “scoring” and making the user experience entertaining for both the individual and the decision makers.

In at least some embodiments, it is not necessary to enter account numbers, policy numbers, reference numbers, account balances, policy coverages, or amounts of any kind In at least some embodiments, it is not necessary to enter third party passwords. In at least some embodiments, when the name of a financial institution, insurance provider, estate attorney, doctor or service provider is input, the system will search the internet for the contact information and will ask for a confirmation. Furthermore, in at least some embodiments, the system may have the ability to pull contact information from an individual's online or desktop contact databases.

Furthermore, the system calculates the individual's score at step 103. In at least some embodiments, the score is based on the completeness of the individual's estate organizer In some of these embodiments, the score may also be based on the completeness of the estates of the people in the individual's network. In at least some embodiments, the score is provided as a number. In at least some of these embodiment, 1000 is a preferred goal. In at least some embodiments, minimal requirements for an estate plan, by country, are established, confirmed, and endorsed by qualified estate planning and financial experts. The individual's score is preferably calculated at least partly by comparing the individual's entered data to the minimal requirements for their country. Further details on scoring are provided elsewhere herein.

In at least some embodiments, the individual's score or Torch Score may be posted to facebook or published to or via other social media. In at least some of these embodiments, the score may be thus published without revealing anything more about the individual's estate.

The system determines the individual's “to-do's” and connects the individual with appropriate professionals or online resouces at step 104. In at least some embodiments, the “to-do's” are accumulated and a list or other collection of the to-do's may be presented to the individual and/or others. Such a list may include any missing minimal requirement items (“must haves”) and/or any additional “should have” items specific to the customer (suggestions). In at least some embodiments, the “to do” list may also include embedded referrals to national professionals, local professionals, online resources, and/or the like, providing services specifically needed by the customer.

The system may further institute one or more periodic reminders with regard to individual “to-do” items and/or life event checks. The frequency with which such reminders are provided may be preset or may be controlled by the individual or other user. In at least some embodiments, reminders for the “to-do's” are provided by the system on a periodic, such as monthly or weekly, basis, and reminders for the life event checks are provided on a periodic, such as quarterly or monthly, basis. In at least some embodiments, email is used to deliver the reminders at the appropriate times. Alternatively or additionally, reminders may be presented to the individual or other user when such person logs into the system.

Life event checks will be added to the customer's to do list periodically and preferably include items similar to the following: (1) Confirm you have not had any changes in your marital status, add new documents, finances, insurance or contacts, (2) Confirm you have not had any changes in you dependents, (3) Confirm you have not had any changes in your pets, (4) Confirm you have not had any changes in your finances, (5) Confirm you have not had any changes in your vehicles, (6) confirm you have not had any changes in your Real Estate, (7) Confirm you have not had any changes in the people (decision makers, loved ones, etc.) to whom you have chosen to pass your Torch.

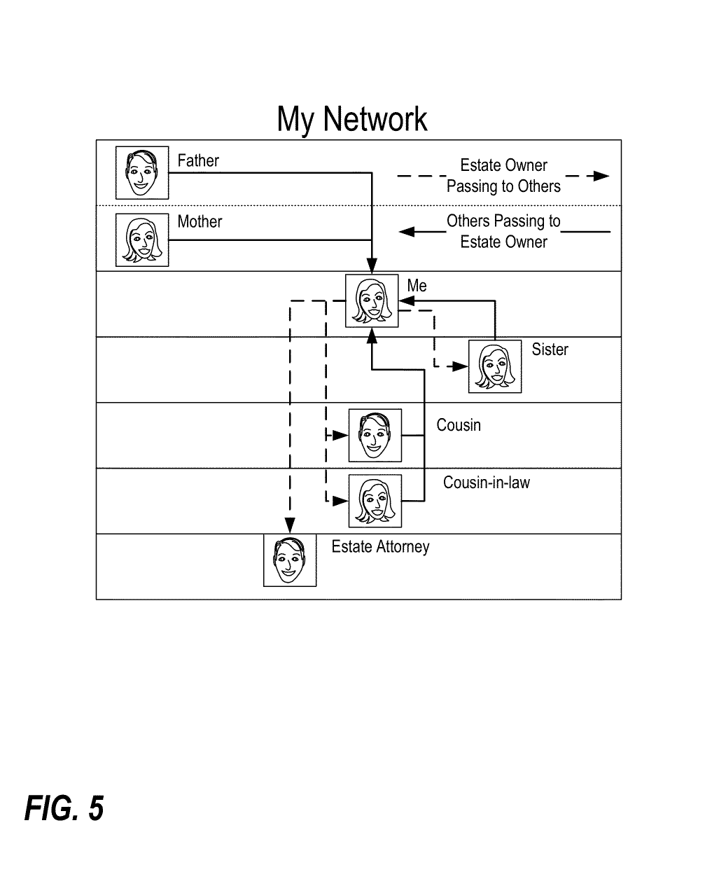

At step 105, some or all of the information entered or generated in steps 102-104 may be shared with other people relevant to the individual's estate and/or estate planning, managing, and other organization activities. If he or she has not done so previously, the individual may also define relationships at this time between the individual and those other people. FIG. 5 is an exemplary graphical display of the individual's relationship information, sometimes referred to herein as the individual's “network.”

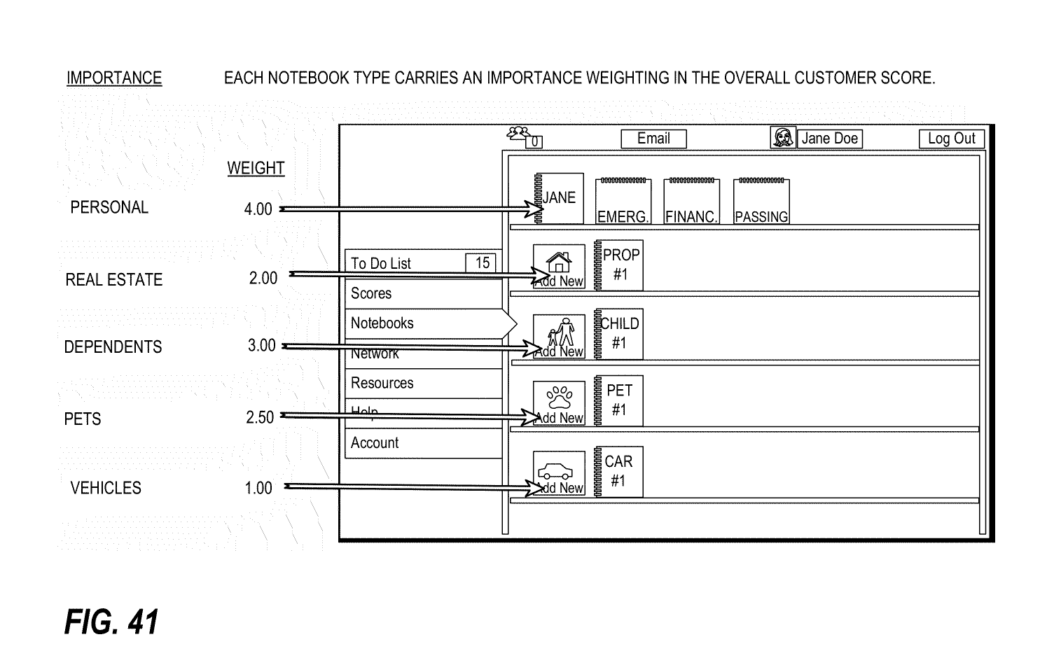

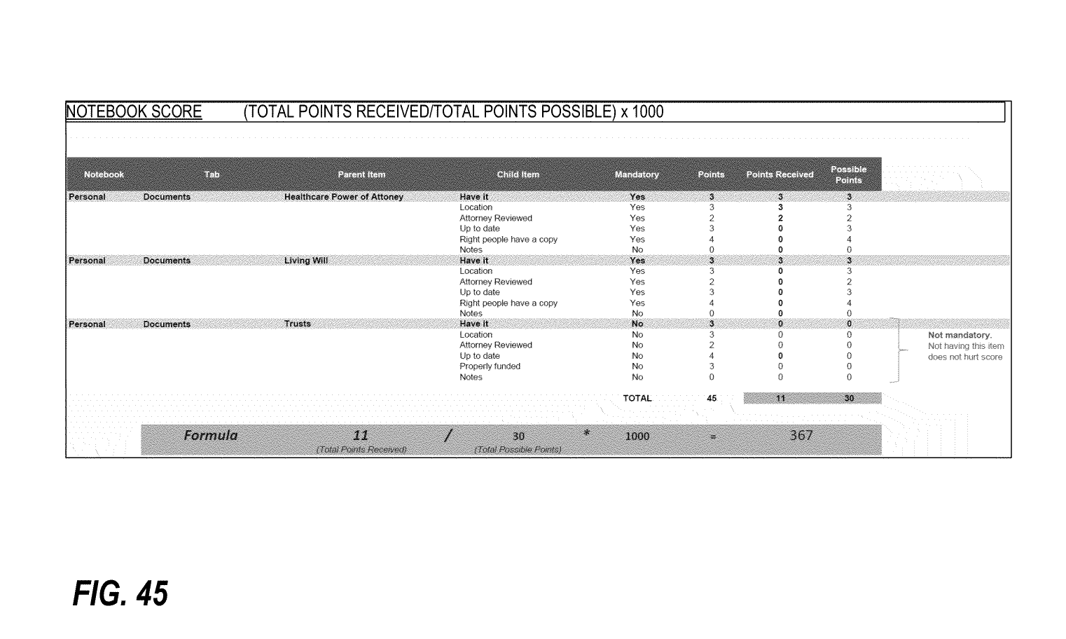

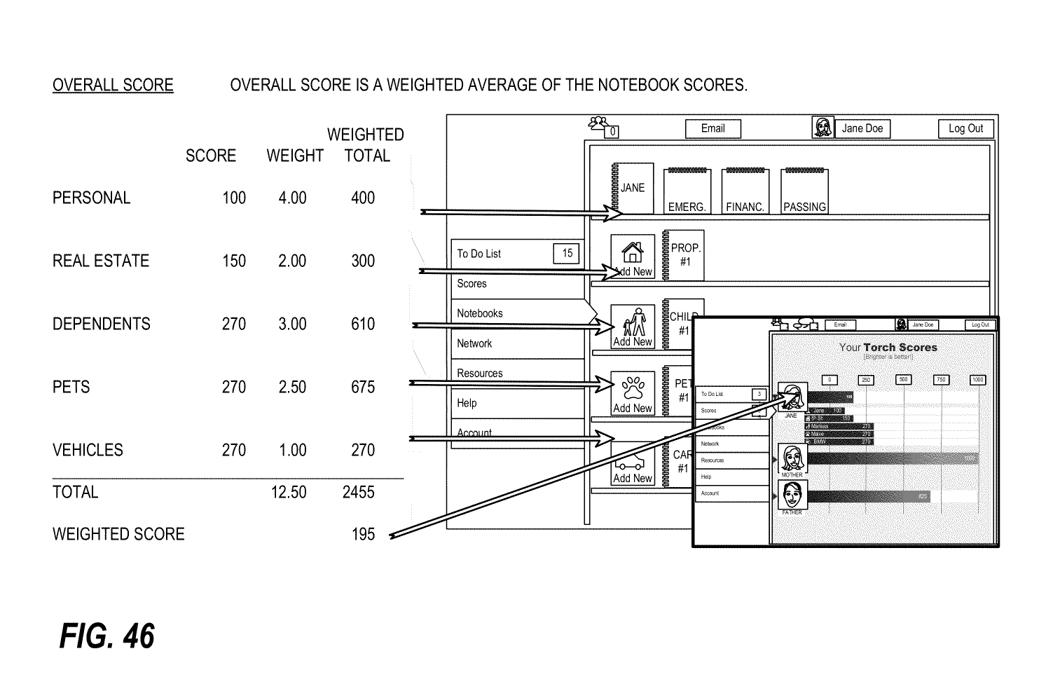

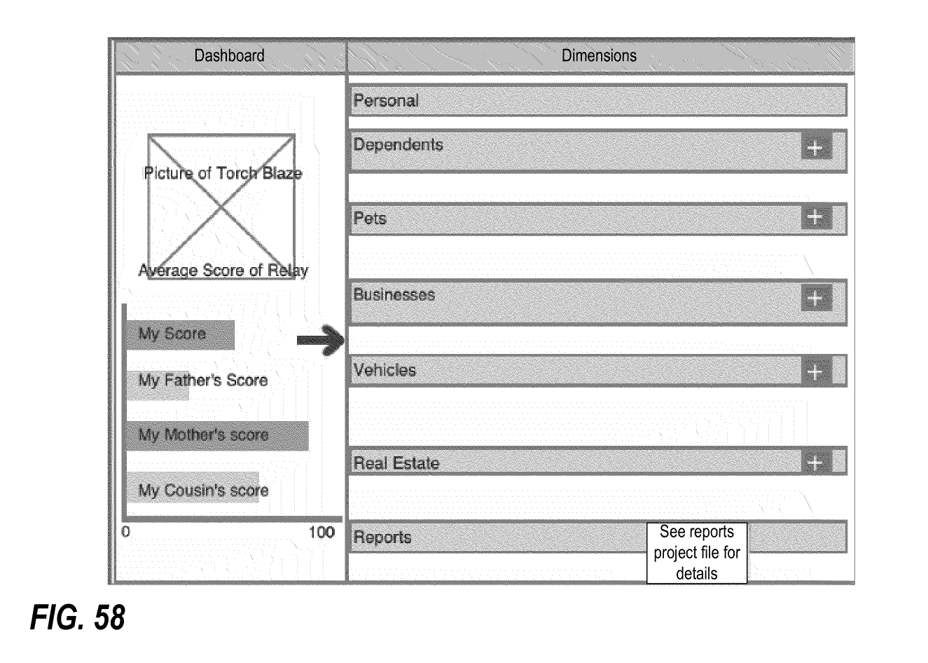

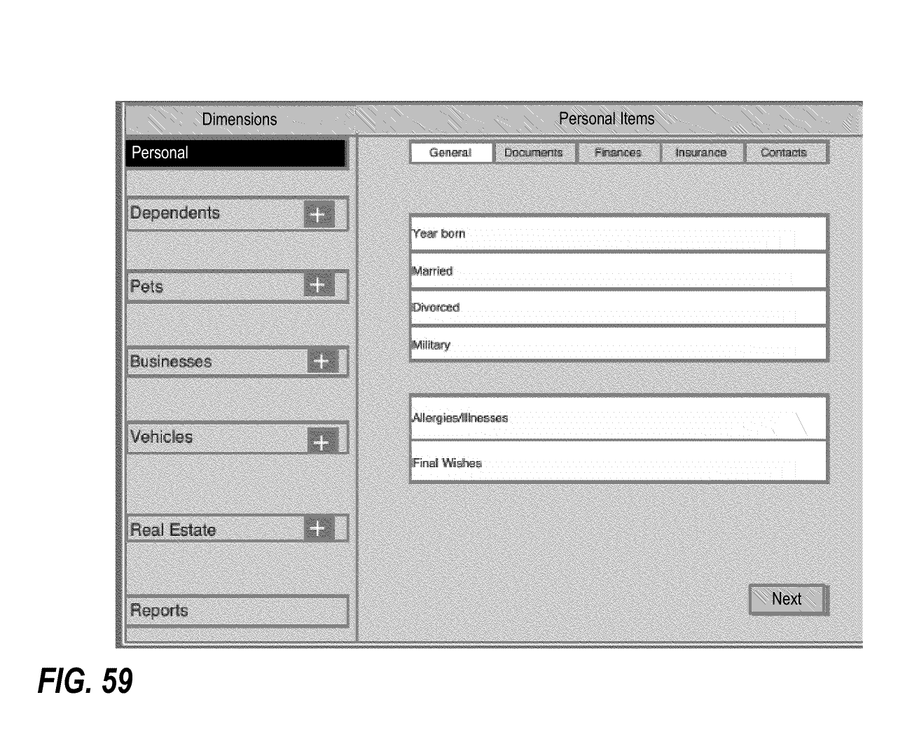

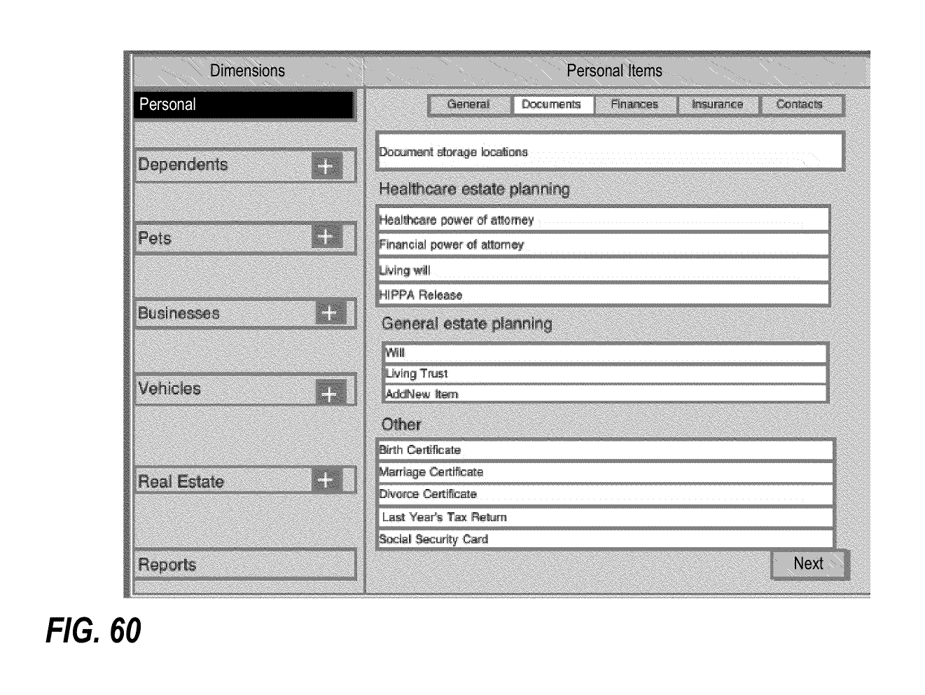

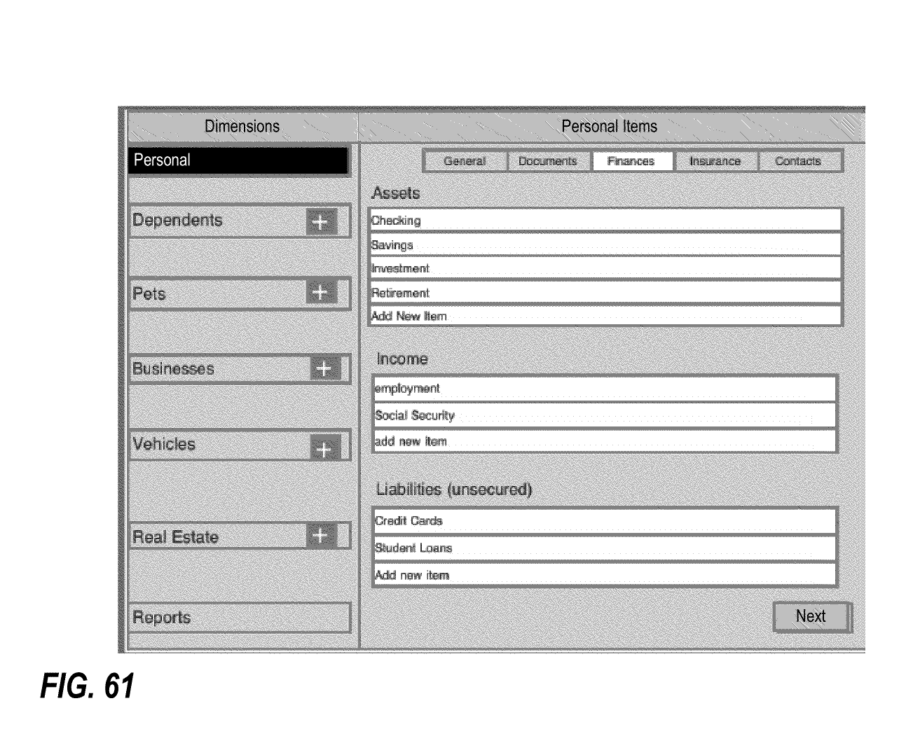

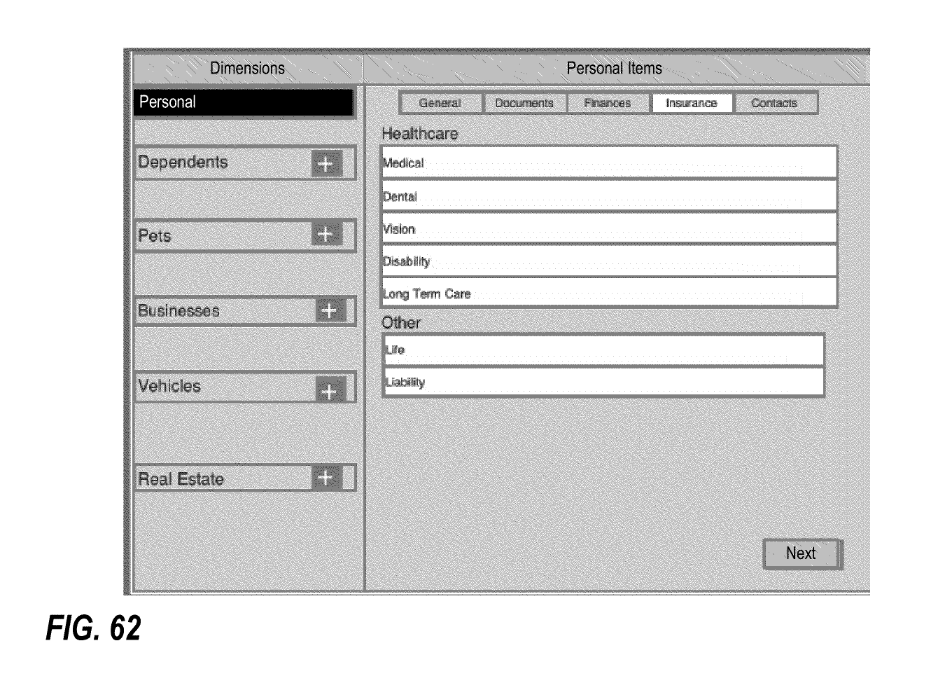

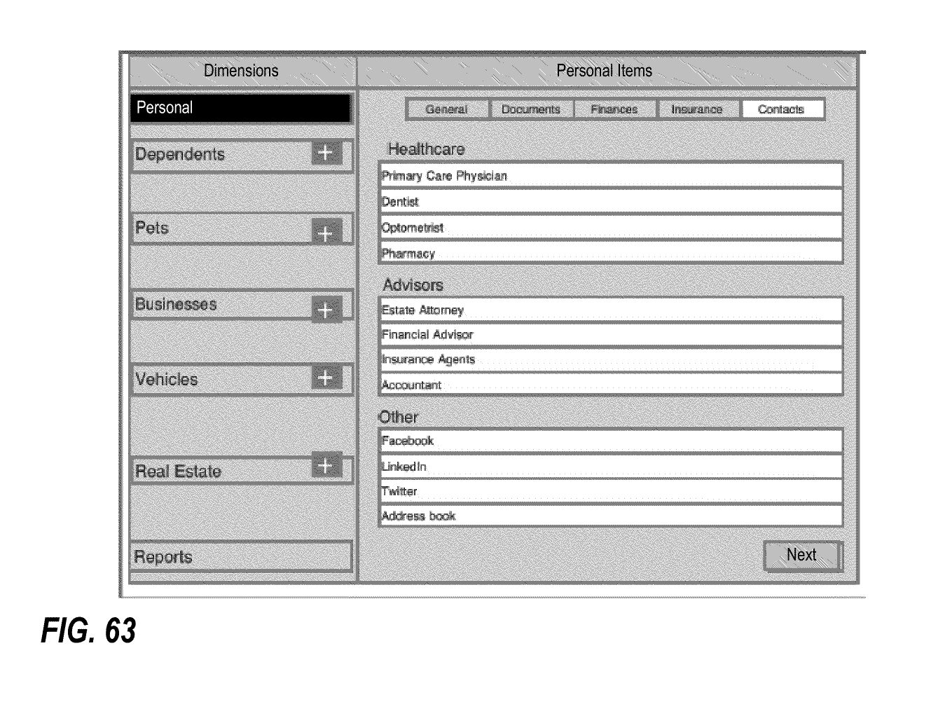

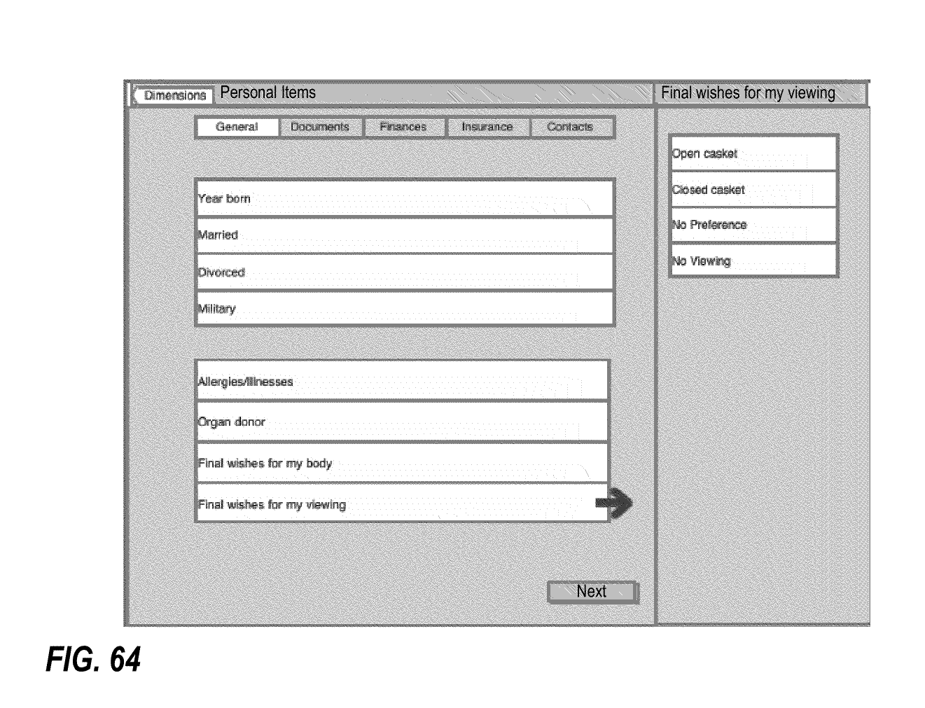

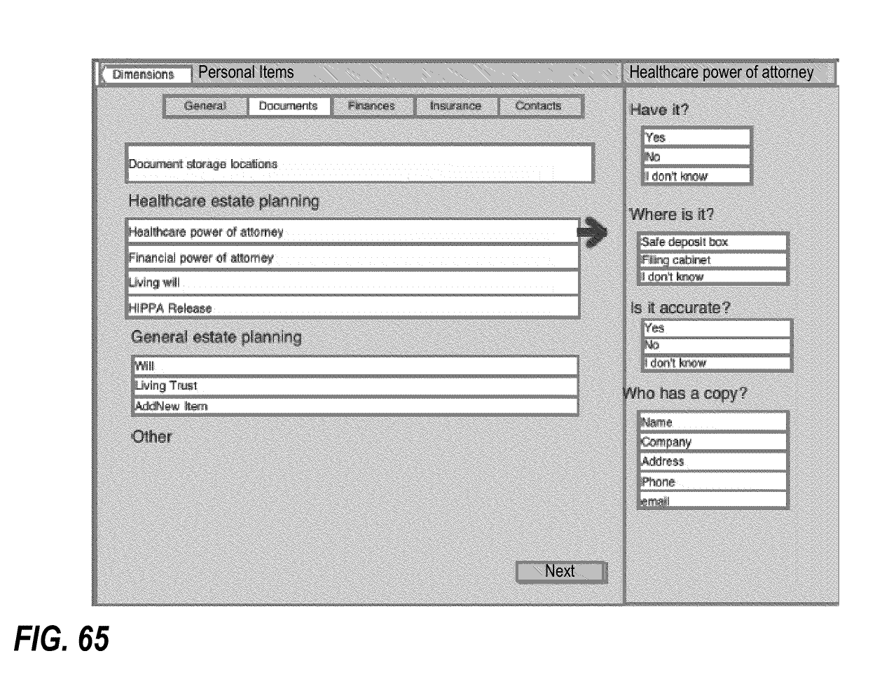

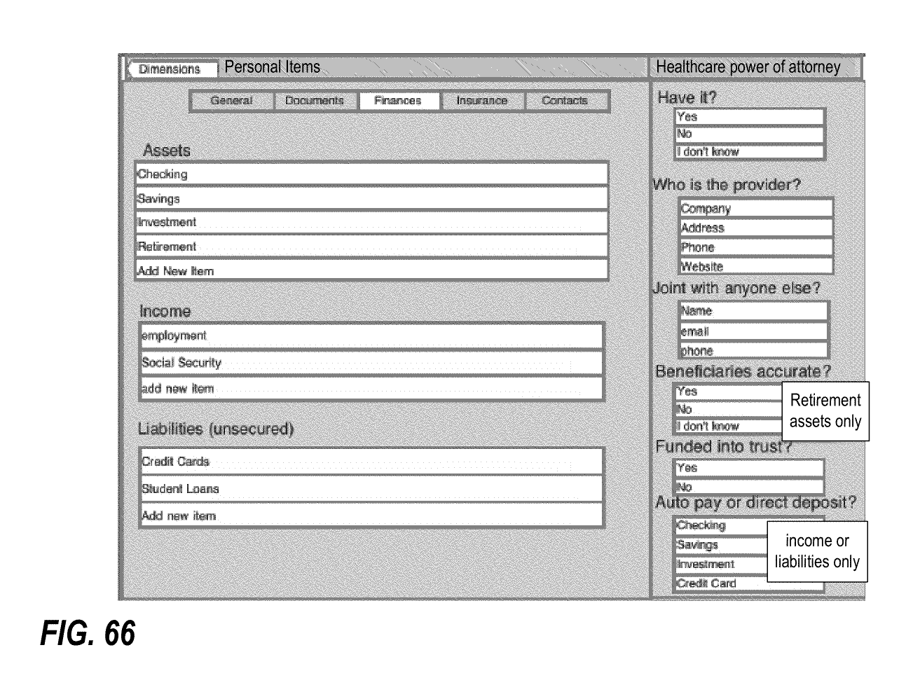

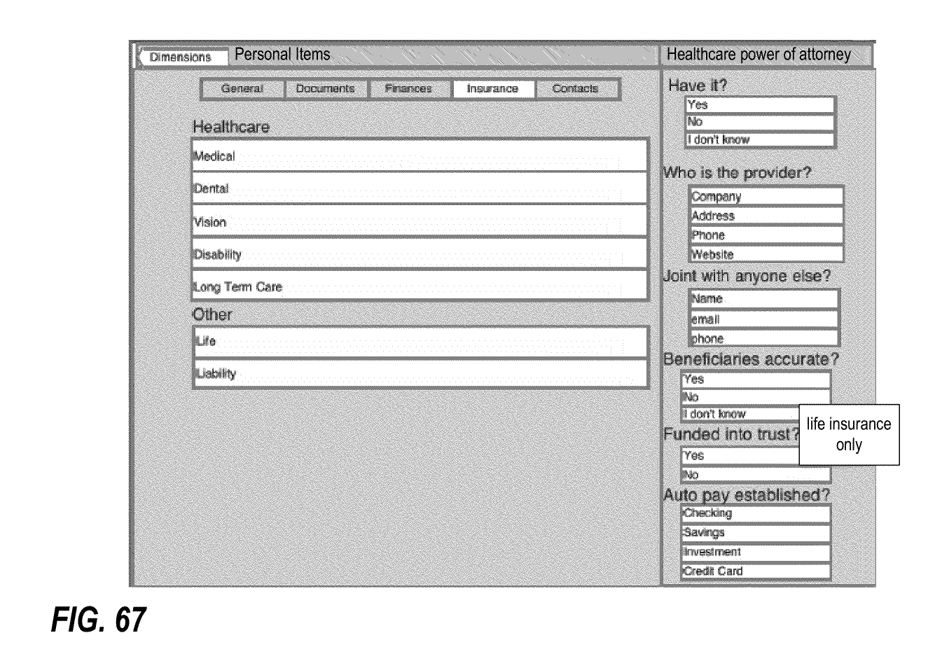

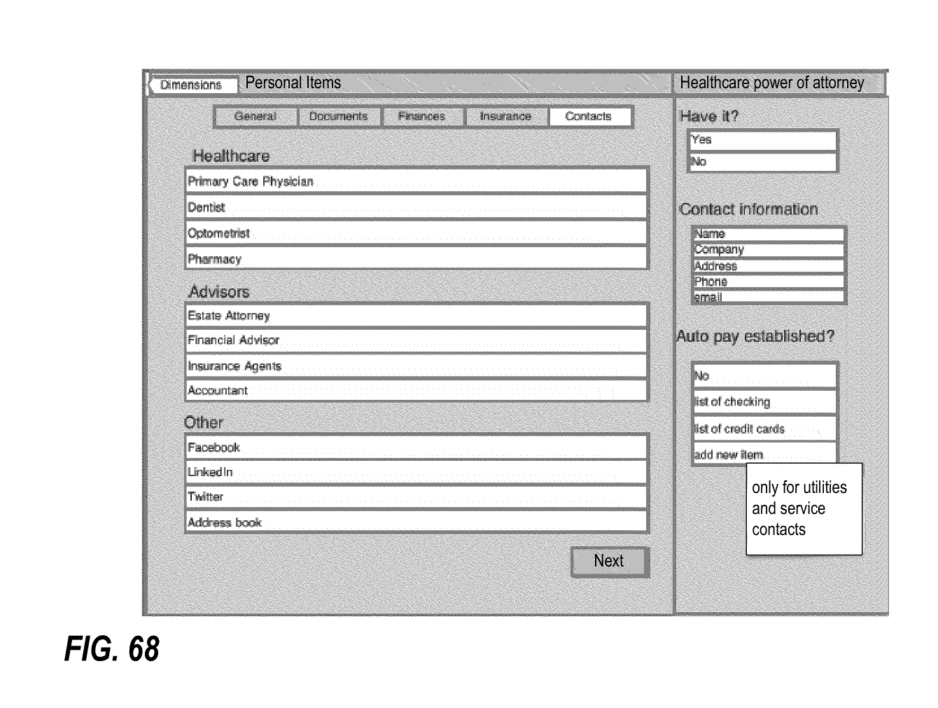

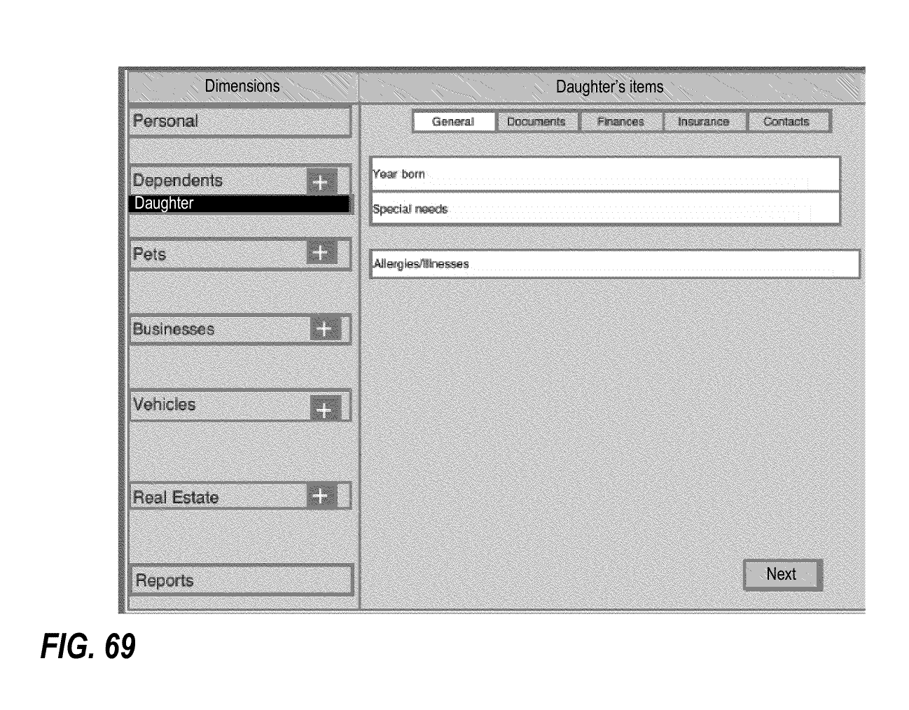

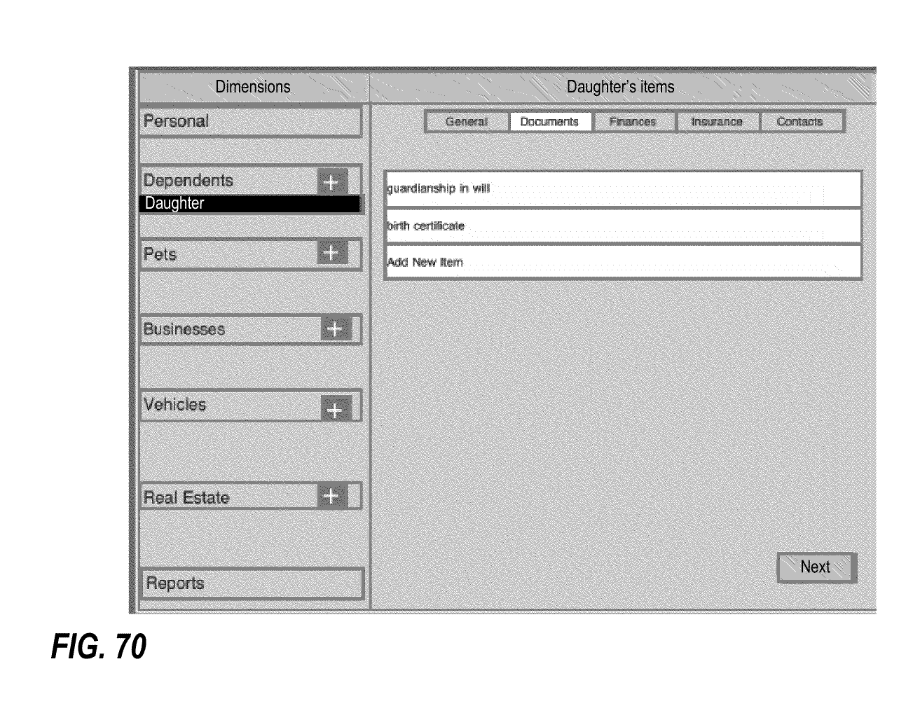

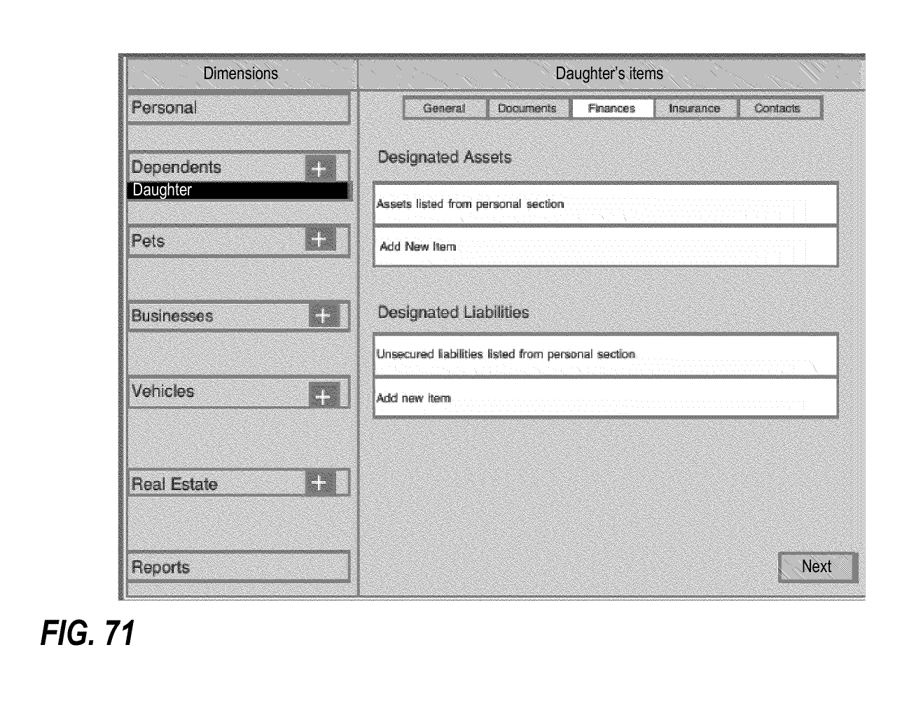

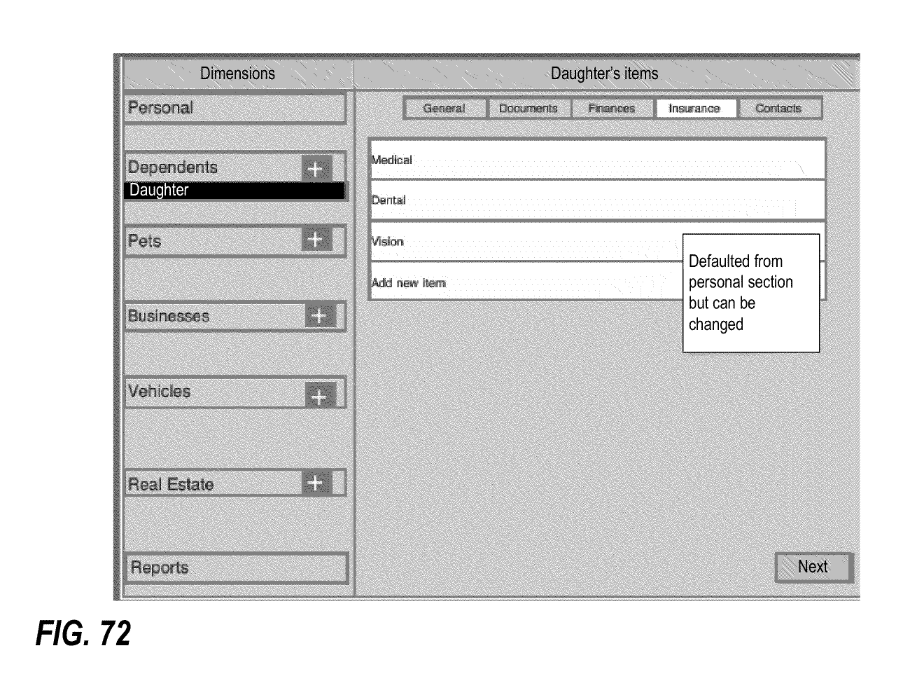

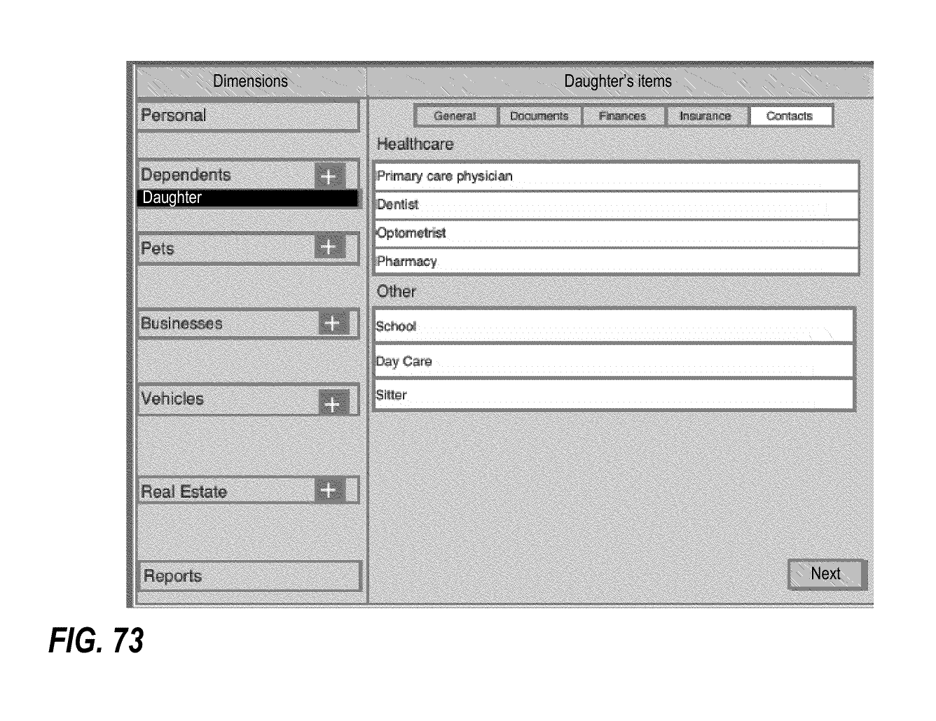

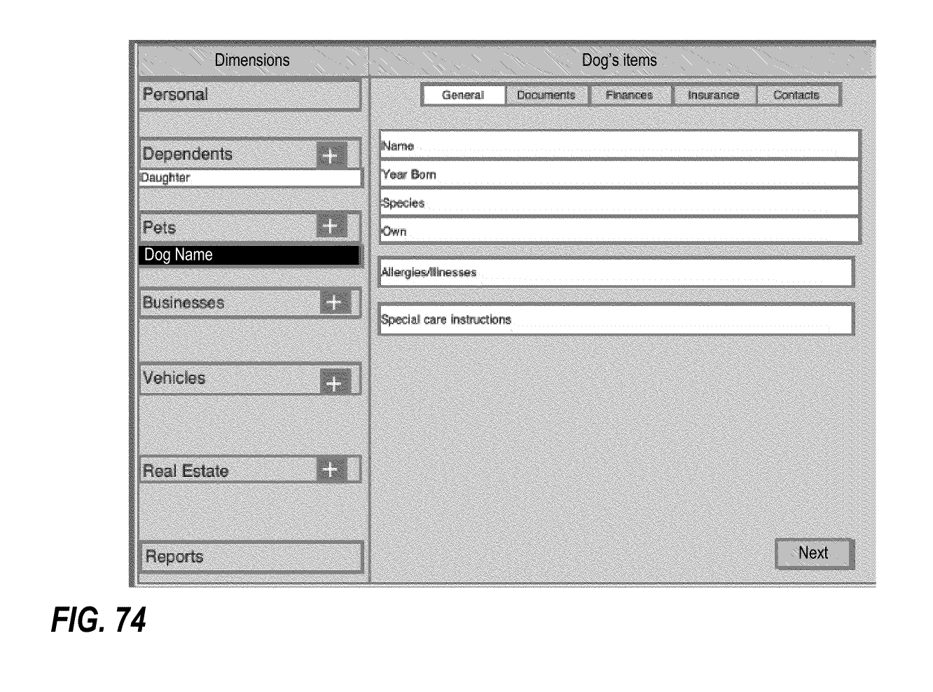

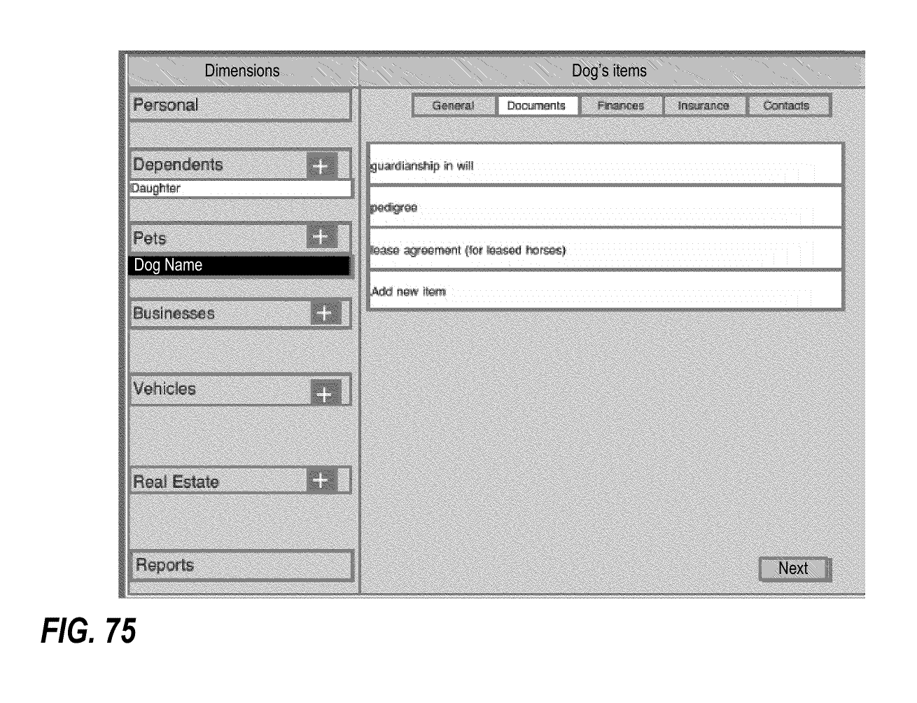

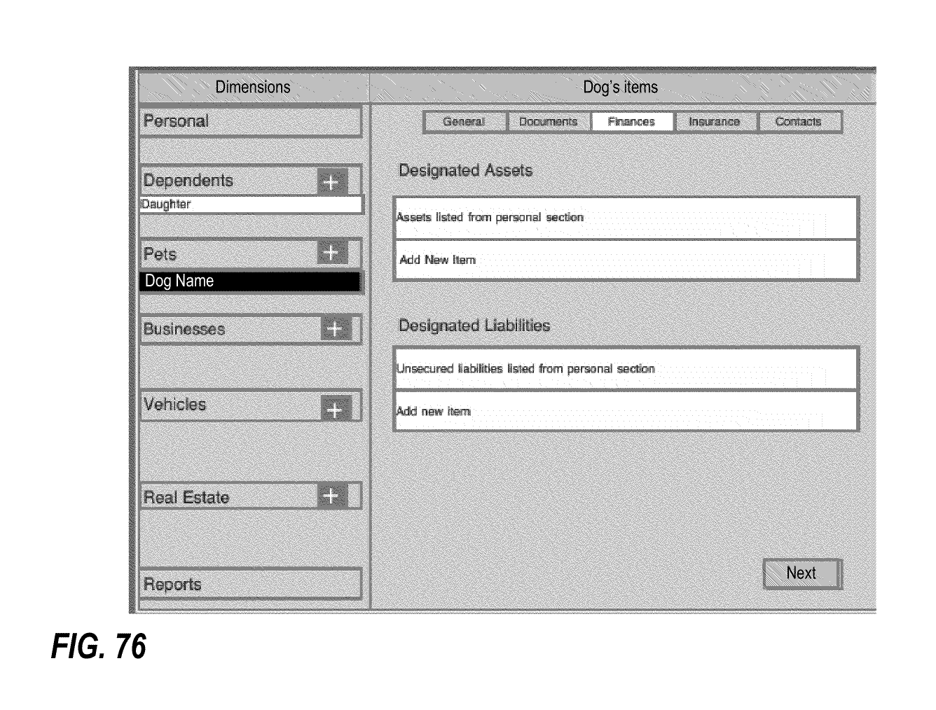

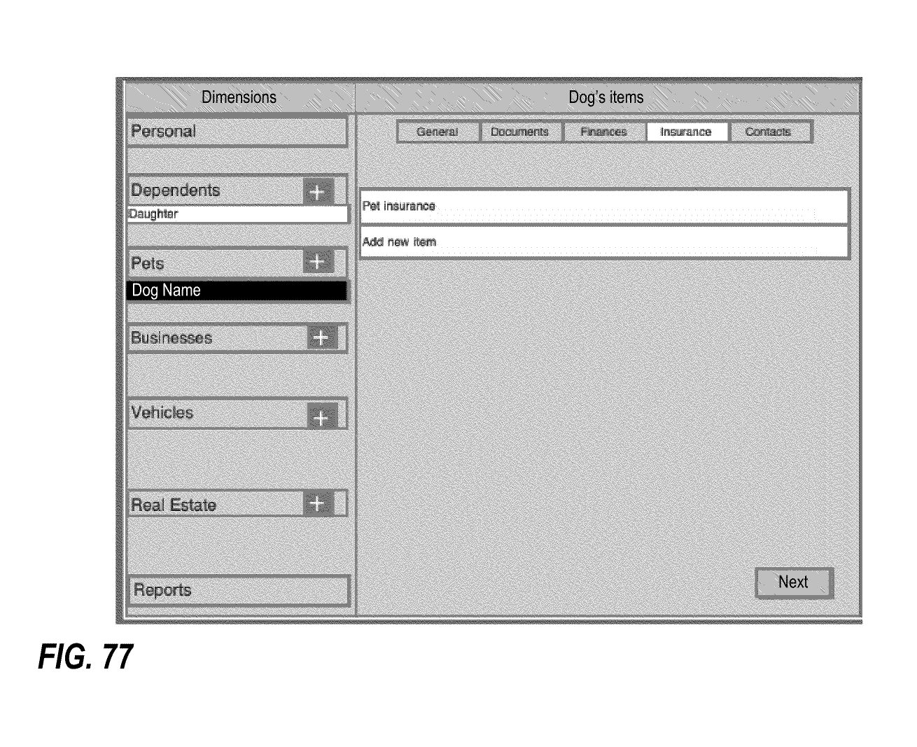

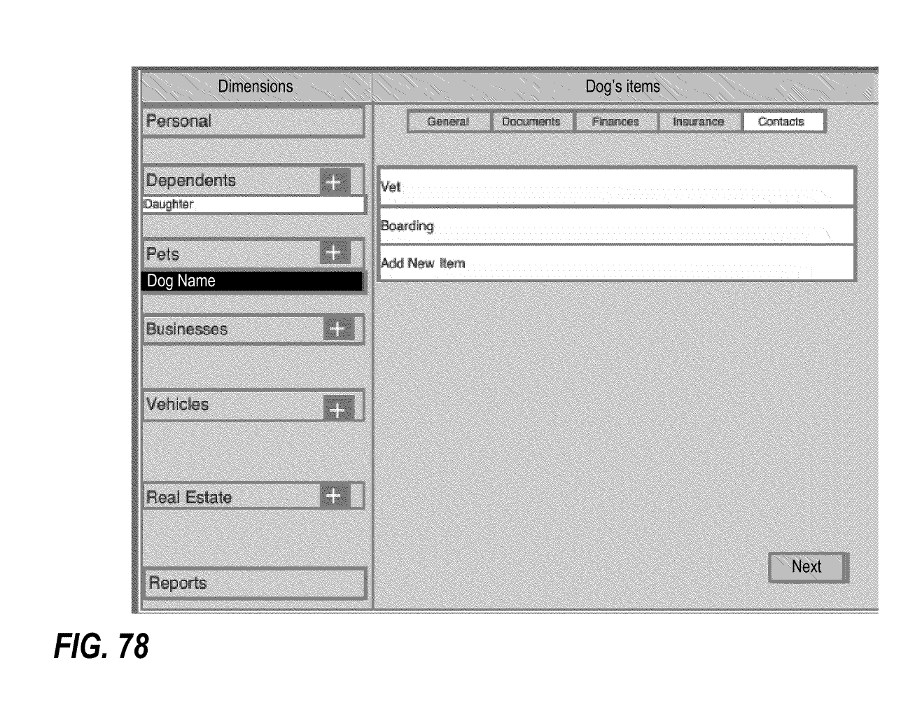

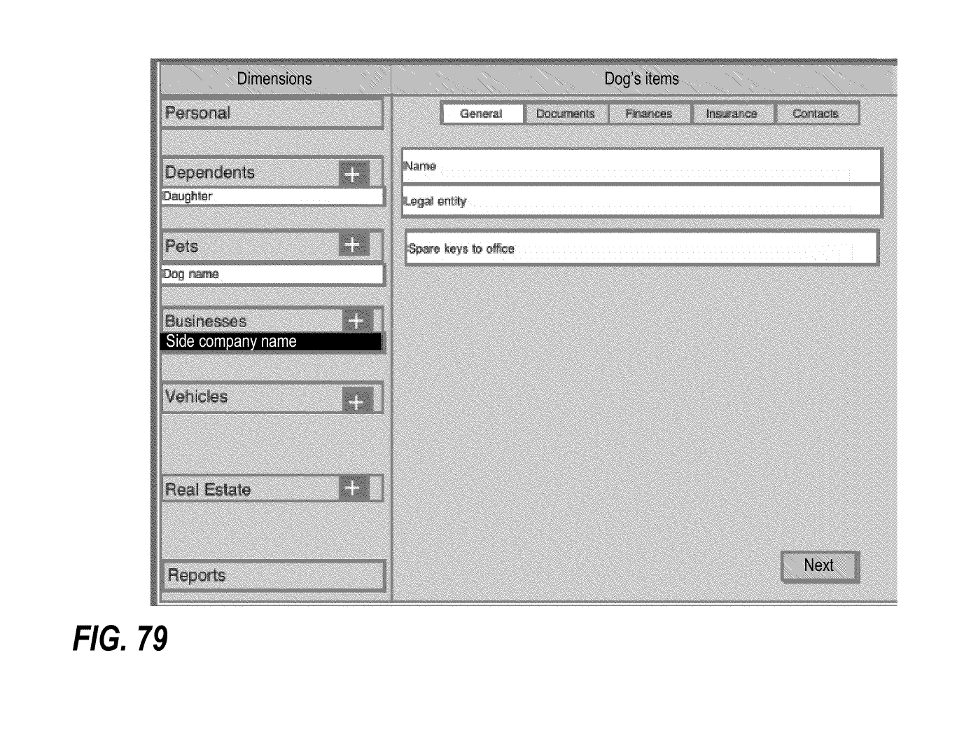

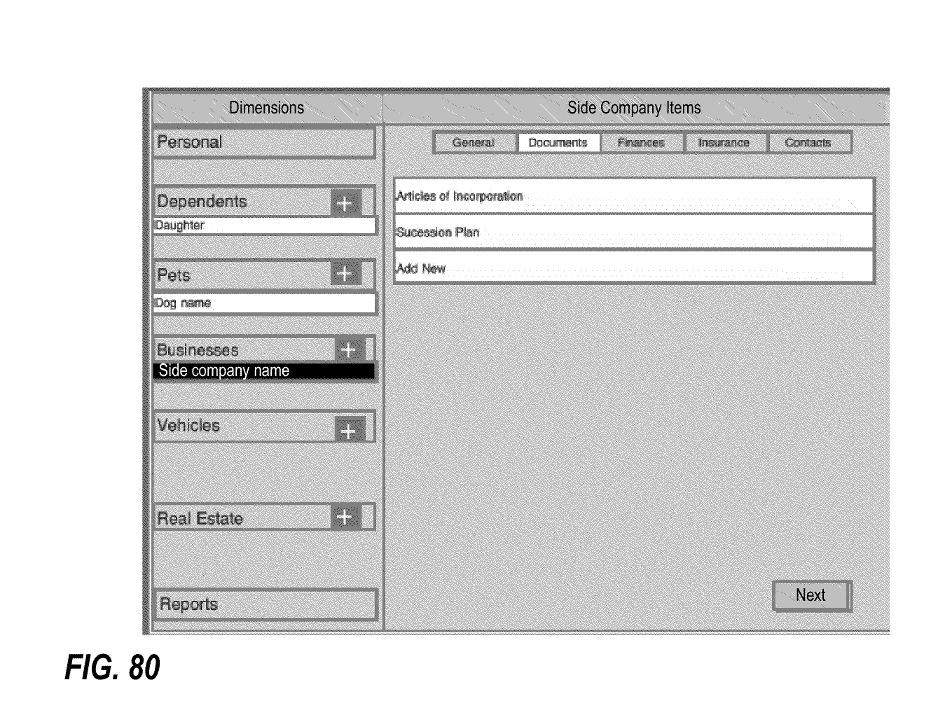

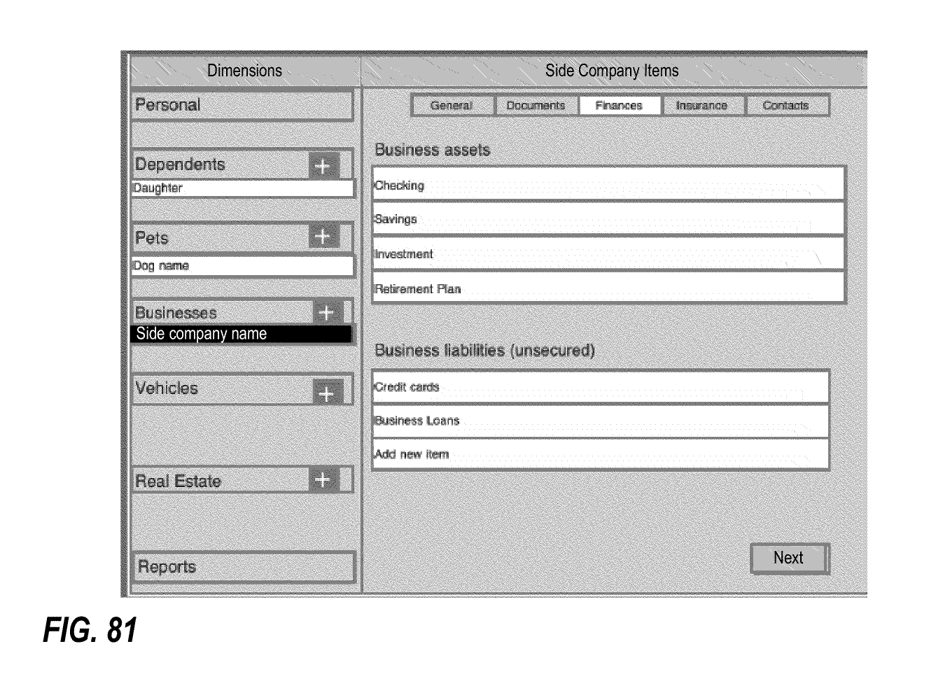

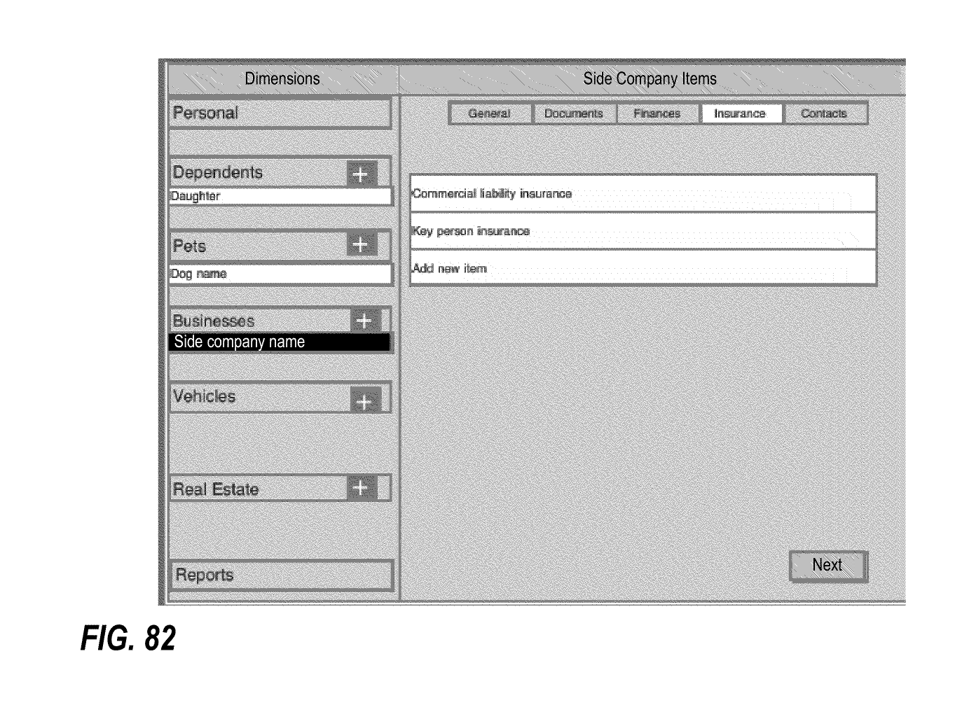

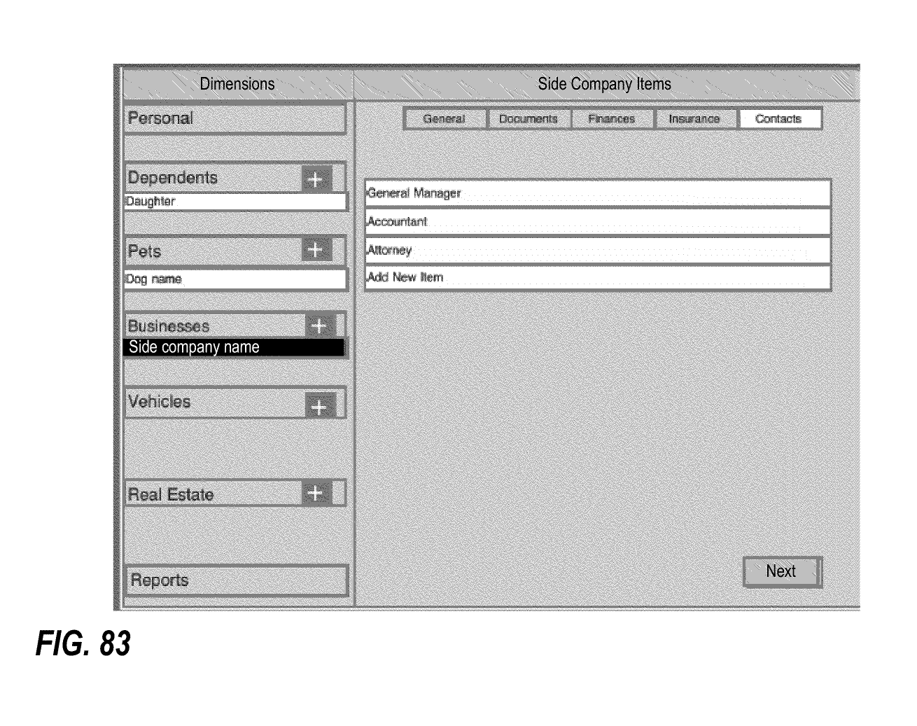

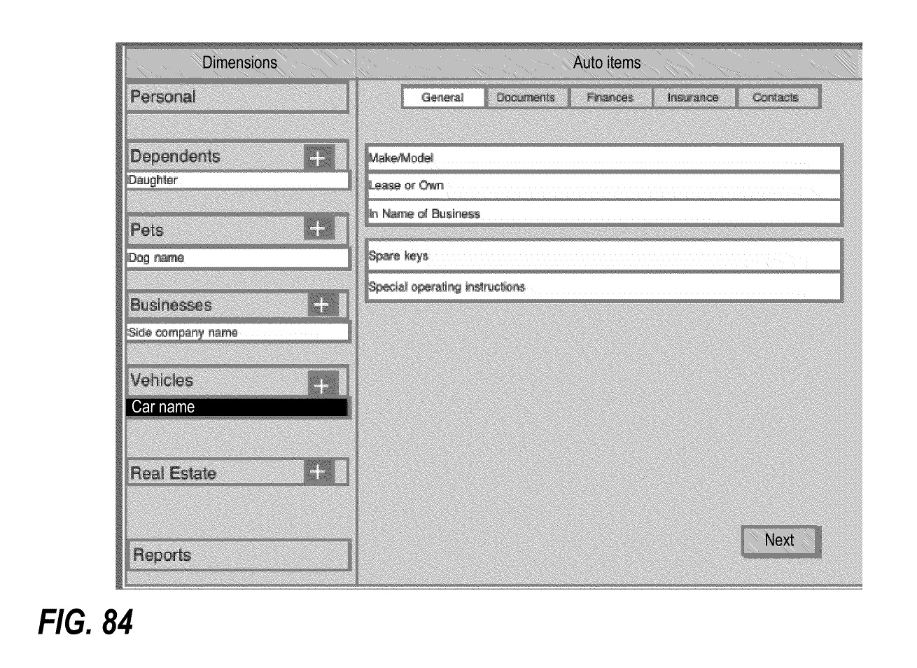

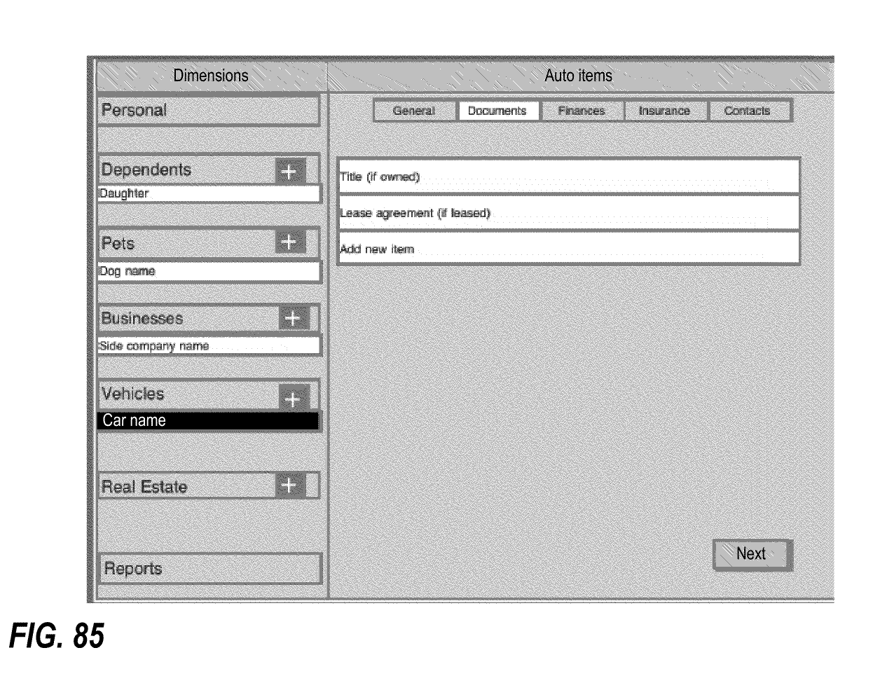

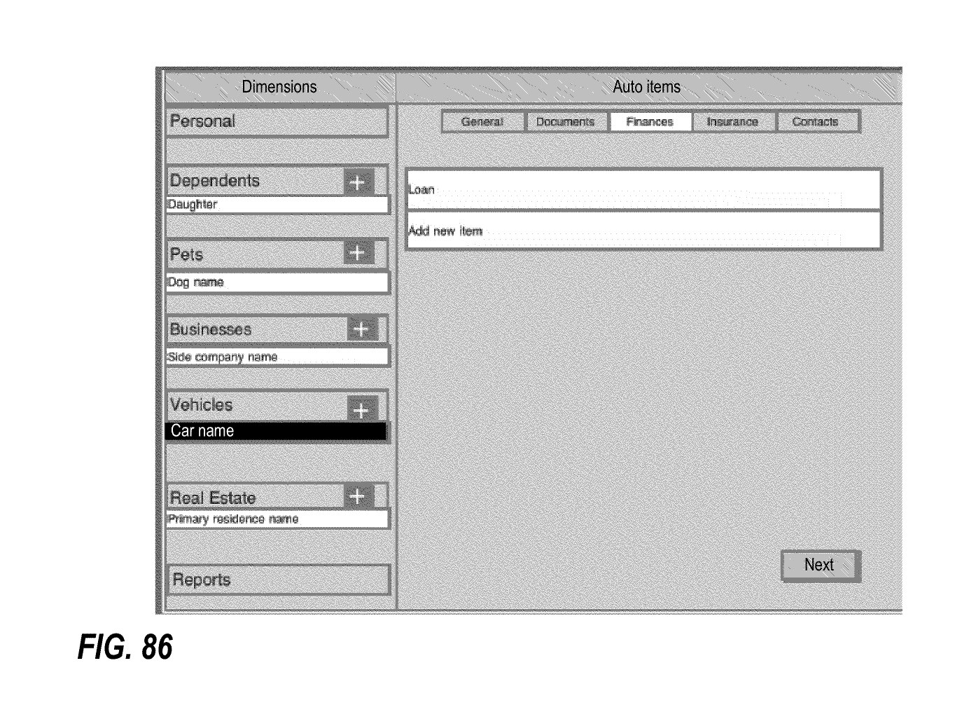

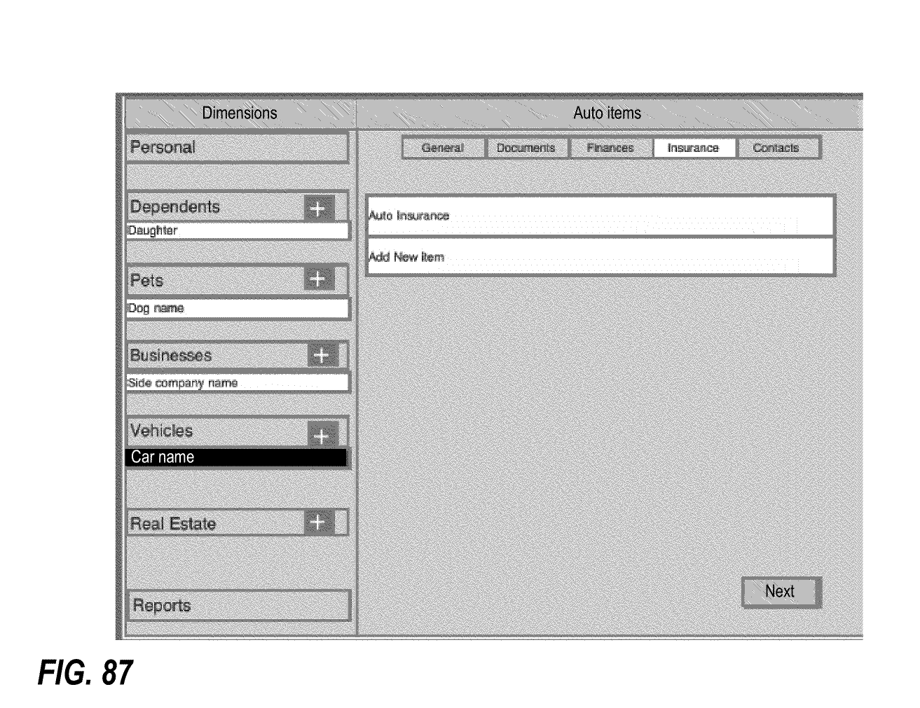

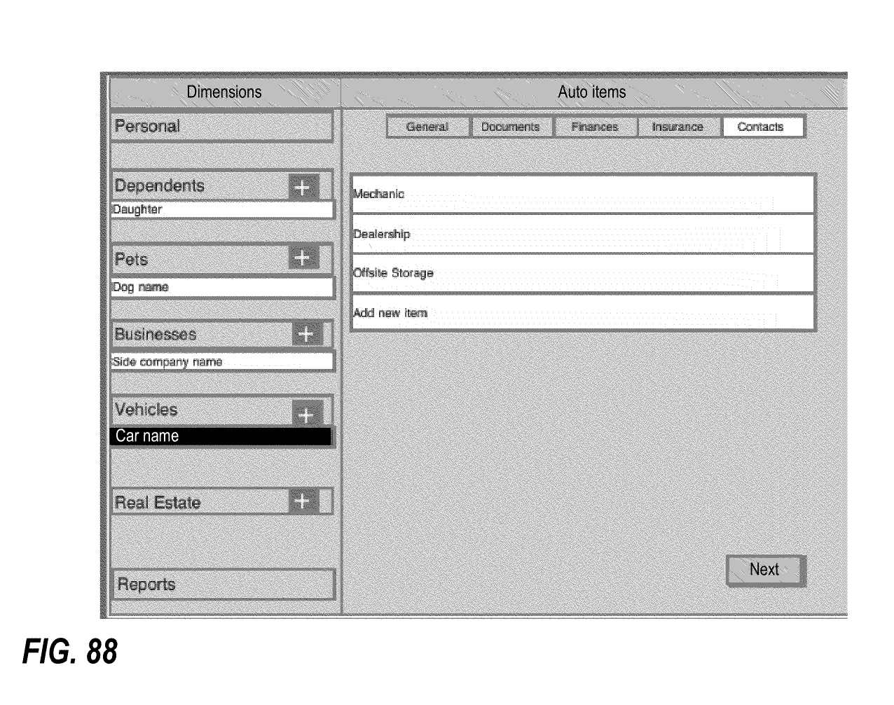

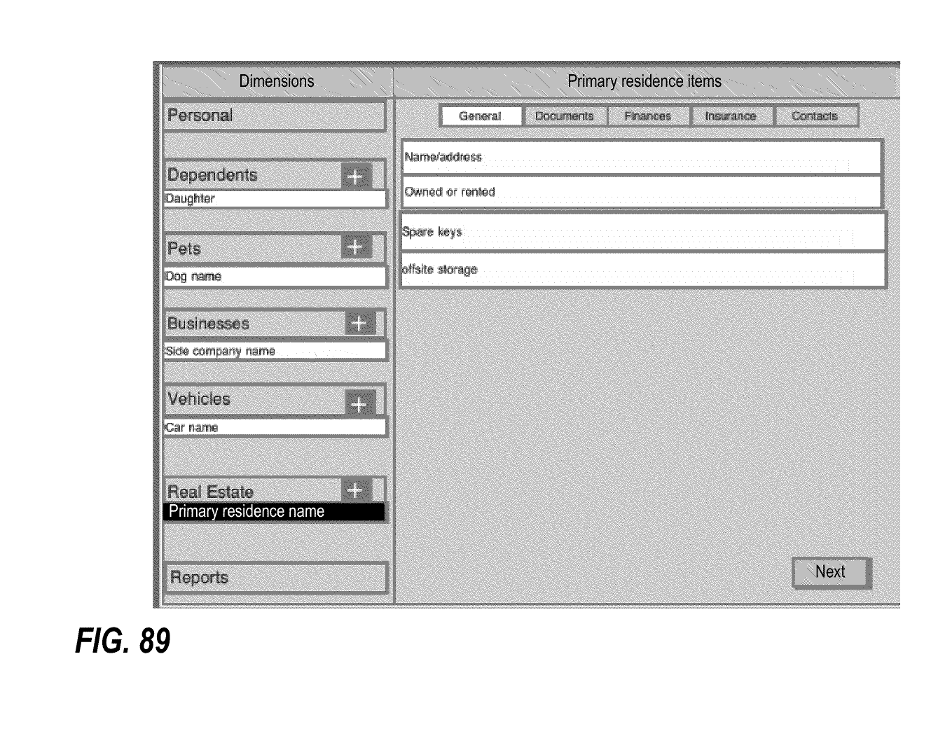

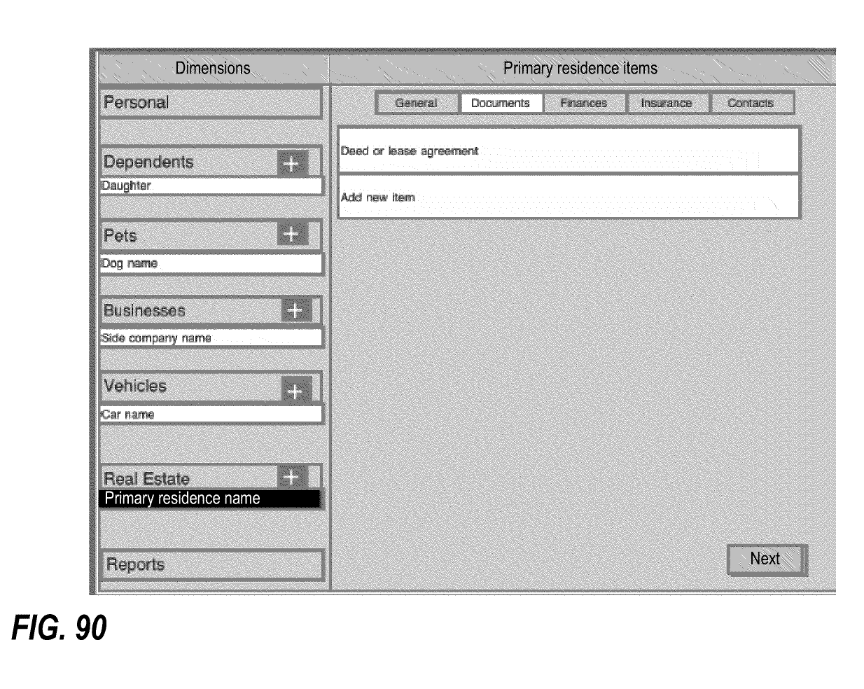

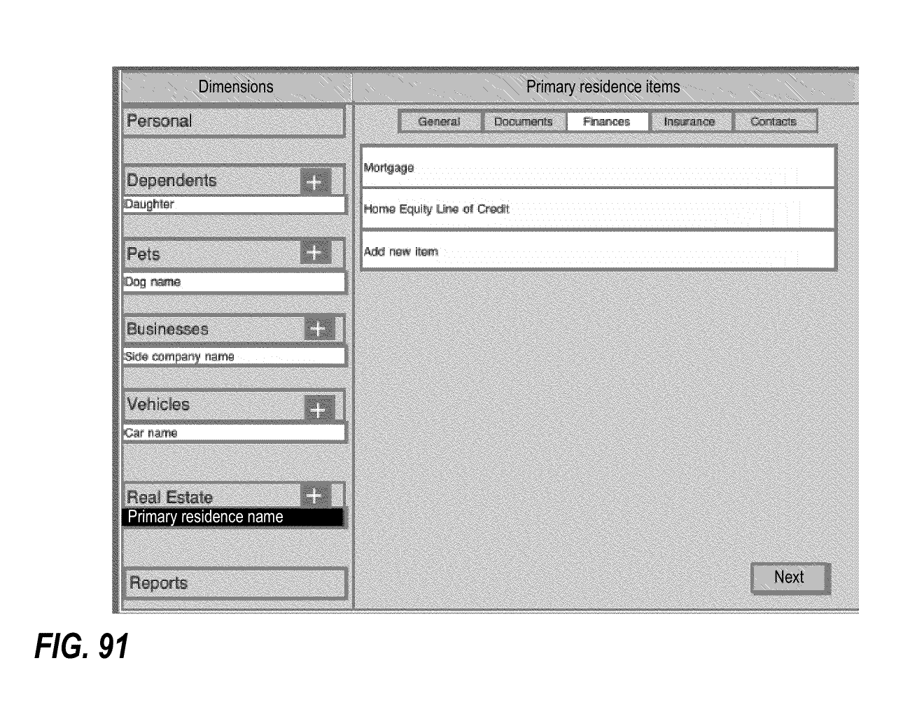

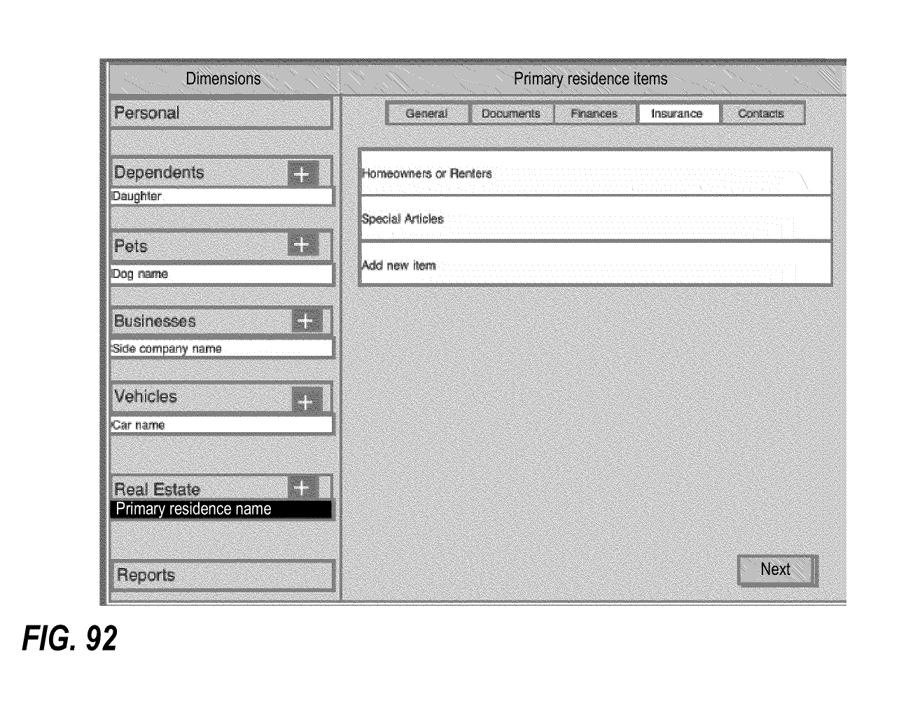

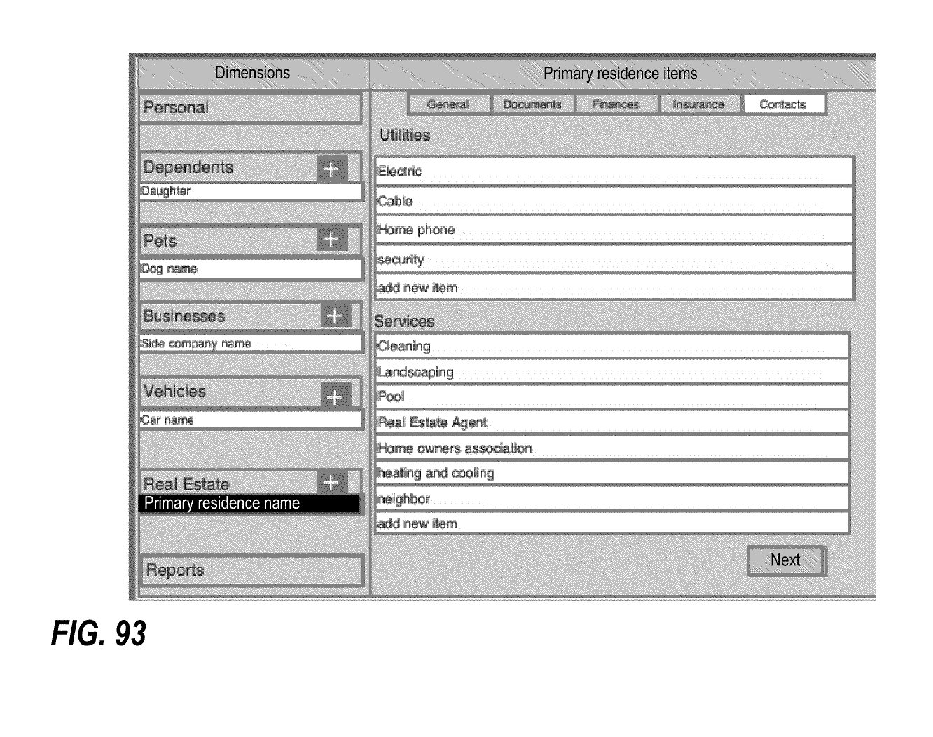

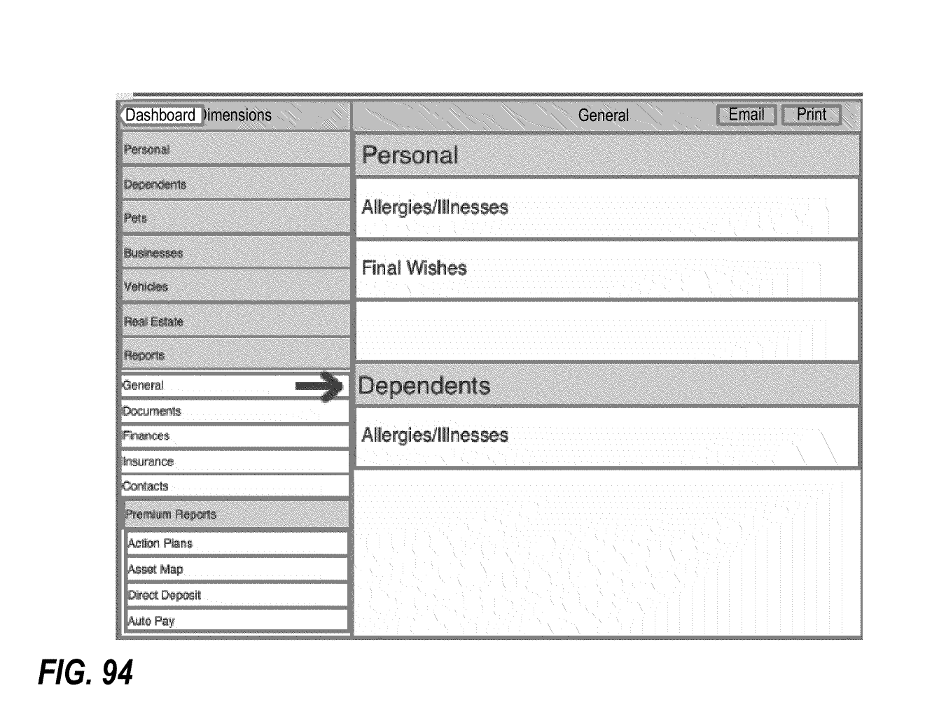

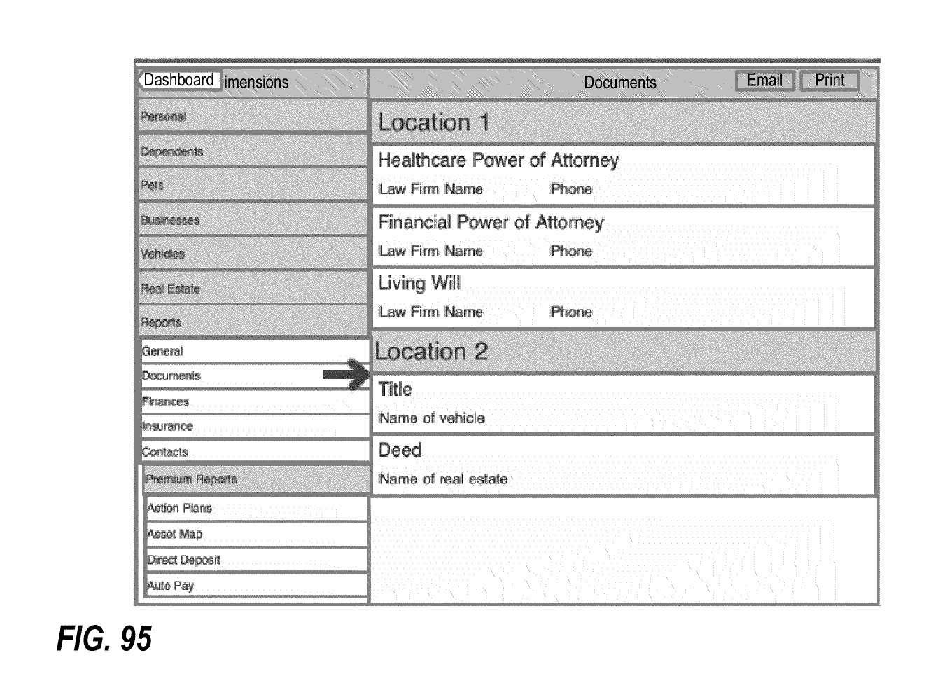

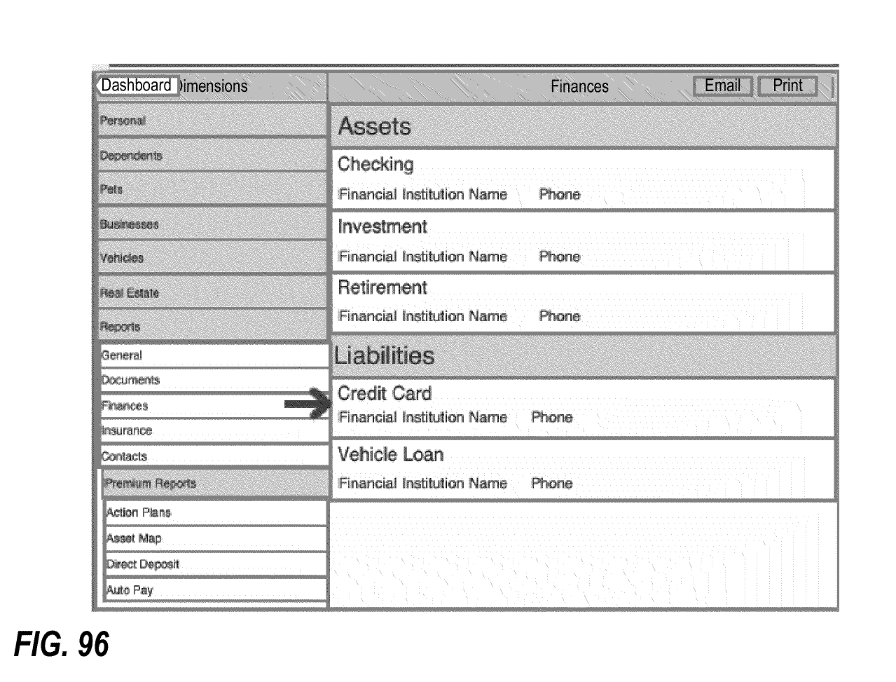

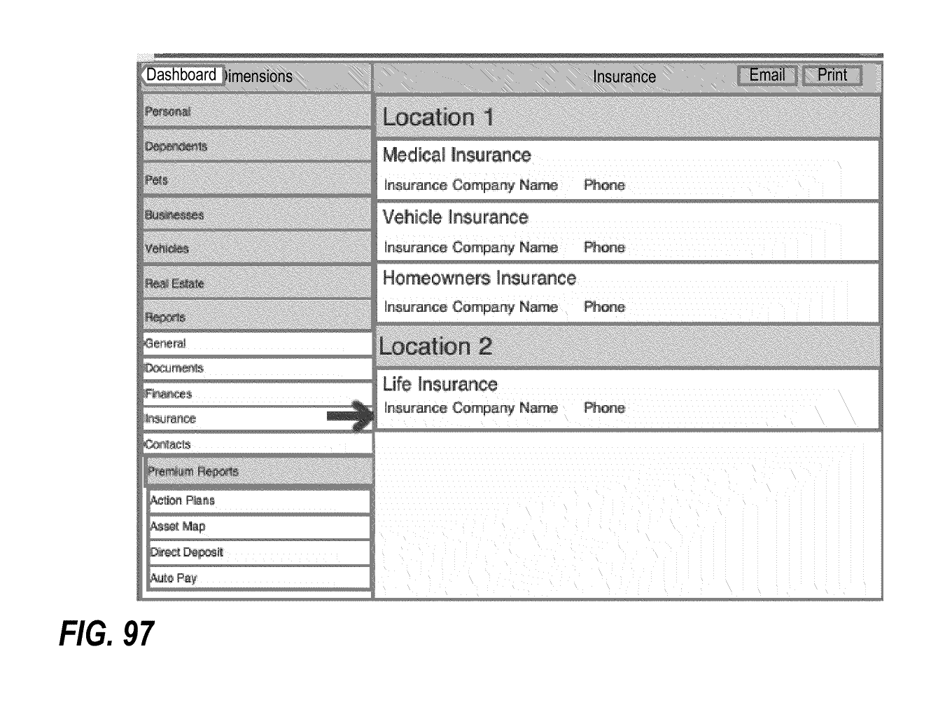

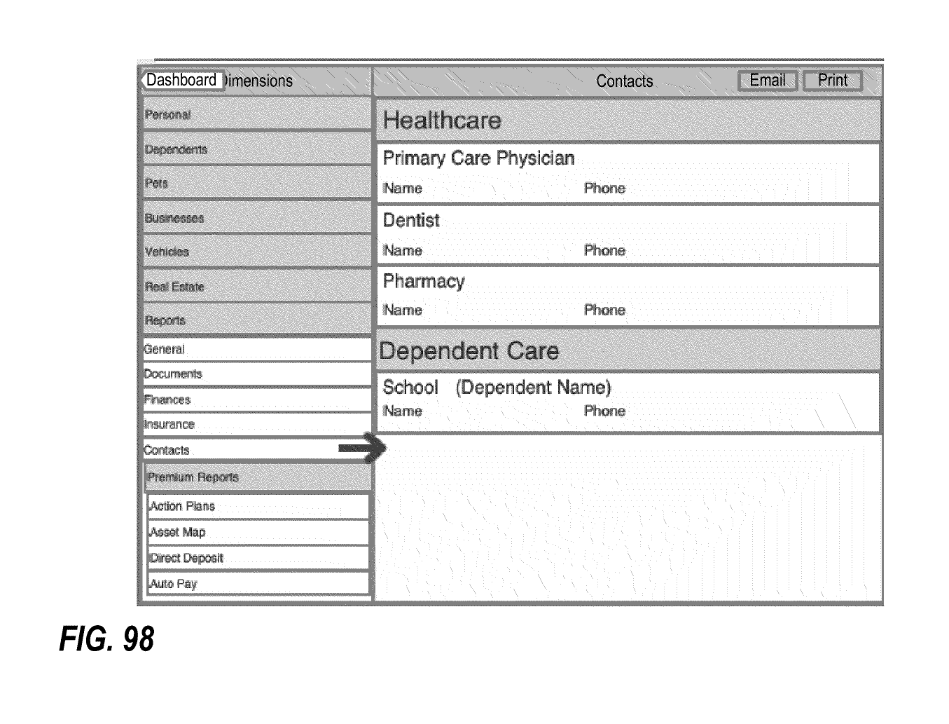

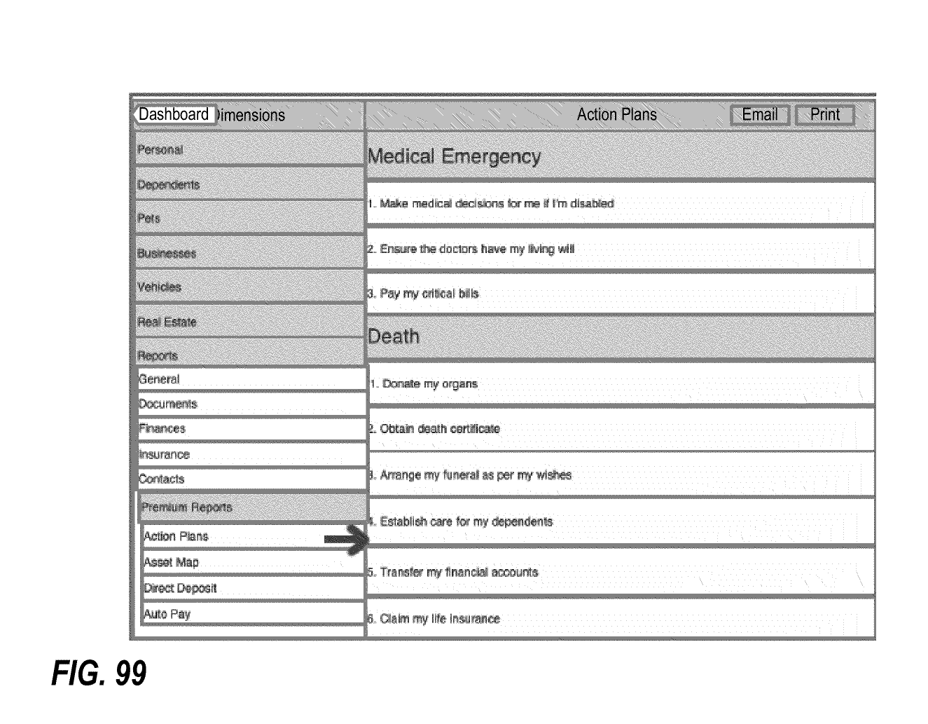

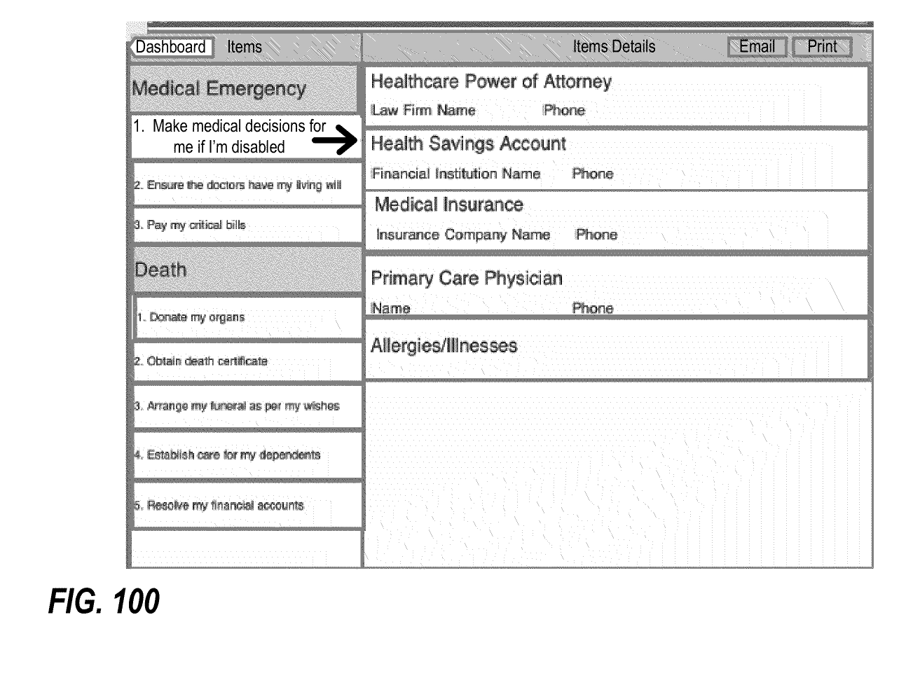

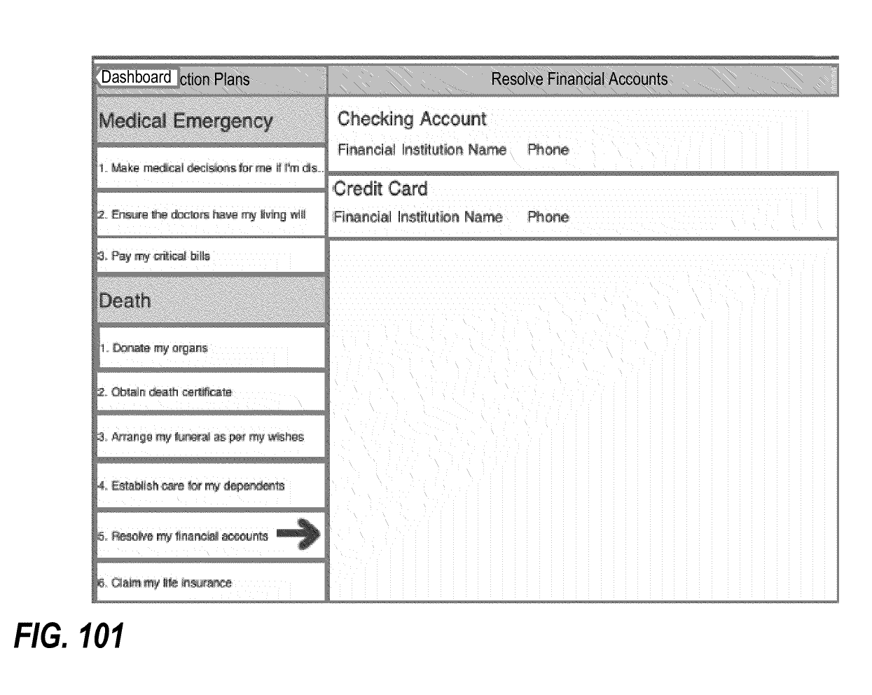

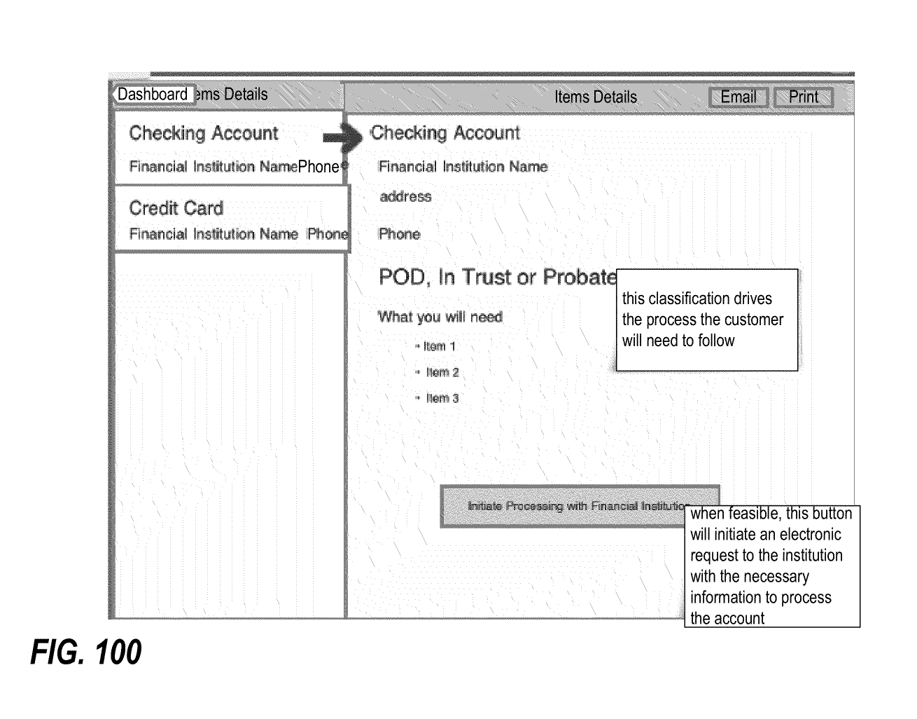

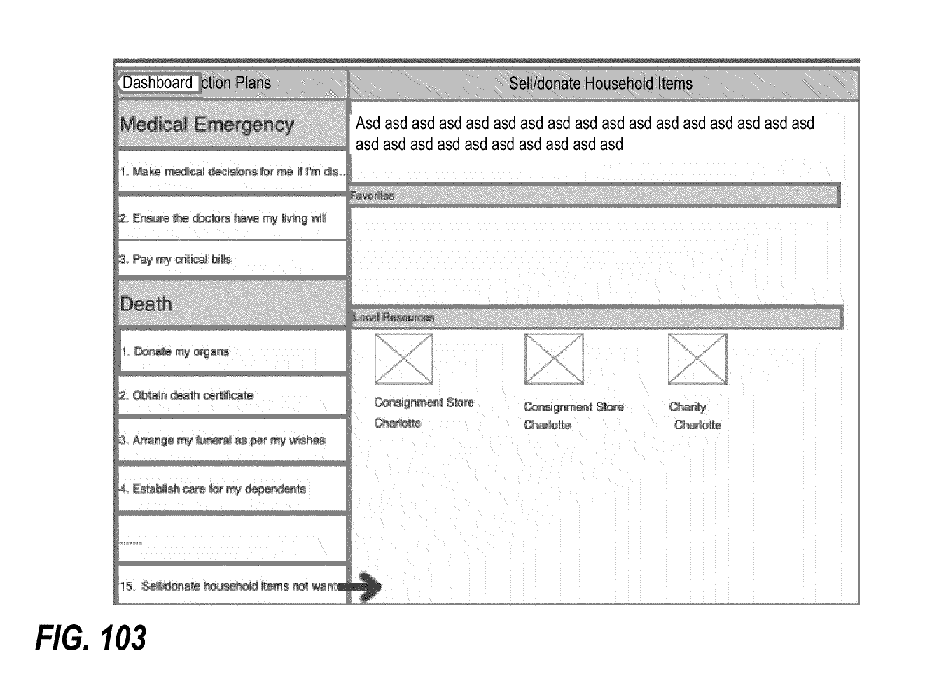

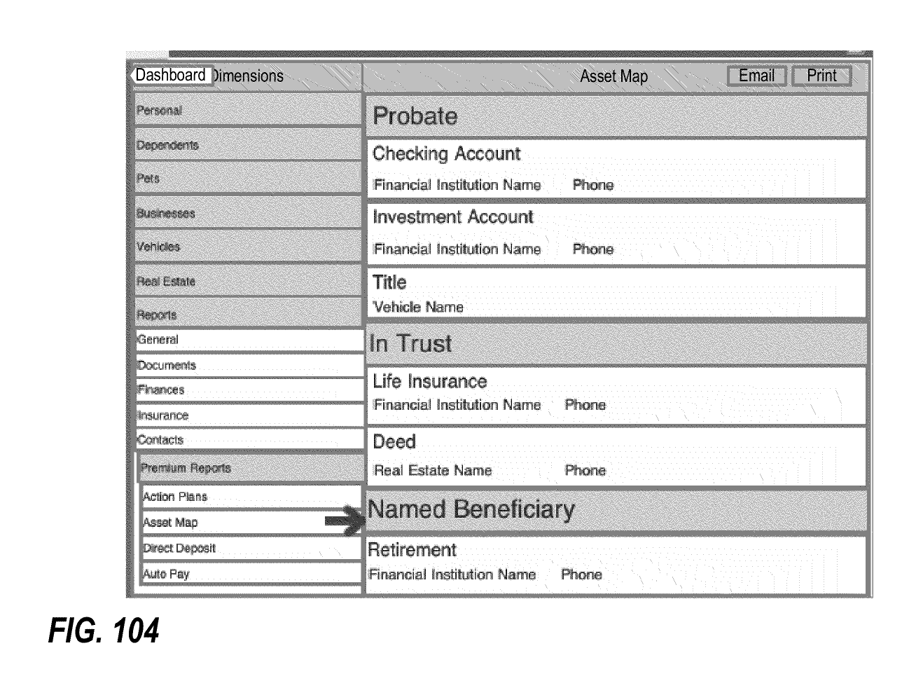

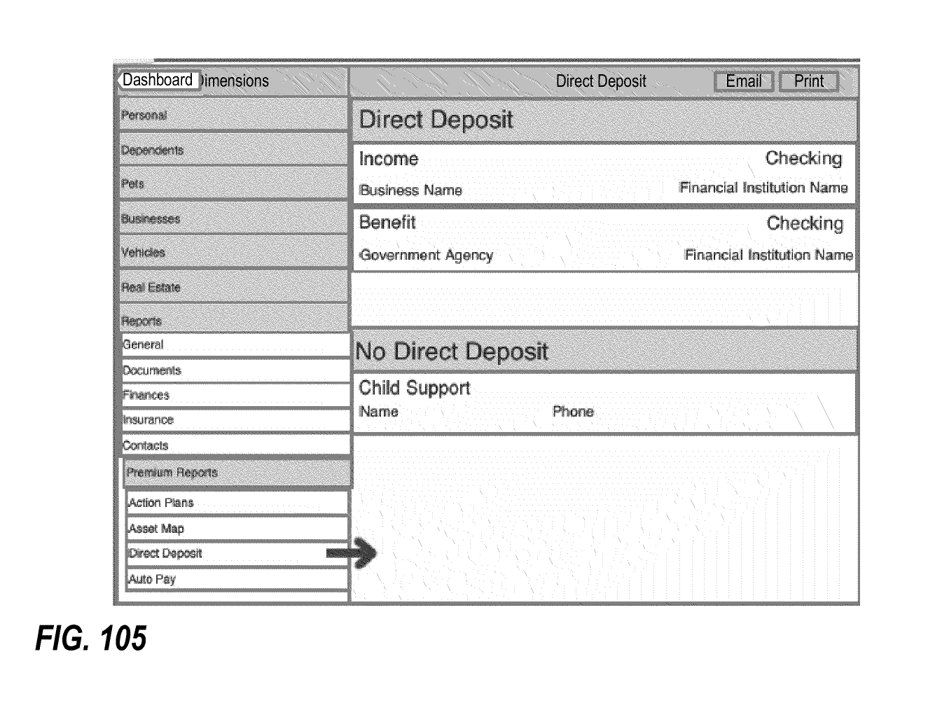

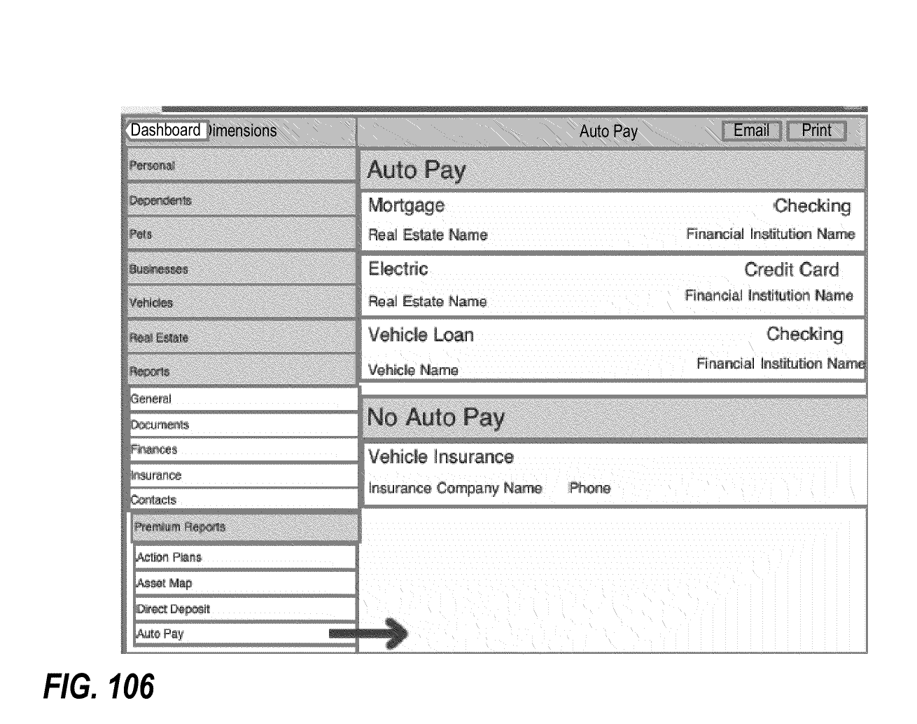

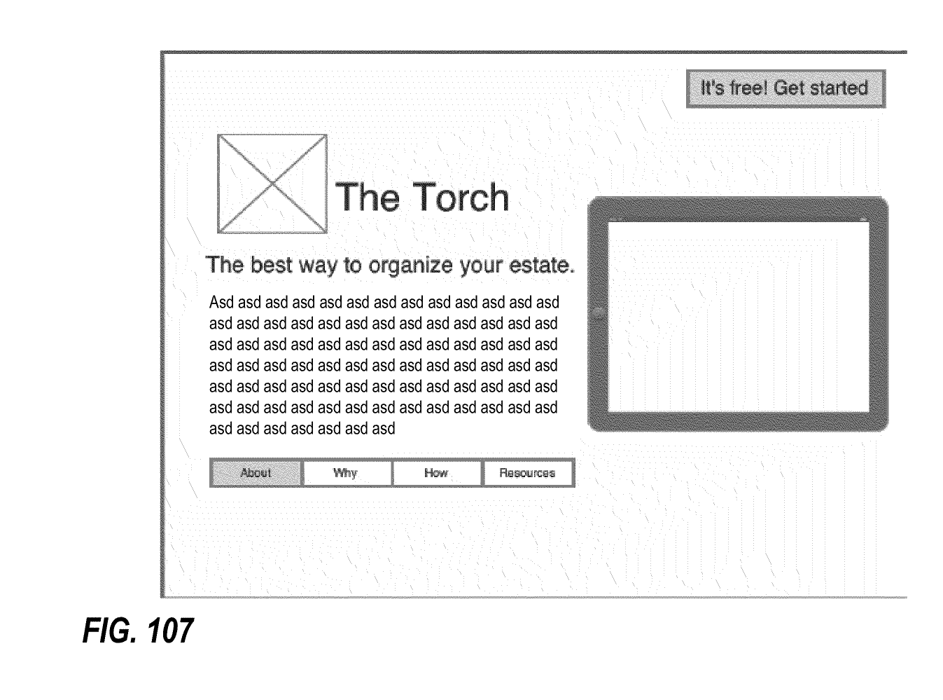

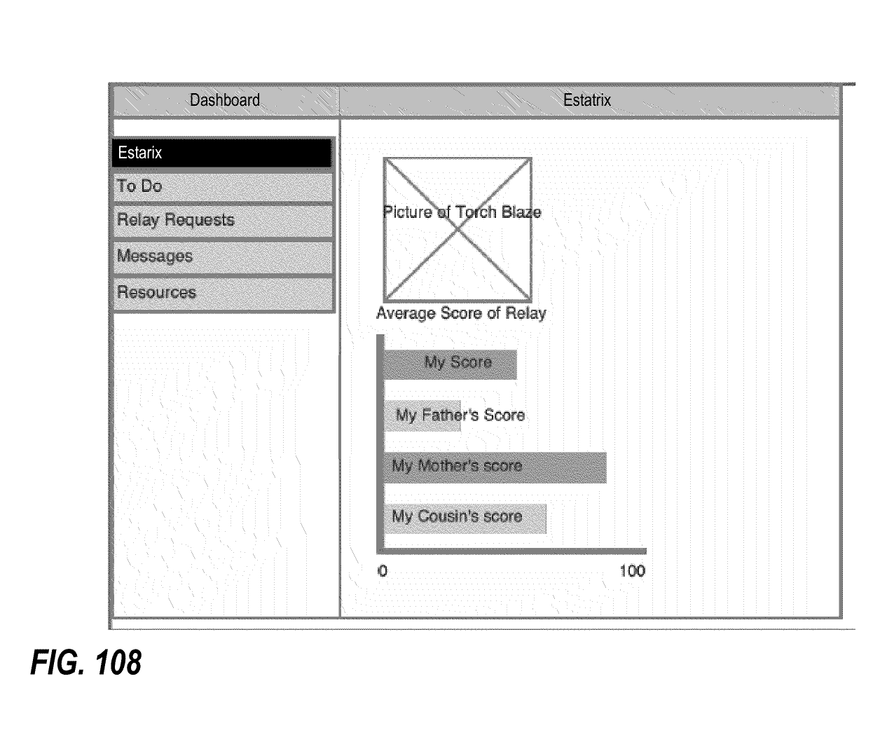

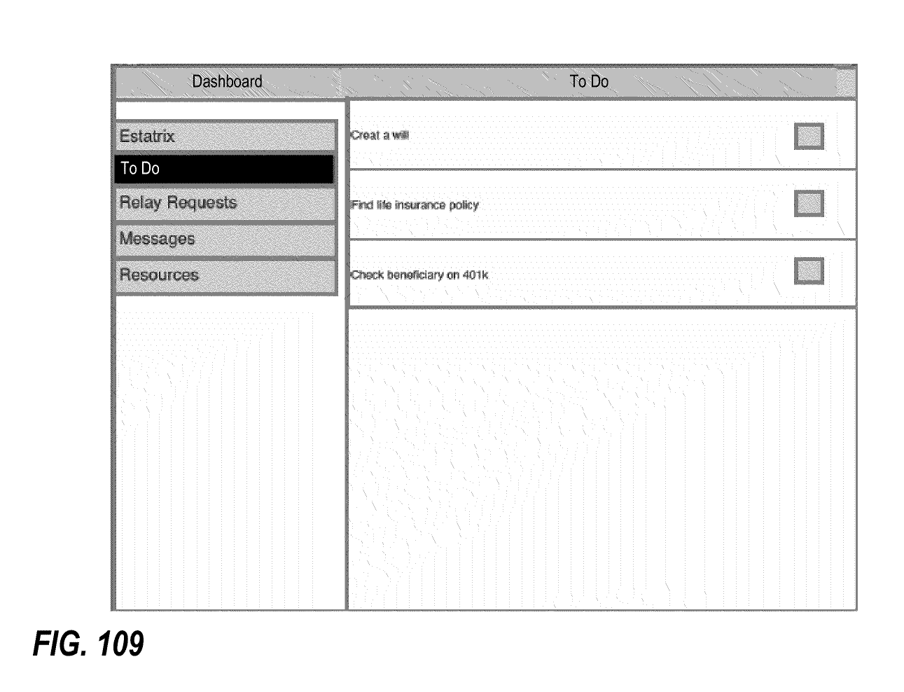

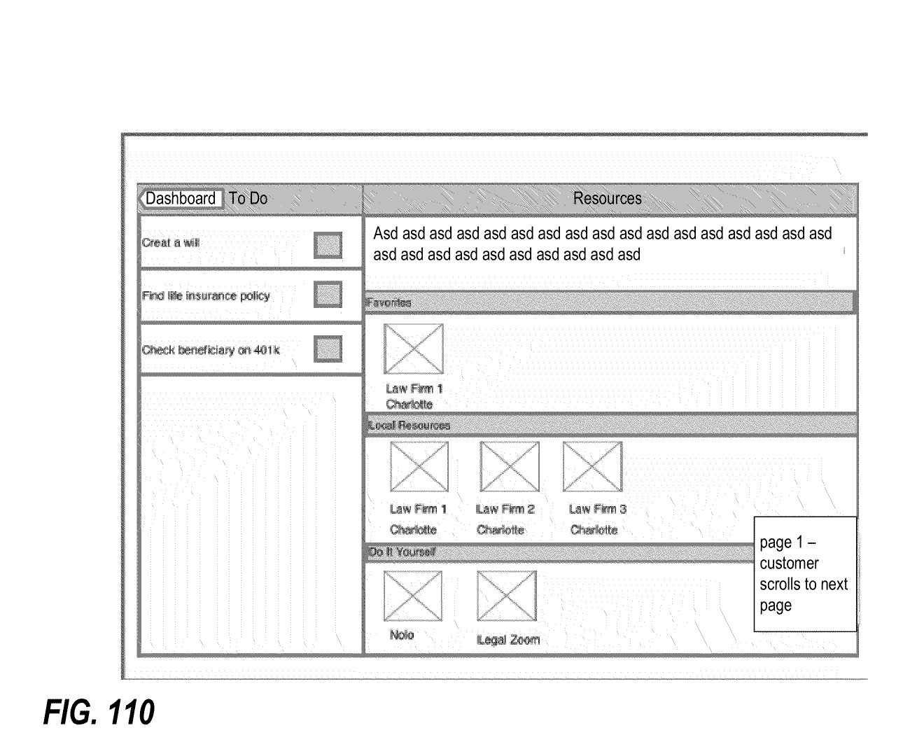

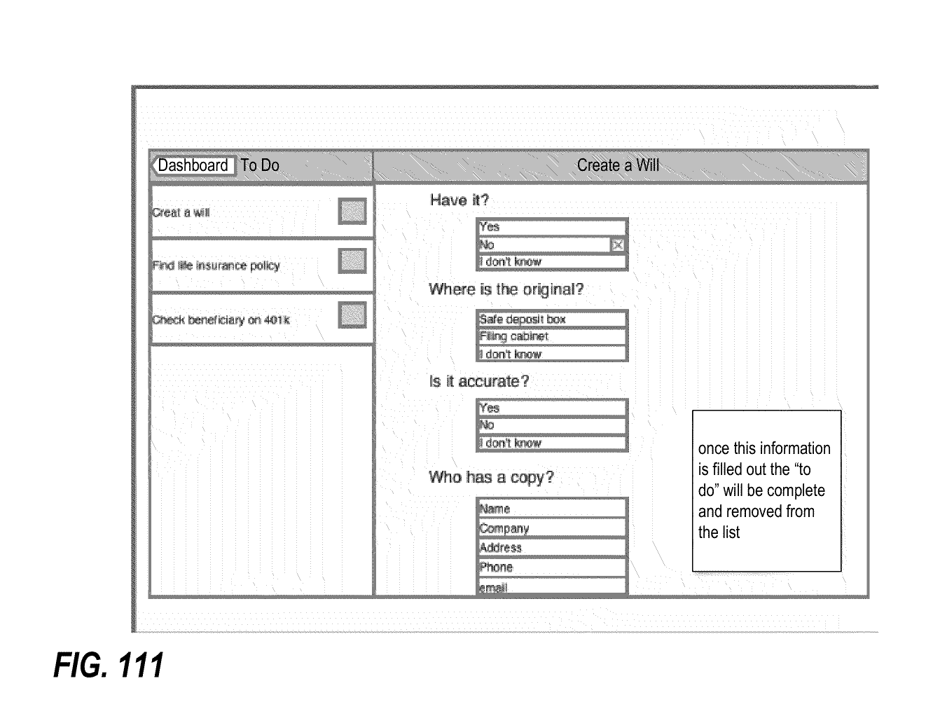

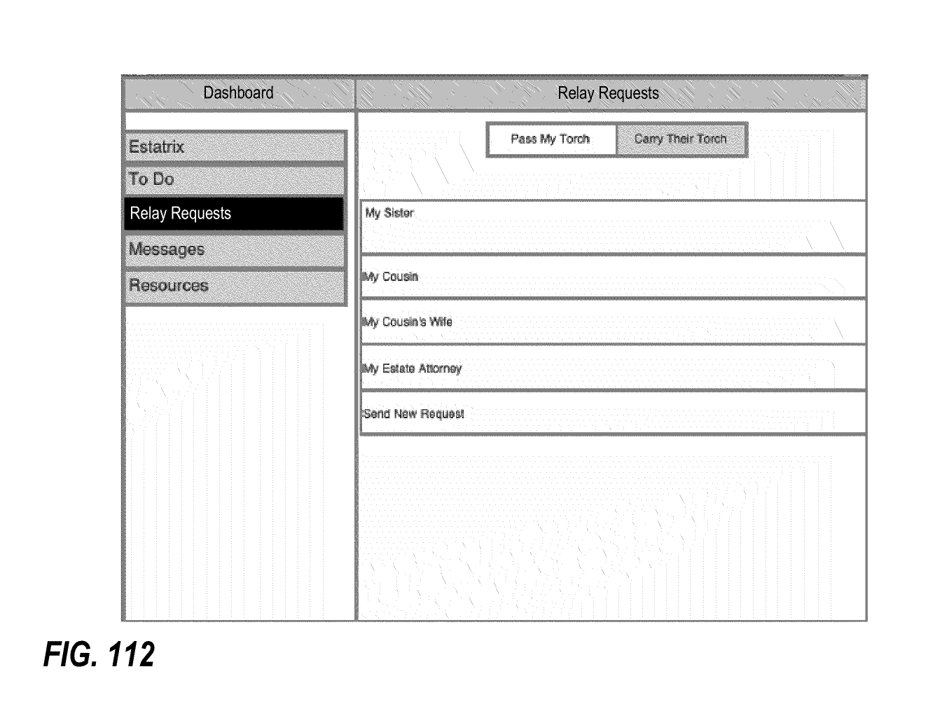

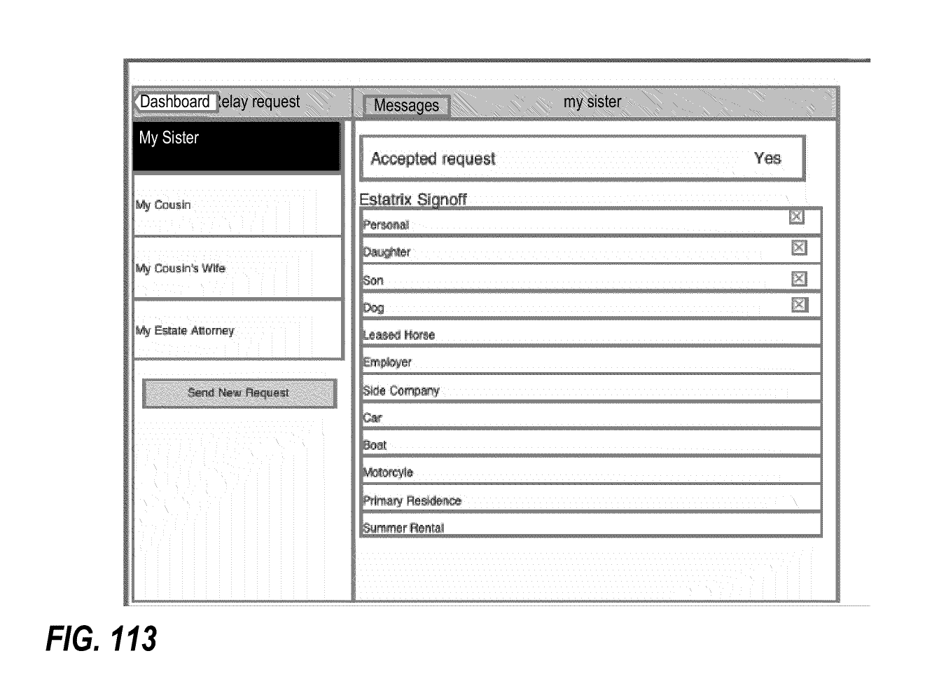

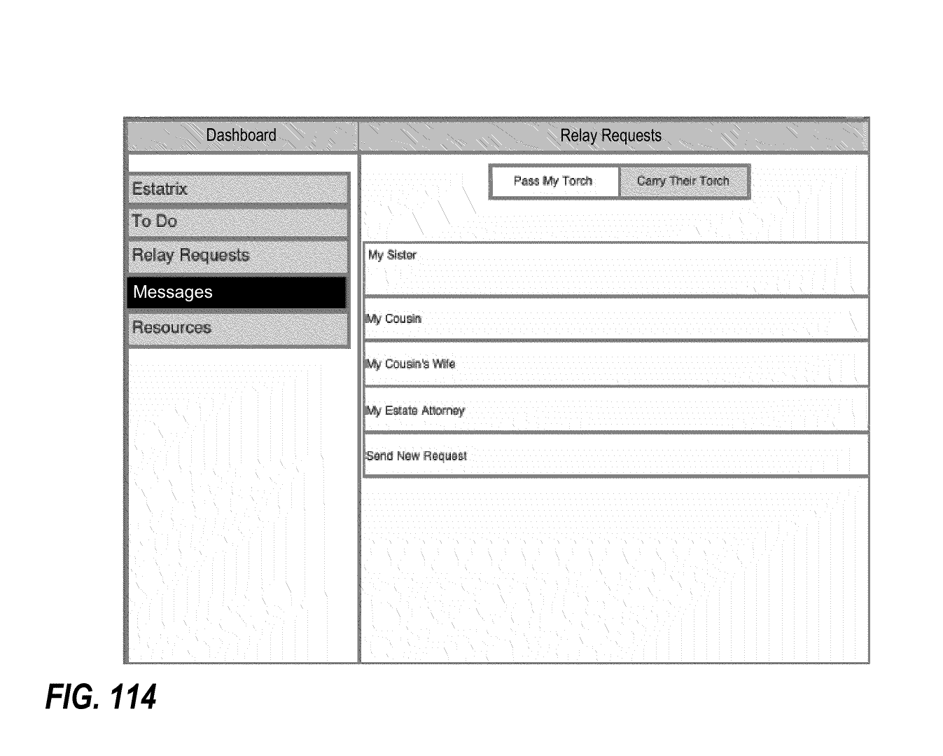

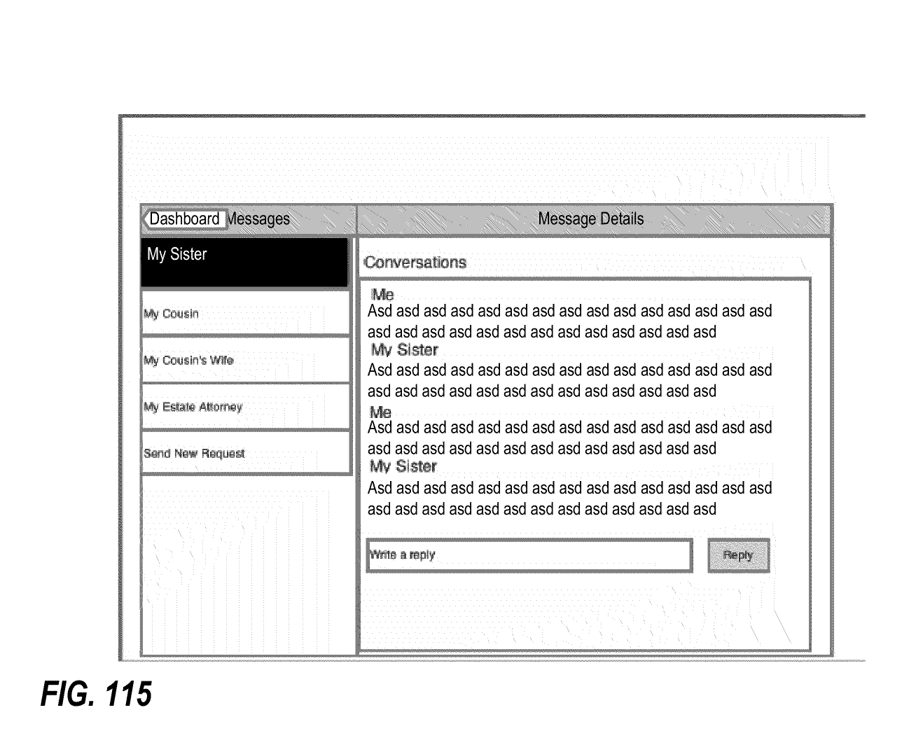

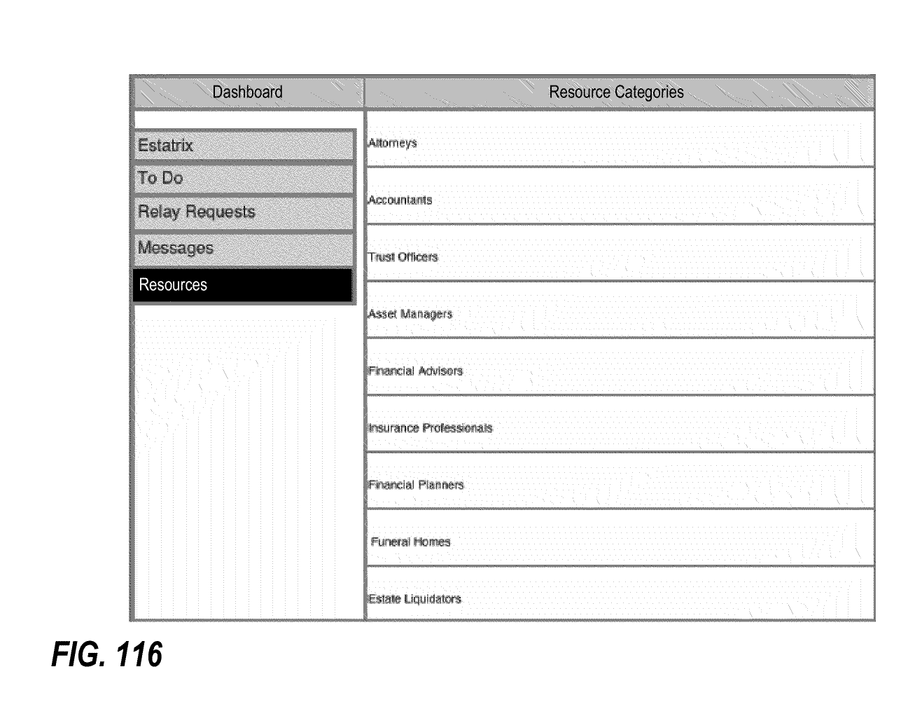

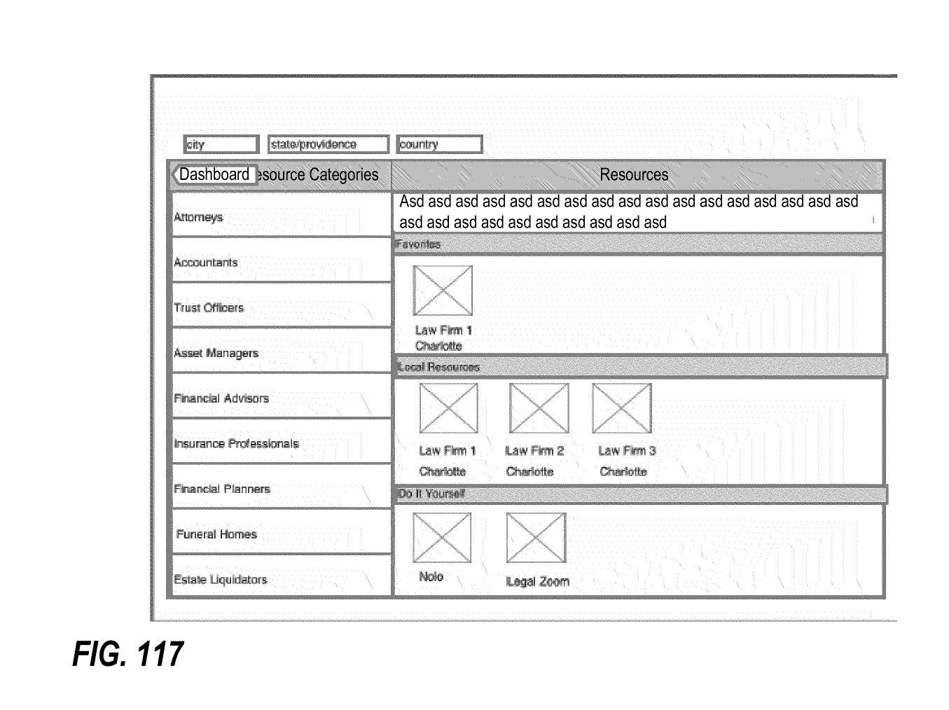

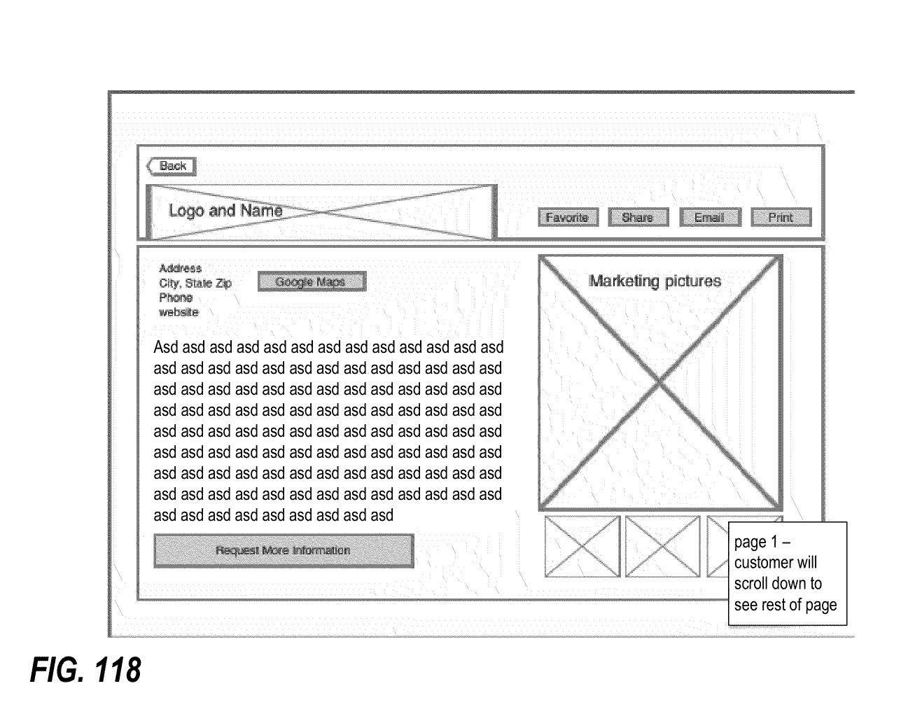

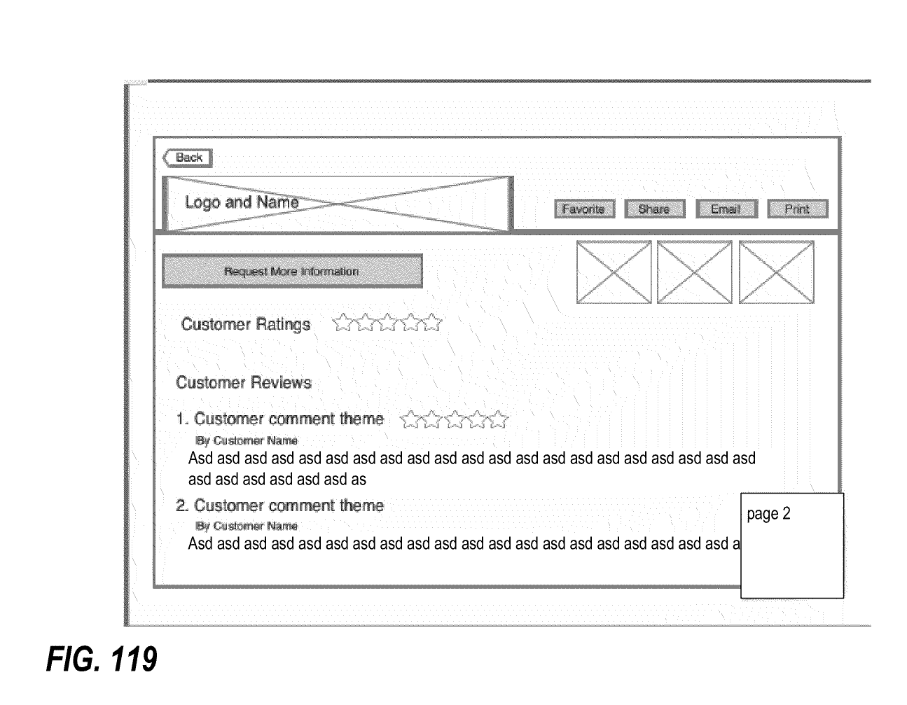

When an individual enters estate information, thereby generating an estate organizer and a Torch Score, and passes their Torch to loved ones and advisors, the system generates and sends an email to each person in their network at step 106. Such an email may include a link to a system website. Each such loved one or advisor logs into the system website at step 107. This website is preferably the same website, or part of the same website, as the website used by the individual in steps 101-104, but in some embodiments could be separate. The loved one or advisor may review the individual's estate organizer at step 108. This and other features may help facilitate cooperation and collaboration between the individual, loved ones and advisors. In at least some embodiments, a graphical user interface similar to the one illustrated in FIGS. 8-46, the one illustrated in FIGS. 58-119, or a combination of both may be used for this purpose. Based on the estate information, the system provides, at step 109, a control dashboard, basic inventory or other item information, customized action plans or checklists (described hereinbelow), asset maps, financial flows, templates, reports, and the like, to make it easier for the estate owner to plan, organize, and manage his or her estate and to make it easier for the estate owner's loved ones to manage the estate owner's affairs, including their estate, and to carry out the estate owner's instructions. In particular, in at least some embodiments, such action plans provide details for loved ones regarding all of the steps they must perform to organize the estate of the individual in the event of a personal emergency or disablement and/or settle the estate in the event of death.

The system may also connect the loved ones with appropriate professionals at this point. In at least some embodiments, the action plans have embedded referrals to national professionals, local professionals, online resources, and/or the like, providing services specifically needed by the loved ones.

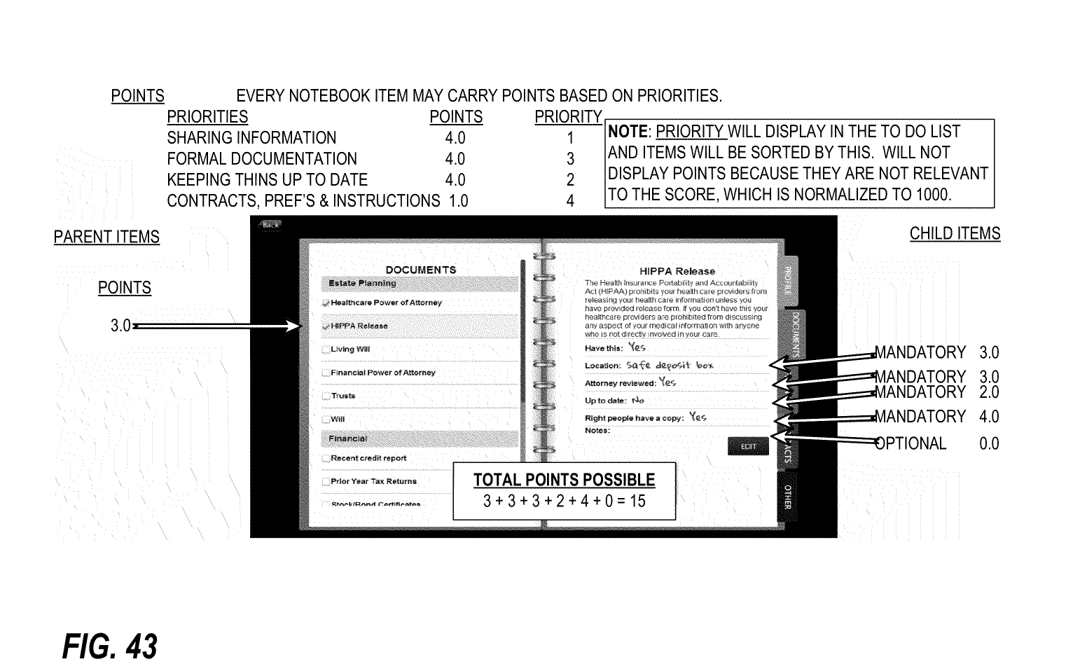

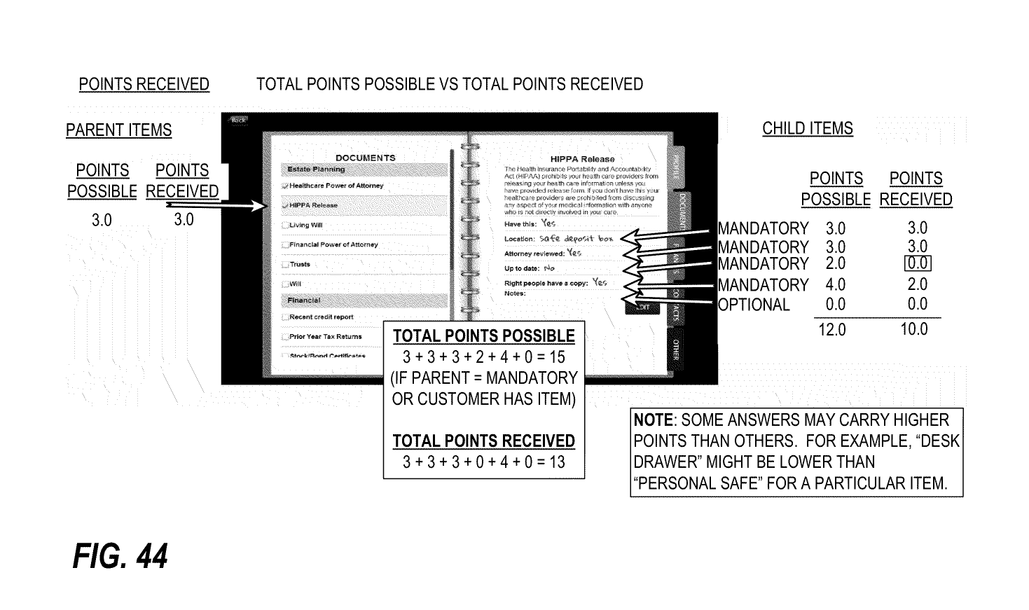

The estate information utilized may include the estate organizer and the Torch score. If the decision maker has questions about any of the estate information, he or she may use messaging made available by the system at step 110. In this regard, a “messaging” feature may be provided where customers can exchange messages with people in their network. This is illustrated, for example, in FIGS. 43 and 44 and/or in FIGS. 114 and 115.

Once the loved ones and advisors understand all of the estate information for the individual, he or she confirms their understanding at step 111, which in turn causes the system to recalculate the individual's score or “Torch Score” at step 112. As used herein, to “confirm their understanding” may mean to confirm that the person understands the information in the estate organizer and accepts the responsibility of being a decision maker for the particular individual in the event of a personal emergency, disablement or death (sometimes referred to herein as a “life event”).

Professionals (advisors) are likewise encouraged to use the system. An advisor wishing to use the system first logs in to a system website at step 113. This website is preferably the same website, or part of the same website, as the website used by the individual in steps 101-104 and the website used by the decision maker in steps 107-111, but in some embodiments could be separate. The website solicits information from and about the professional and may or may not purchase a premium account at step 114. If so, then once the advisor is cleared, he or she can create an advertising page at step 115. At steps 116, the ad page may be delivered to individuals and loved ones having a need for the services offered by the advisor. Furthermore, at step 117, the ad page and/or other information about the advisor are included in an online directory. The directory may be organized by category, and may be searchable by individuals and loved ones. Other premium features may include a dashboard of their clients scores, access to their clients To Do lists (not just their own), limited access to update their client's accounts, a resource listing branded with their picture or logo and sorted to the top, and a dashboard with traffic and lead statistics from their resource listing.

On the other hand, even if at step 114 the advisor does not purchase a premium account, the advisor may still access client torches that are passed to them at step 118, attend to their own To Dos at step 119, and edit their own info at step 120. In at least some embodiments, these features are available to both premium account purchasers and those who do not purchase premium accounts.

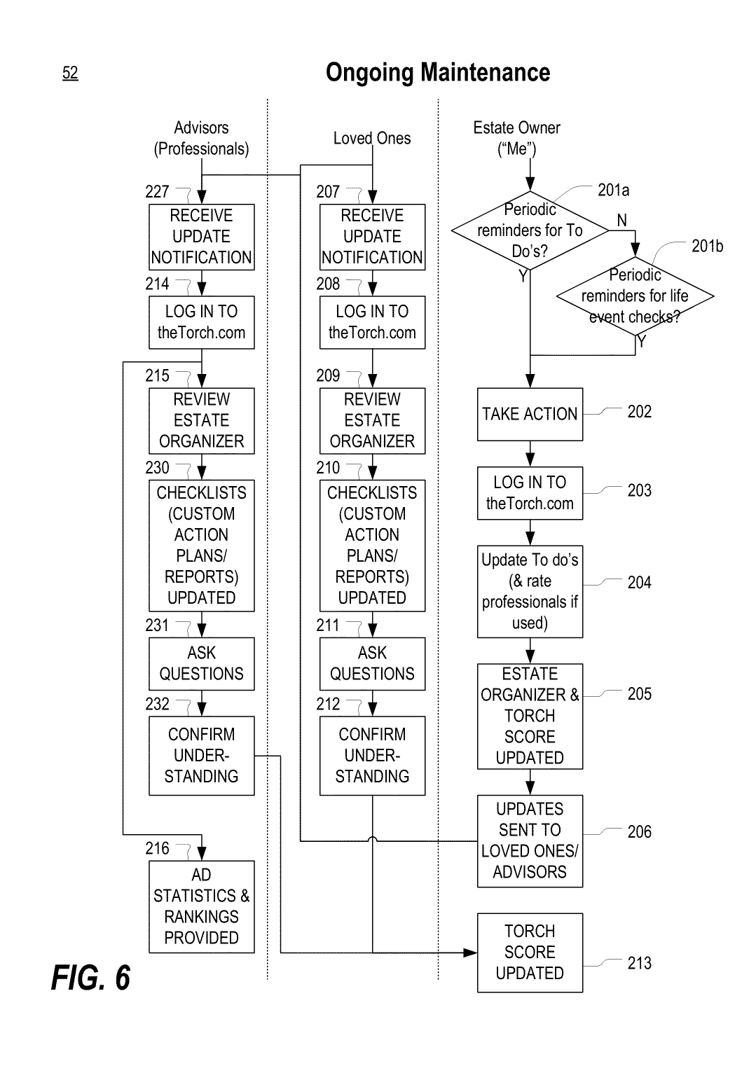

Once some or all of the steps in FIG. 3 have been carried out, the system 10 may be used to carry out ongoing maintenance activities. FIG. 6 is a flowchart illustrating the operation of the system 10 of the present invention during ongoing maintenance activities 52. As shown therein, if there are periodic to-do reminders at step 201a, or periodic life event check reminders at step 201b, then at step 202 the individual may take appropriate action in response thereto. In at least some embodiments, this action is taken outside of the system and its website(s). When the action is completed, the individual may log into the system website at step 203 and update his or her to-do's accordingly at step 204. Optionally, if the individual utilized the services of a participating advisor in addressing the to-do item, he or she may also rate that advisor accordingly. Once the to-do's have been updated, the system updates the individual's estate organizer and score or Torch Score at step 205 and sends an update to the individual's “network” at step 206.

When an individual takes a maintenance action with regard to their estate information, thereby updating their estate organizer and score, the system generates and sends an update notification email to each person (loved ones and/or advisors) to whom the individual is passing their torch at step 207 or step 227. Each such loved one or advisor logs into the system website at step 208 or step 214, respectively, and may review the individual's estate organizer at step 209 or step 214, respectively. Based on the estate information, the system updates the custom checklists or action plans at step 210 or step 230, respectively. The system may once again connect the loved ones with appropriate professionals or online resources at this point. If the loved one or advisor has questions about any of the estate information, he or she may ask them at step 211 or step 231. Once again, the messaging feature may be utilized for this purpose. Once the loved one or advisor understands all of the estate information for the individual, he or she confirms their understanding at step 212 or step 232, respectively, which in turn causes the system to recalculate the individual's score or “Torch Score” at step 213. Additionally, advisors may be able to view statistics and rankings pertaining to their branded ad at step 216. This latter feature may, in at least some embodiments, be limited to advisors with premium accounts.

In at least some embodiments, an individual's score or Torch Score is adjusted upwardly (sometimes referred to herein as “stoking” the Torch Score) or downwardly (sometimes referred to herein as “dimming” the Torch Score) over time. Stoking may be achieved, for example, when an individual completes more of his or her “To Do's,” when an individual influences people in his or her network to complete more of their “to-do's,” and/or when a person confirms that they understand the instructions and other information of people in their network. In some embodiments, extra credit may be added for going above and beyond the minimum requirements for an individual's affairs. Dimming may occur, for example, when an individual leaves items in their estate organizer uncompleted (with greater dimming occurring the longer it remains incomplete), when people in an individual's network leave items uncompleted, and/or when a user fails to recheck their estate organizer on a periodic basis.

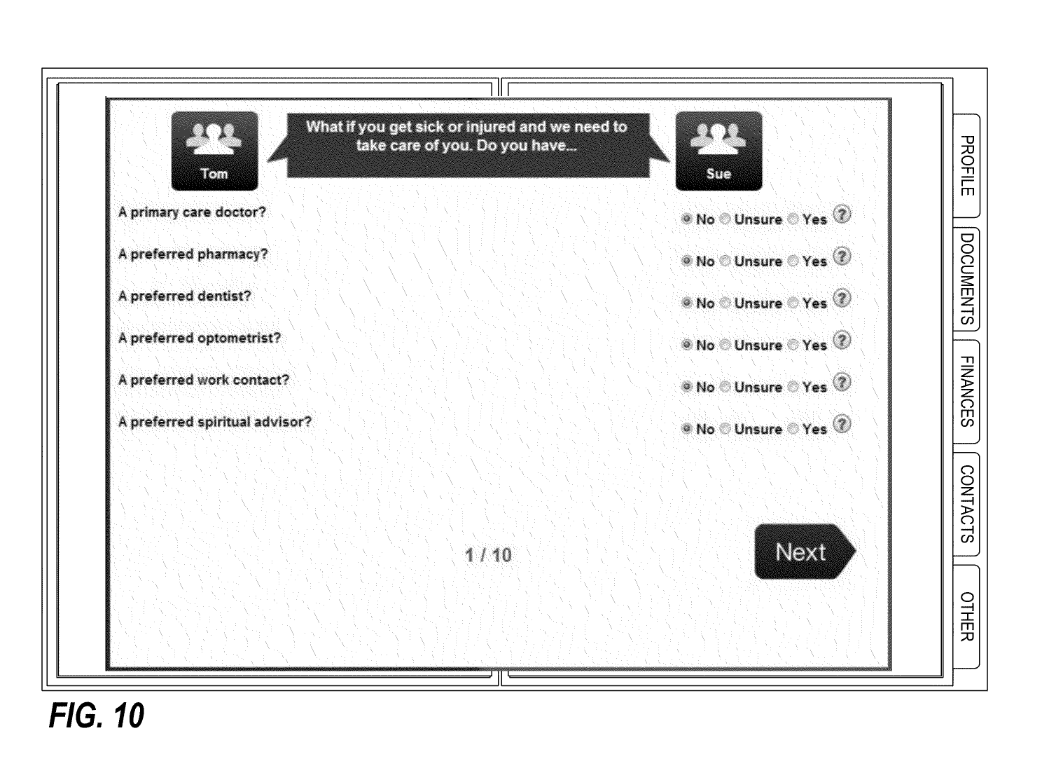

Referring again to FIG. 8, it will be appreciated that the graphical user interface may accommodate some or all of the functions described hereinabove as well as other functions. For example, as shown in FIG. 8, the option “Notebooks” has been selected, but alternatively, a depiction of a “To Do List” (and accompanying functionality) may be selected, a depiction of “Scores” (and accompanying functionality) may be selected, a depiction of “Network” (and accompanying functionality) may be selected, a depiction of “Resouces” (and accompanying functionality) may be selected, “Help” information may be selected, and/or “Account” information may be selected. With regard to “Notebooks”, a graphical representation such as that illustrated in FIG. 8 may be presented to the user that displays checklists and notebooks and includes the option of creating further notebooks. In particular, a “personal” notebook, which in at least some embodiments is mandatory, is displayed for Jane along with a single real estate notebook (for “Property #1”), a single dependent notebook (for “Child #1”), a single pet notebook (for “Pet #1”), and a single vehicle notebook (for “Car #1”). Further details may be provided with respect to FIGS. 10-46, described hereinbelow. Details of an alternative embodiment and/or alternative features may be provided with respect to FIGS. 58-X70, also described herienbelow.

Professionals (advisors) may re-enter the system website as well to review client information. If they have purchase a premium account, they will have additions features like a comprehensive client dashboard showing client scores and the ability to view client To Do lists, although in at least some embodiments such features are limited to advisors who purchase a premium account. As shown at step 214, an advisor may once again log into the system. In addition to reviewing the estate organizer at step 215, the advisor may also review ad statistics and rankings at step 216. Furthermore, the advisor may make changes to his or her advertising page or to other aspects of the information stored in the system about the advisor.

In at least some commercial embodiments, national and local vendors or other resources may pay for a listing, an ad, or the like in the resource directory. In at least some embodiments, the system may integrate a link to the resource ad into the user “To Do Lists” and “Checklists” to make easier for the users to find the resources they need when they need them.

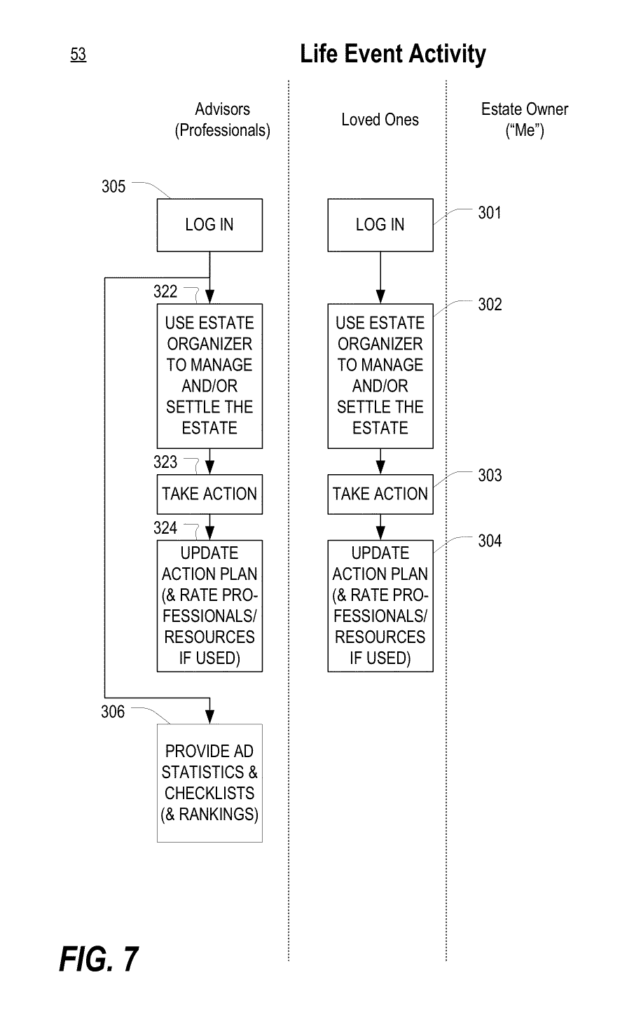

The system may also be utilized when a life event pertaining to the individual with the estate (such as the individual's death or disablement) occurs. FIG. 7 is a flowchart illustrating the operation of the system 10 of the present invention during life event activities 53 triggered by the occurrence of a life event at step 54. As shown therein, the individual's loved ones may log into the system at step 301. At step 302, each loved one can use the individual's estate organizer, checklists, and custom reports to help guide actions to organize, manage and/or settle the estate. Appropriate actions are taken at step 303, and the action plan is updated accordingly at step 304.

The system enables loved ones and advisors to work as a team during a life event, giving both access to the same information. The advisor may once again log into the system at step 305 and use the estate organizer to assist the family in managing and/or settling the estate in step 322 and 323. The advisor can update checklist items completed and rate any resources used in step 324. At step 306, the system may provide the advisor with ad statistics and rankings Furthermore, the advisor may make changes to his or her advertising page or to other aspects of the information stored in the system about the advisor.

### Exemplary Graphical User Interface

An exemplary graphical user interface for use in carrying out various methods and aspects of the present invention is next described with respect to FIGS. 8, 9A, 9B, and 11-46. As described previously, FIG. 8 provides primary user control for the graphical user interface and for the system 10 generally. In some embodiments, an unpopulated version of this screen may be presented to a user when first opening the GUI. In other embodiments, this screen is not presented to the user until the user first provides basic information about themselves and possibly about some of the dimensions of their life and estate. Regardless, this screen serves as the main dashboard for the GUI once the user has entered such information. As shown therein, this screen displays notebooks added by the person based on the unique dimensions of their life. In at least some embodiments, every user automatically has a personal notebook, but can add any number (including zero) of dimension-specific notebooks for real estate, dependents, pets and vehicles. Each notebook is preferably formatted the same regardless of the subject; only the items in the notebook are different.

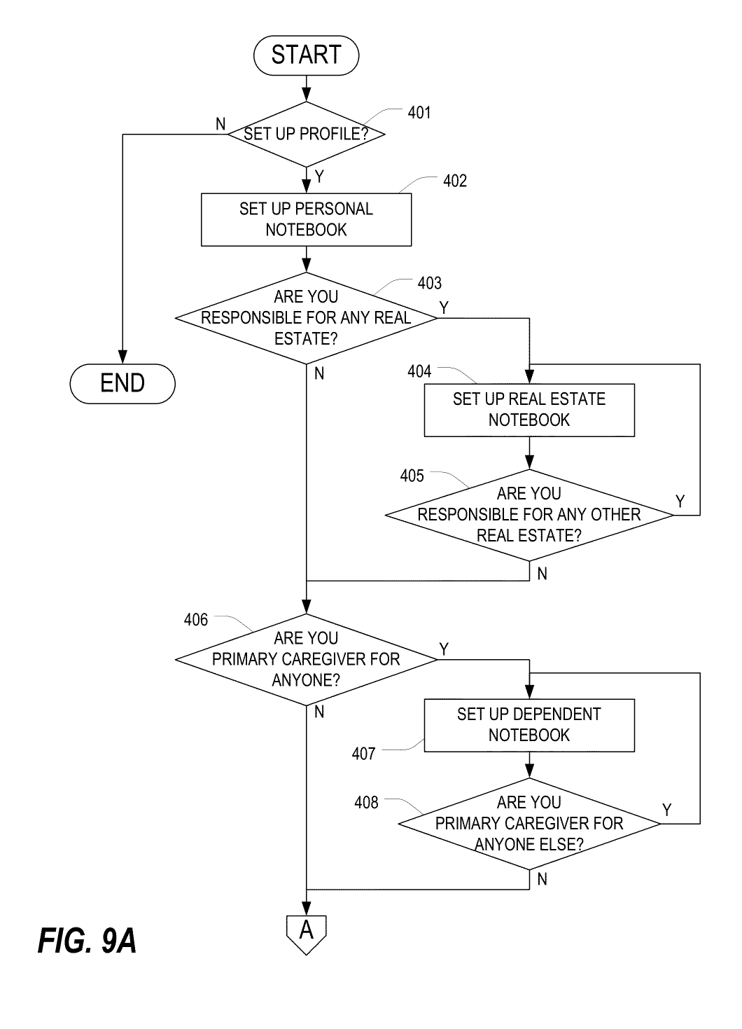

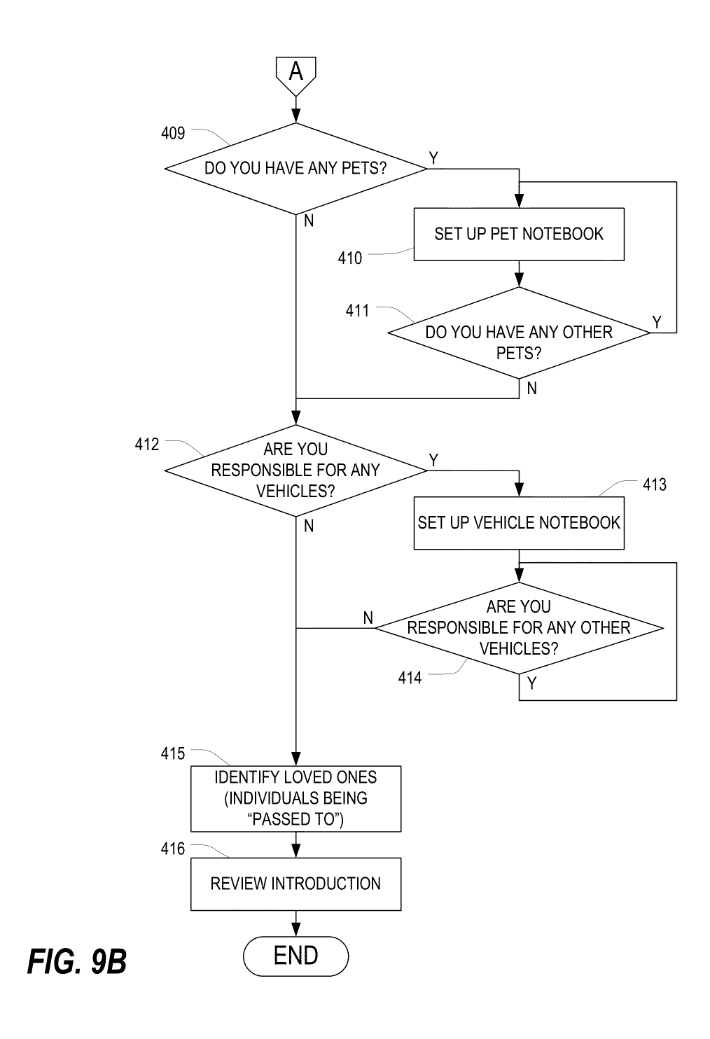

In at least some embodiments, a setup wizard is provided to assist the user with initial information input. FIGS. 9A and 9B collectively depict a flowchart illustrating the operation of a one-time setup wizard for new users. With reference to FIG. 9A, if at step 401 the new user is ready to set up a profile, and he or she is walked through a series of questions to help them determine the notebooks they need to create. At step 402, the new user is first asked a few personal questions, and a personal notebook is set up for the user. The answers to these questions are compared to the contents of his or her notebooks during the scoring process. The user is then asked at step 403 if he or she is responsible for his or her own household or any real estate, and if yes, the user is plied with questions in order to create a notebook at step 404 for the property. This process is repeated at step 405 for any other real estate properties. The user is then asked at step 406 if he or she is the primary caregiver for anyone, and if yes, the user is plied with questions in order to create a notebook at step 407 for the dependent. Dependents could include children, parents in need of care, or the like. This process is repeated at step 408 for any other dependents.

Turning to FIG. 9B, the user is then asked at step 409 if he or she is responsible for any pets, and if yes, the user is plied with questions in order to create a notebook at step 410 for the pet. This process is repeated at step 411 for any other pets. The user is then asked at step 412 if he or she is responsible for any vehicles, and if yes, the user is plied with questions in order to create a notebook at step 413 for the vehicle. This process is repeated at step 414 for any other vehicles. Finally, at step 415, the user is asked to identify two people who the user would want to navigate their life if something happened to them. Once they enter two people, the setup is complete and the user is taken to a virtual bookcase with his or her notebooks and instructions at step 416 for next steps.

The setup wizard preferably uses a user-friendly, conversational approach to prompt the user for information. This can be implemented using a series of notebook conversation screens that simulate a conversation between the estate owner and one or two trusted loved ones. In this regard, FIG. 10 is a graphical depiction of one notebook conversation screen of one exemplary graphical user interface in accordance with one or more preferred embodiments of the present invention. In particular, FIG. 10 is an example of the first page of a personal notebook conversation wizard. In at least some embodiments, every personal, dependent, pet, real estate and vehicle notebook created has a one-time setup wizard that walks the user through a questionnaire formatted to resemble a conversation with loved ones. Answers to this questionnaire are automatically entered into the notebook in the correct sections and also automatically populate the executor checklists. The conversation wizards make filling out the notebook fast, easy and understandable.

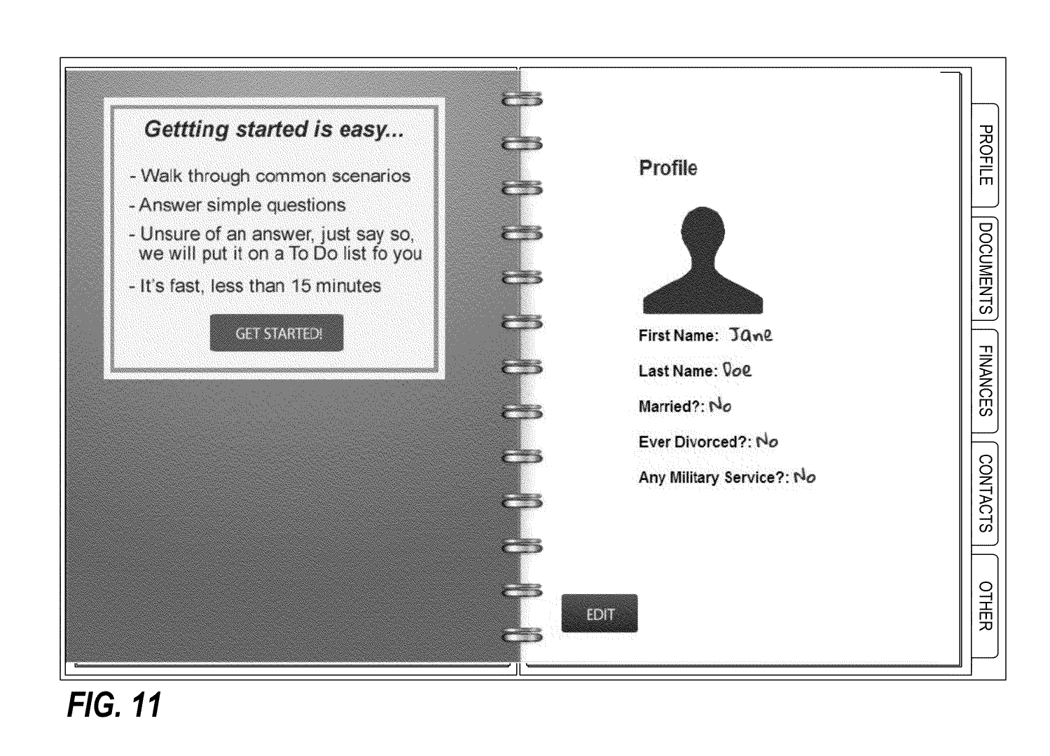

Once the user has provided at least partial information for various notebooks, specific notebooks may be selected for viewing and updating from the dashboard. In this regard, FIG. 11 is a graphical depiction of a personal notebook profile section of one exemplary graphical user interface in accordance with one or more preferred embodiments of the present invention. In particular, FIG. 11 graphically displays a “user profile” page in a graphical depiction of a personal notebook for the estate owner. In at least some embodiments, when the personal notebook is selected, the notebook is graphically “opened” and this screen is displayed. In addition to displaying the profile information itself, tabs are provided (shown along the right edge) to allow the user to move through the different sections of the notebook. The edit button allows the user to change the values on the page.

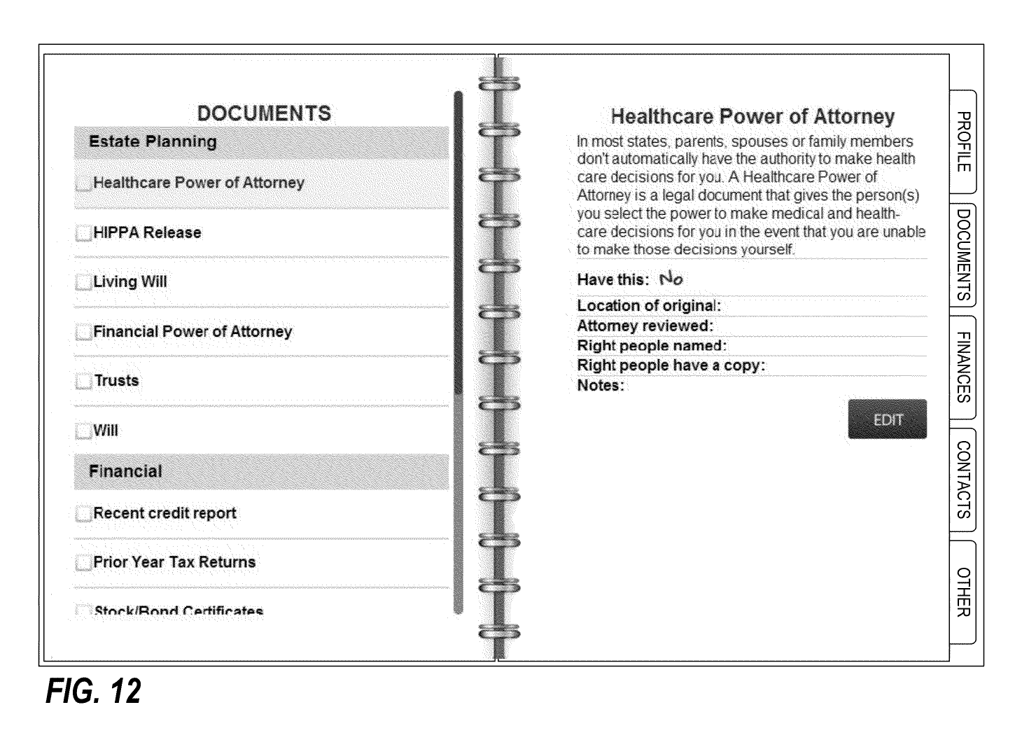

FIG. 12 is a graphical depiction of a personal notebook documents section of one exemplary graphical user interface in accordance with one or more preferred embodiments of the present invention. In particular, FIG. 12 graphically displays a “documents” page in a graphical depiction of a personal notebook for the estate owner. When the Documents tab is selected the page will display the document items. The page is pre-populated with expert recommended items to reduce the amount of data entry. The main items are on the left panel and the detailed information associated with those items is on the right panel. The detailed information includes, but is not limited to, specifics about where documents can be found, if it they are up to date and if an attorney reviewed them.

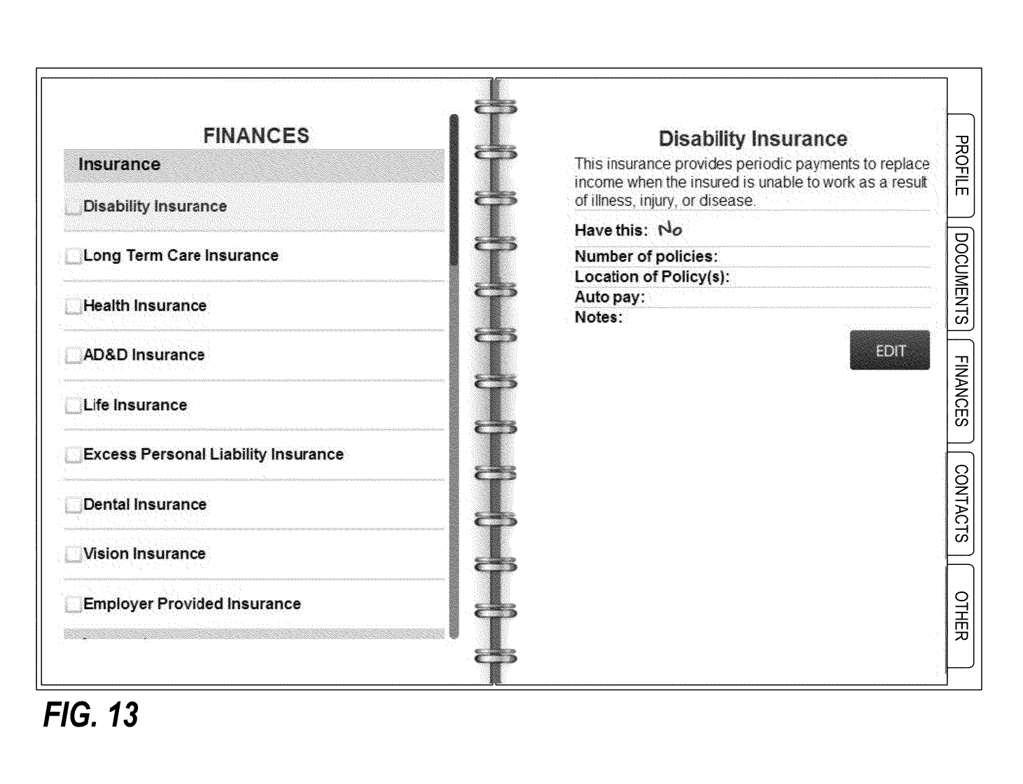

FIG. 13 is a graphical depiction of a personal notebook finances section of one exemplary graphical user interface in accordance with one or more preferred embodiments of the present invention. In particular, FIG. 13 graphically displays a “finances” page in a graphical depiction of a personal notebook for the estate owner. When the Finances tab is selected the page will display the finance items. The page is pre-populated with expert recommended items to reduce the amount of data entry. The main items are on the left panel and the detailed information associated with those items is on the right panel. The detailed information includes, but is not limited to, specifics about how many accounts, where to look for statements, if accounts are joint, if beneficiaries are correct and if automatic deposits or payments are established.

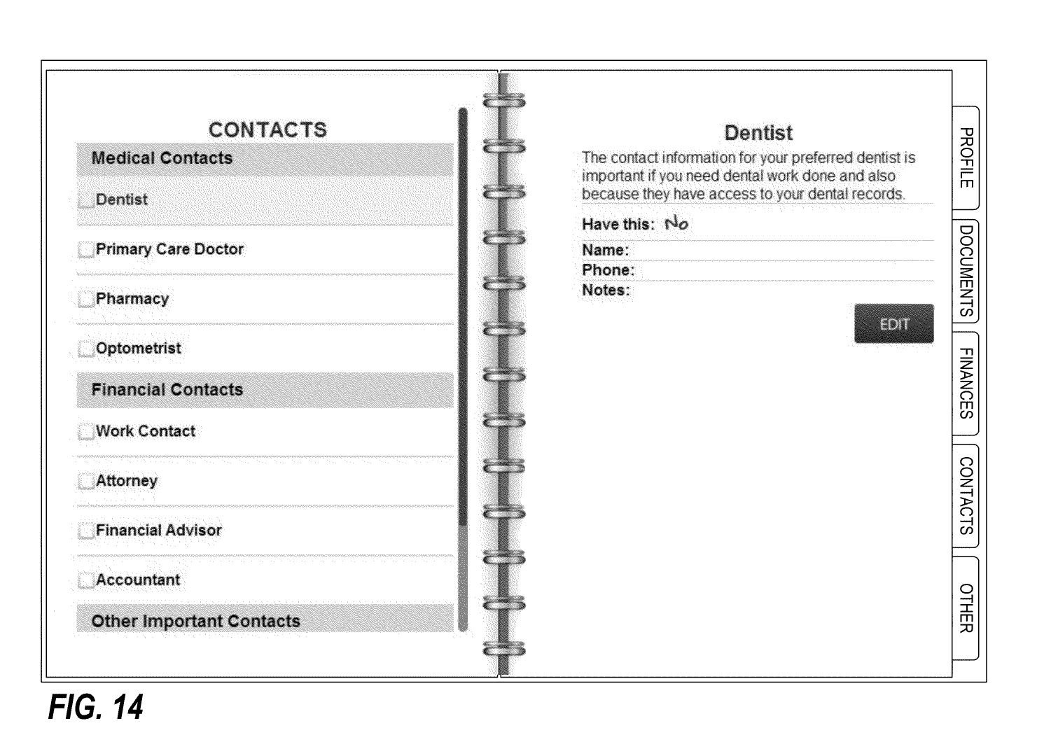

FIG. 14 is a graphical depiction of a personal notebook contacts section of one exemplary graphical user interface in accordance with one or more preferred embodiments of the present invention. In particular, FIG. 14 graphically displays a “contacts” page in a graphical depiction of a personal notebook for the estate owner. When the Contacts tab is selected the page will display the Contact items. The page is pre-populated with expert recommended items to reduce the amount of data entry. The main items are on the left panel and the detailed information associated with those items is on the right panel. The detailed information includes, but is not limited to, specifics about name, phone number and notes about a contact.

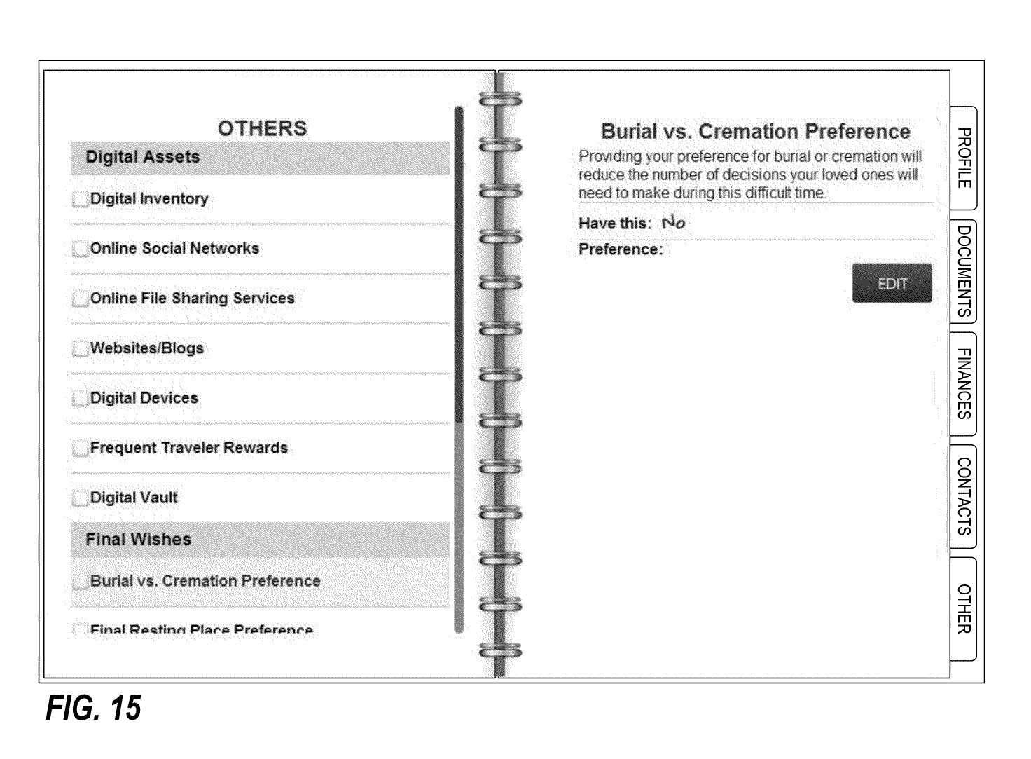

FIG. 15 is a graphical depiction of an additional personal notebook section of one exemplary graphical user interface in accordance with one or more preferred embodiments of the present invention. In particular, FIG. 15 graphically displays an “other information” page in a graphical depiction of a personal notebook for the estate owner. When the Other tab is selected, the page will display the other items. The page is pre-populated with expert recommended items to reduce the amount of data entry. The main items are on the left panel and the detailed information associated with those items is on the right panel. The detailed information includes, but not limited to, specifics about personal preferences and instructions.

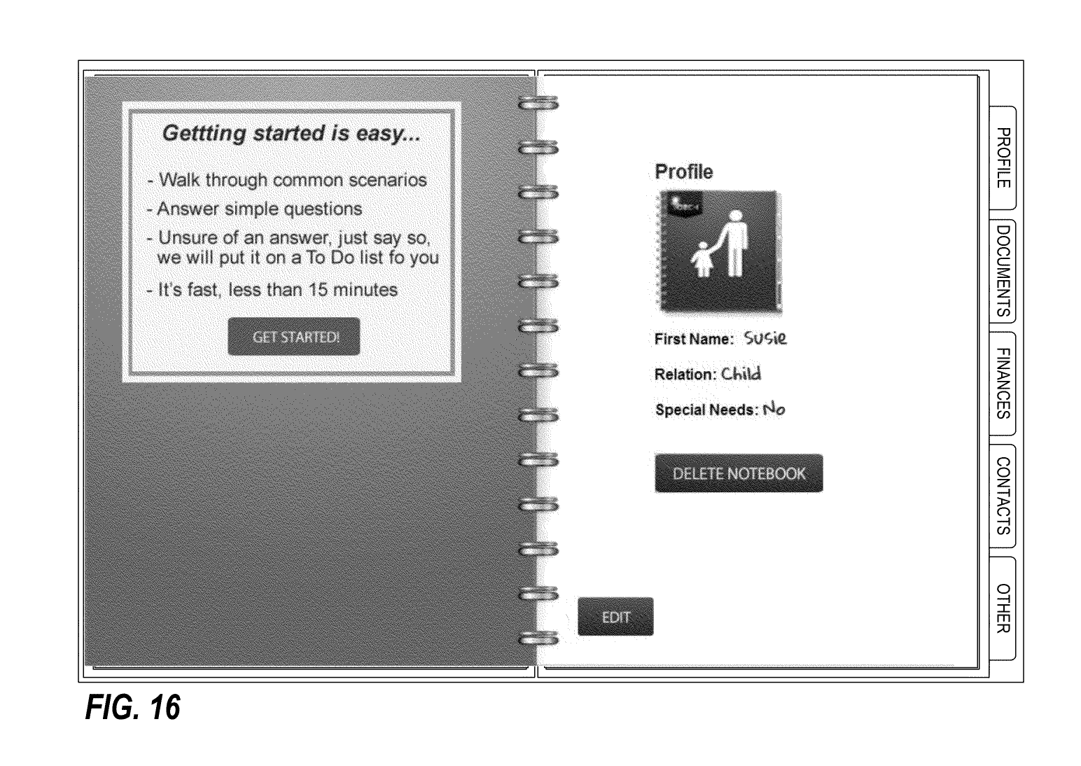

FIG. 16 is a graphical depiction of a dependent notebook profile section of one exemplary graphical user interface in accordance with one or more preferred embodiments of the present invention. In particular, FIG. 16 graphically displays a “dependent profile” page in a graphical depiction of a dependent notebook for the estate owner. In at least some embodiments, when a dependent notebook is selected, the notebook is graphically “opened” and this screen is displayed. In addition to displaying the profile information itself, tabs are provided (shown along the right edge) to allow the user to move through the different sections of the notebook. The edit button allows the user to change the values on the page.

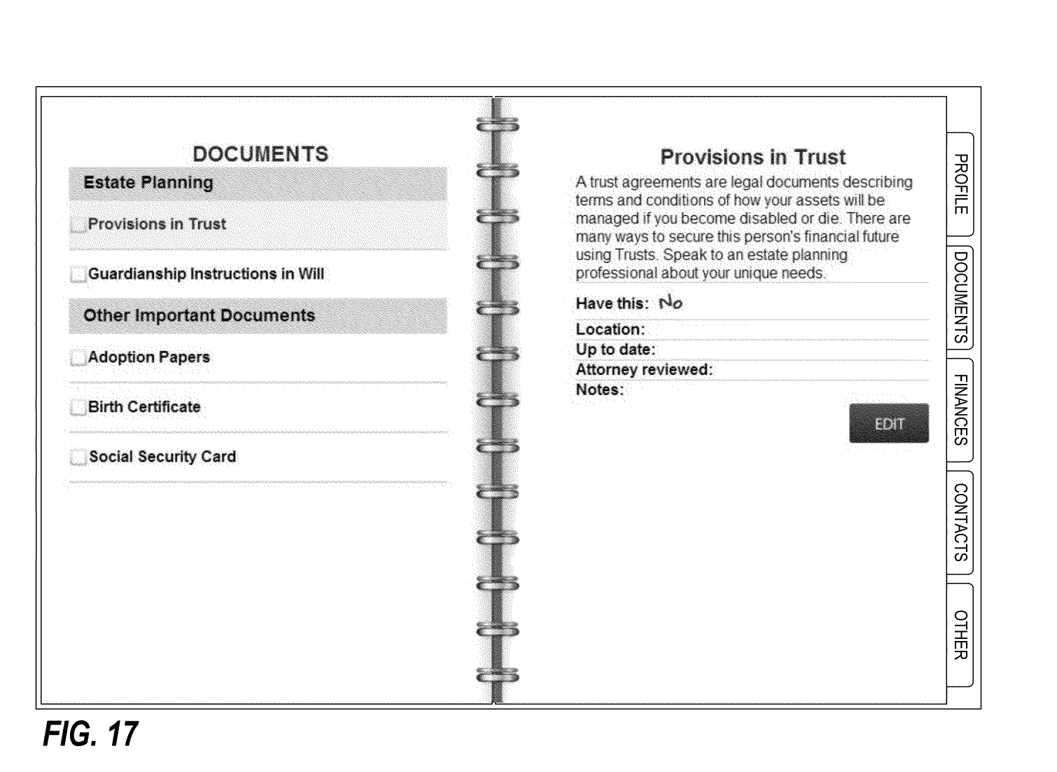

FIG. 17 is a graphical depiction of a dependent notebook documents section of one exemplary graphical user interface in accordance with one or more preferred embodiments of the present invention. In particular, FIG. 17 graphically displays a “documents” page in a graphical depiction of a dependent notebook for the estate owner. When the Documents tab on a dependent notebook is selected the page displays the document items. The page is pre-populated with expert recommended items to reduce the amount of data entry. The main items are on the left panel and the detailed information associated with those items is on the right panel. The detailed information includes, but is not limited to, specifics about where the document can be found, if it is up to date and if an attorney reviewed it.

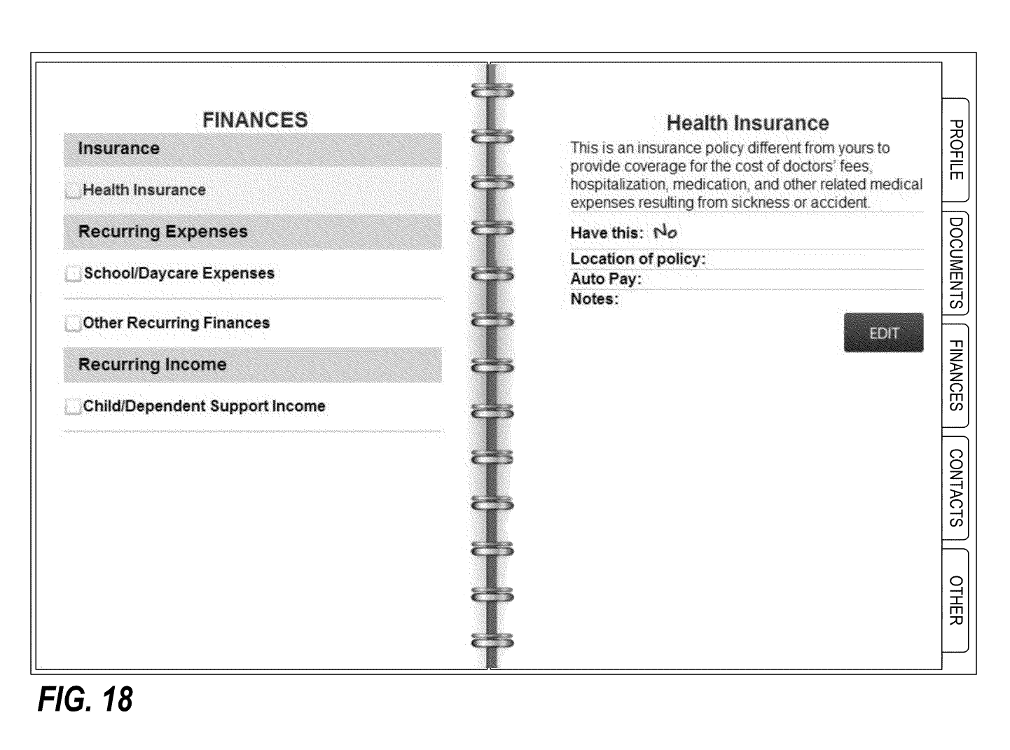

FIG. 18 is a graphical depiction of a dependent notebook finances section of one exemplary graphical user interface in accordance with one or more preferred embodiments of the present invention. In particular, FIG. 18 graphically displays a “finances” page in a graphical depiction of a dependent notebook for the estate owner. When the Finances tab on a dependent notebook is selected the page displays the finance items. The page is prepopulated with expert recommended items to reduce the amount of data entry. The detailed information includes, but is not limited to, specifics about how many accounts, where to look for statements, if accounts are jointly owned, if beneficiaries are correct and if automatic deposits or payments are established.

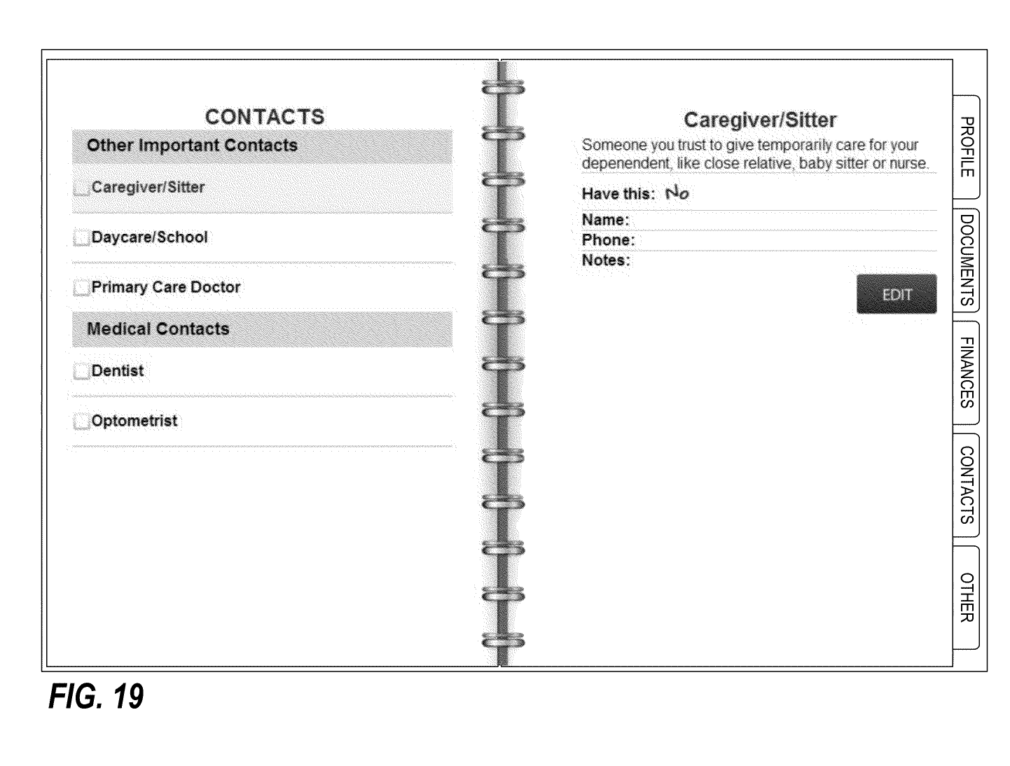

FIG. 19 is a graphical depiction of a dependent notebook contacts section of one exemplary graphical user interface in accordance with one or more preferred embodiments of the present invention. In particular, FIG. 19 graphically displays a “contacts” page in a graphical depiction of a dependent notebook for the estate owner. When the Contacts tab on a dependent notebook is selected the page displays the Contact items. The page is pre-populated with expert recommended items. The main items are on the left panel and the detailed information associated with those items is on the right panel. Detailed information includes, but is not limited to, specifics about name, phone number and notes about a contact.

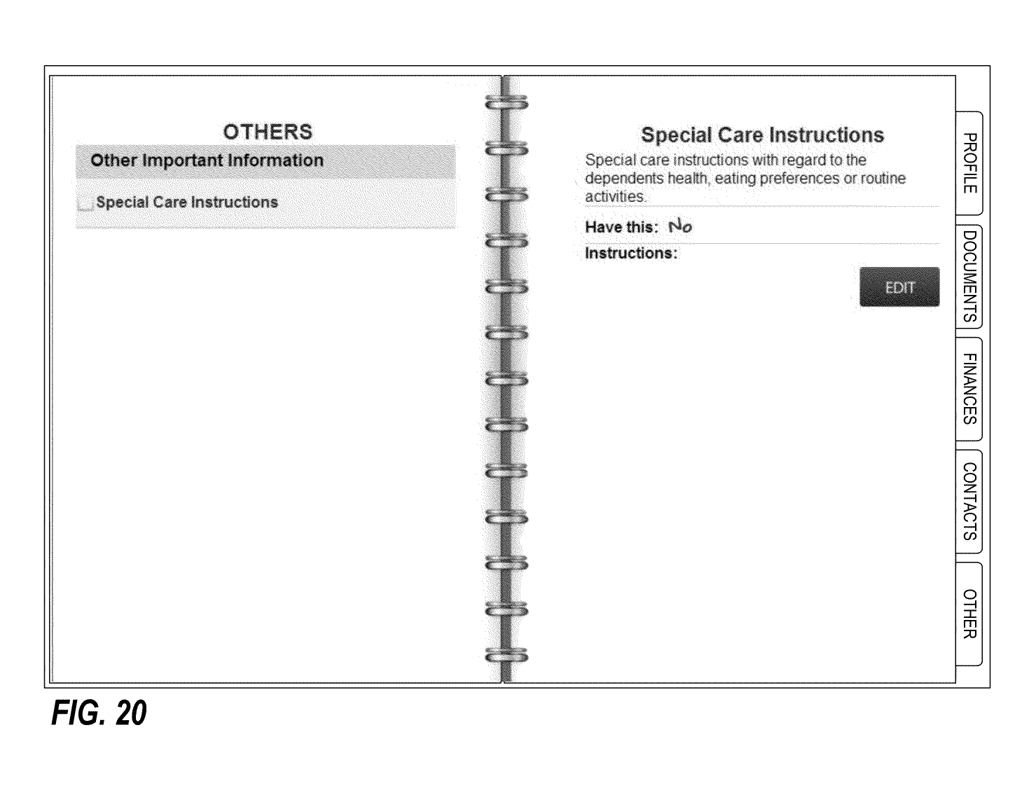

FIG. 20 is a graphical depiction of an additional dependent notebook section of one exemplary graphical user interface in accordance with one or more preferred embodiments of the present invention. In particular, FIG. 20 graphically displays an “other information” page in a graphical depiction of a dependent notebook for the estate owner. When the Other tab on a dependent notebook is selected the page displays the Other items. The page is pre-populated with expert recommended items. The main items are on the left panel and the detailed information associated with those items is on the right panel. Detailed information includes, but is not limited to, specifics about preferences and instructions.

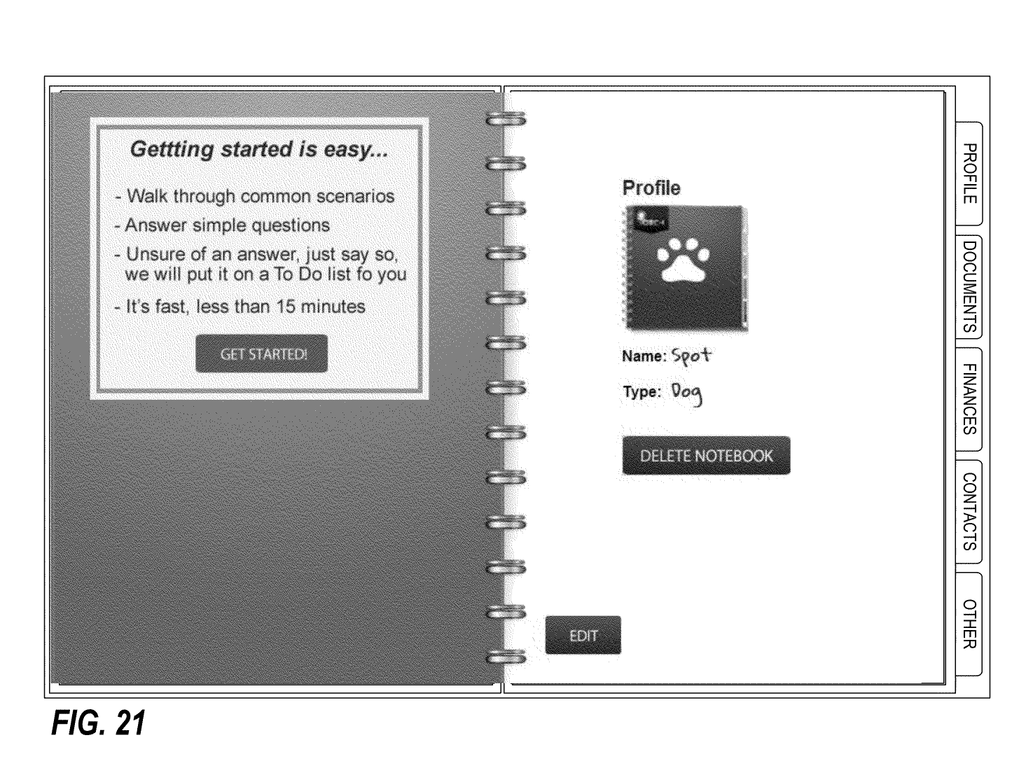

FIG. 21 is a graphical depiction of a pet notebook profile section of one exemplary graphical user interface in accordance with one or more preferred embodiments of the present invention. In particular, FIG. 21 graphically displays a “pet profile” page in a graphical depiction of a dependent notebook for the estate owner. In at least some embodiments, when a pet notebook is selected, the notebook is graphically “opened” and this screen is displayed. In addition to displaying the profile information itself, tabs are provided (shown along the right edge) to allow the user to move through the different sections of the notebook. The edit button allows the user to change the values on the page.

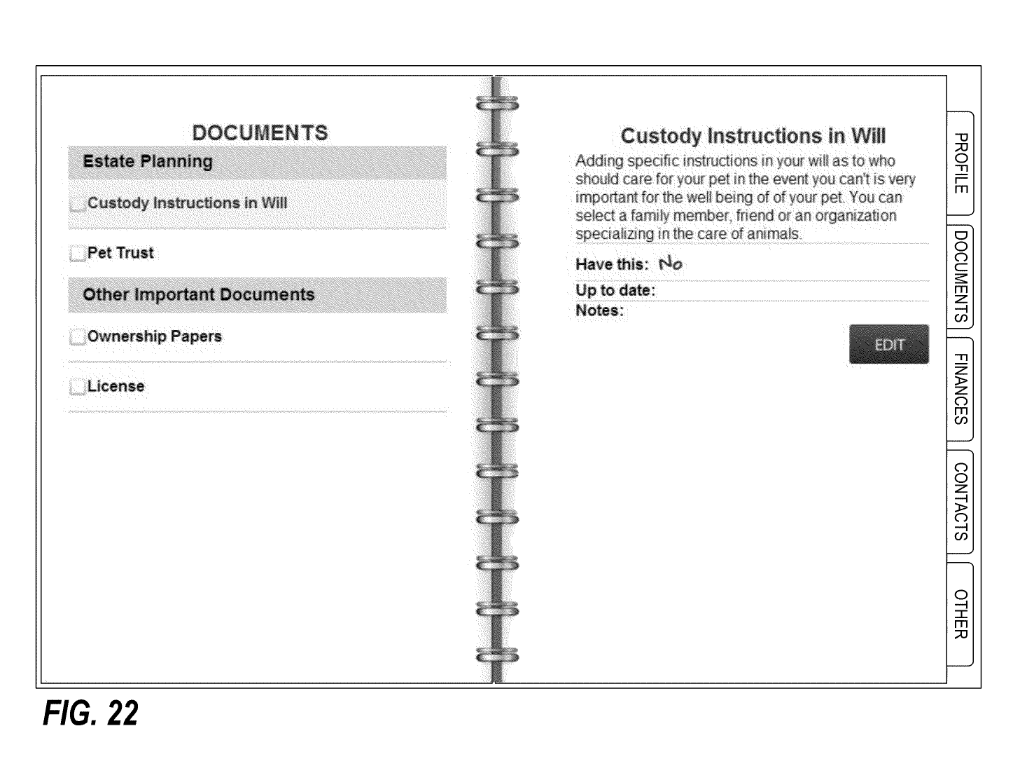

FIG. 22 is a graphical depiction of a pet notebook documents section of one exemplary graphical user interface in accordance with one or more preferred embodiments of the present invention. In particular, FIG. 22 graphically displays a “documents” page in a graphical depiction of a pet notebook for the estate owner. When the Documents tab on a Pets notebook is selected the page displays the Document items. The page is pre-populated with expert recommended items. The main items are on the left panel and the detailed information associated with those items is on the right panel. The detailed information includes, but is not limited to, specifics about where the document can be found, if it is up to date and if an attorney reviewed it.

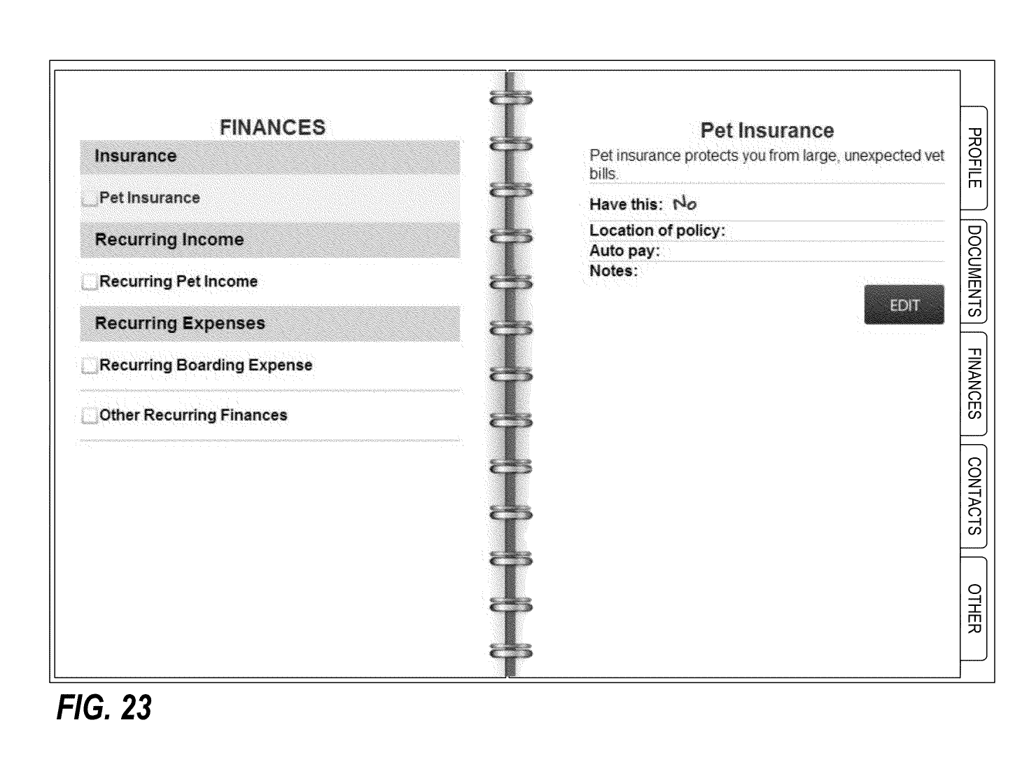

FIG. 23 is a graphical depiction of a pet notebook finances section of one exemplary graphical user interface in accordance with one or more preferred embodiments of the present invention. In particular, FIG. 23 graphically displays a “finances” page in a graphical depiction of a pet notebook for the estate owner. When the Finances button on a Pets dimension is selected page displays the Finances items. The page is pre-populated with expert recommended items. The detailed information includes, but is not limited to, specifics about how many accounts, where to look for statements, if accounts are jointly owned, if beneficiaries are correct and if automatic deposits or payments are established.

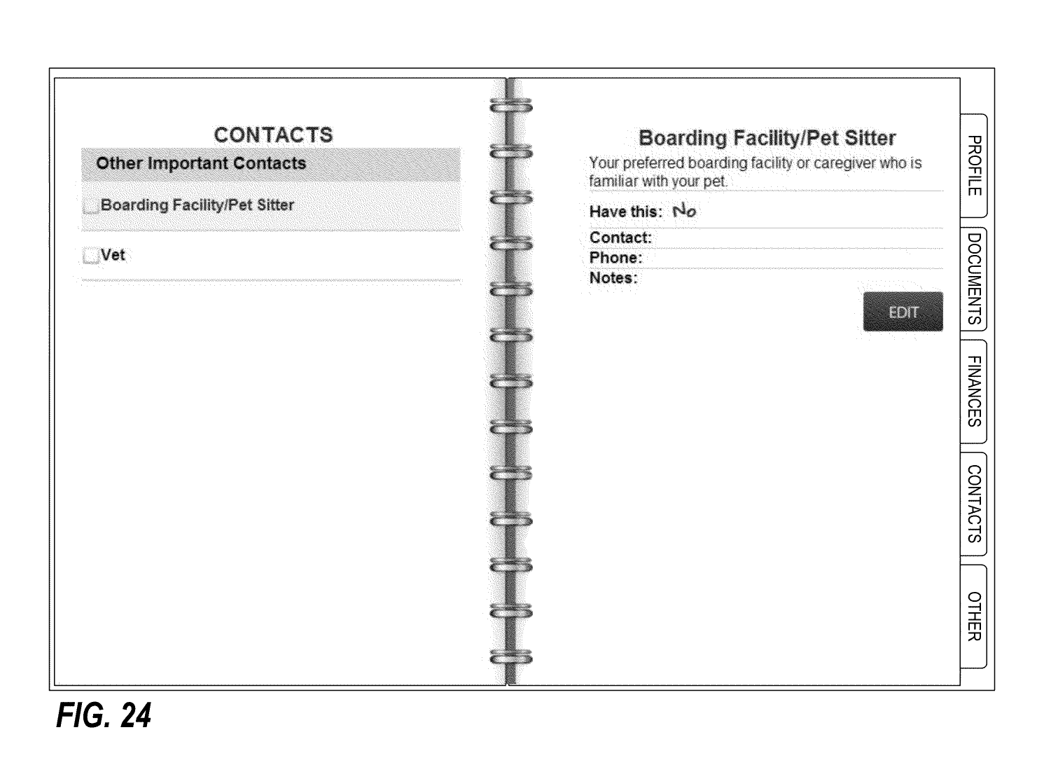

FIG. 24 is a graphical depiction of a pet notebook contacts section of one exemplary graphical user interface in accordance with one or more preferred embodiments of the present invention. In particular, FIG. 24 graphically displays a “contacts” page in a graphical depiction of a pet notebook for the estate owner. When the Contacts tab on a Pet notebook is selected the page displays the Contact items for the pet. The page is pre-populated with expert recommended items. The detailed information includes, but is not limited to, specifics name, phone number and notes.

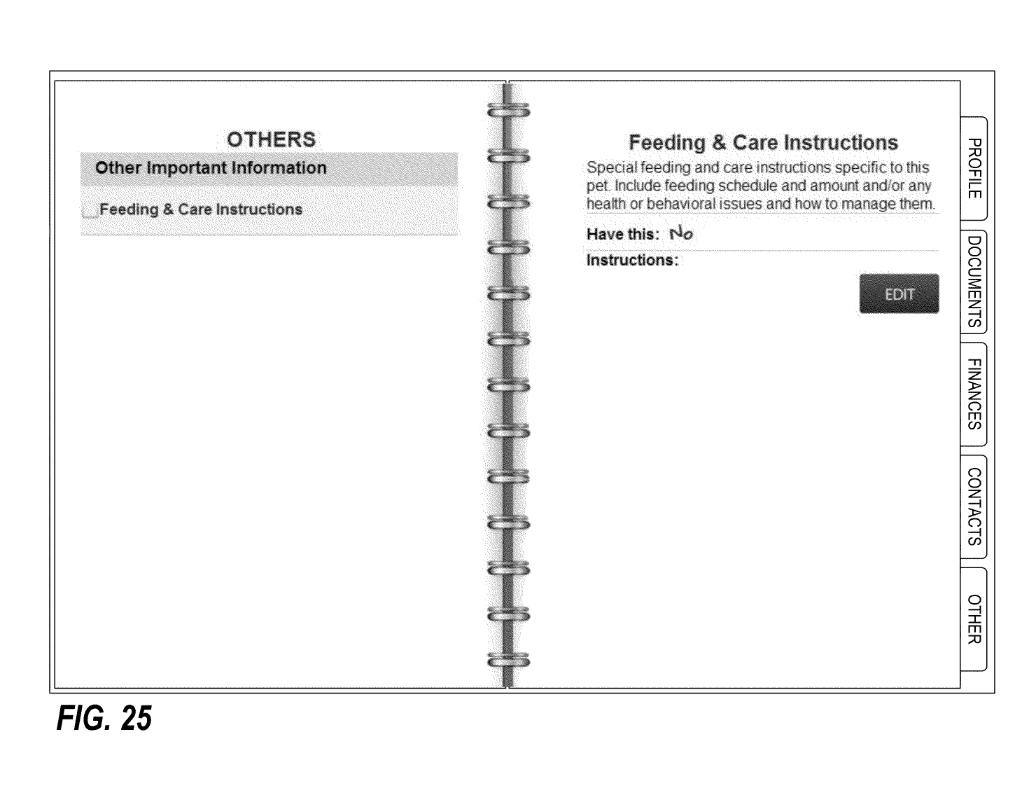

FIG. 25 is a graphical depiction of an additional pet notebook documents section of one exemplary graphical user interface in accordance with one or more preferred embodiments of the present invention. In particular, FIG. 25 graphically displays an “other information” page in a graphical depiction of a pet notebook for the estate owner. When the Other tab on a Pet notebook is selected the page displays the Other items for the pet. The page is pre-populated with expert recommended items. The detailed information includes, but is not limited to, instructions and preferences.

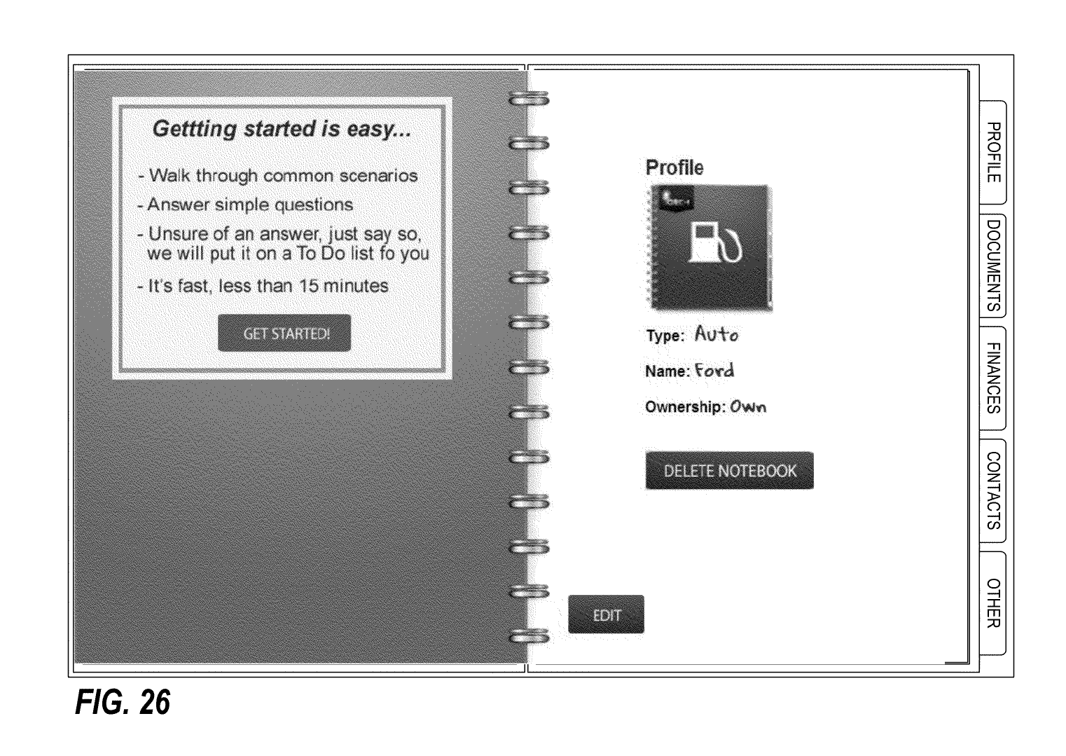

FIG. 26 is a graphical depiction of a vehicle notebook profile section of one exemplary graphical user interface in accordance with one or more preferred embodiments of the present invention. In particular, FIG. 26 graphically displays a “vehicle profile” page in a graphical depiction of a vehicle notebook for the estate owner. In at least some embodiments, when a vehicle notebook is selected, the notebook is graphically “opened” and this screen is displayed. In addition to displaying the profile information itself, tabs are provided (shown along the right edge) to allow the user to move through the different sections of the notebook. The edit button allows the user to change the values on the page.

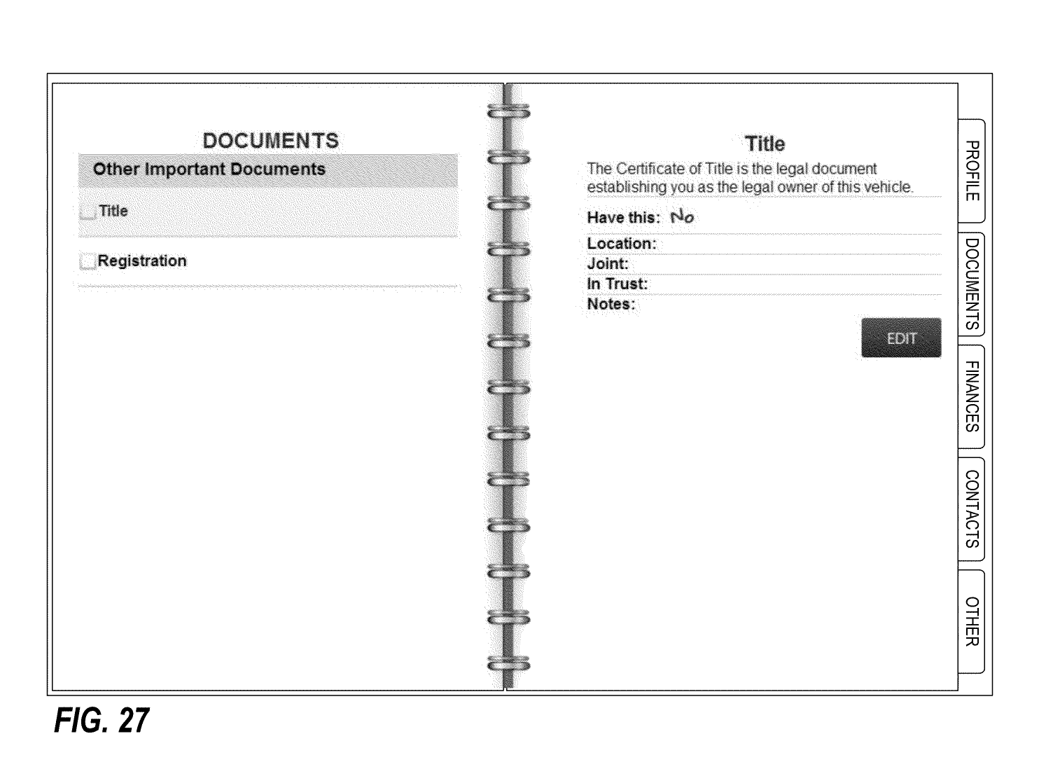

FIG. 27 is a graphical depiction of a vehicle notebook documents section of one exemplary graphical user interface in accordance with one or more preferred embodiments of the present invention. In particular, FIG. 27 graphically displays a “documents” page in a graphical depiction of a vehicle notebook for the estate owner. When the Documents tab on a Vehicle notebook is selected the page displays the Document items. The page is pre-populated with expert recommended items. The main items are on the left panel and the detailed information associated with those items is on the right panel. The detailed information includes, but is not limited to, specifics about where the document can be found.

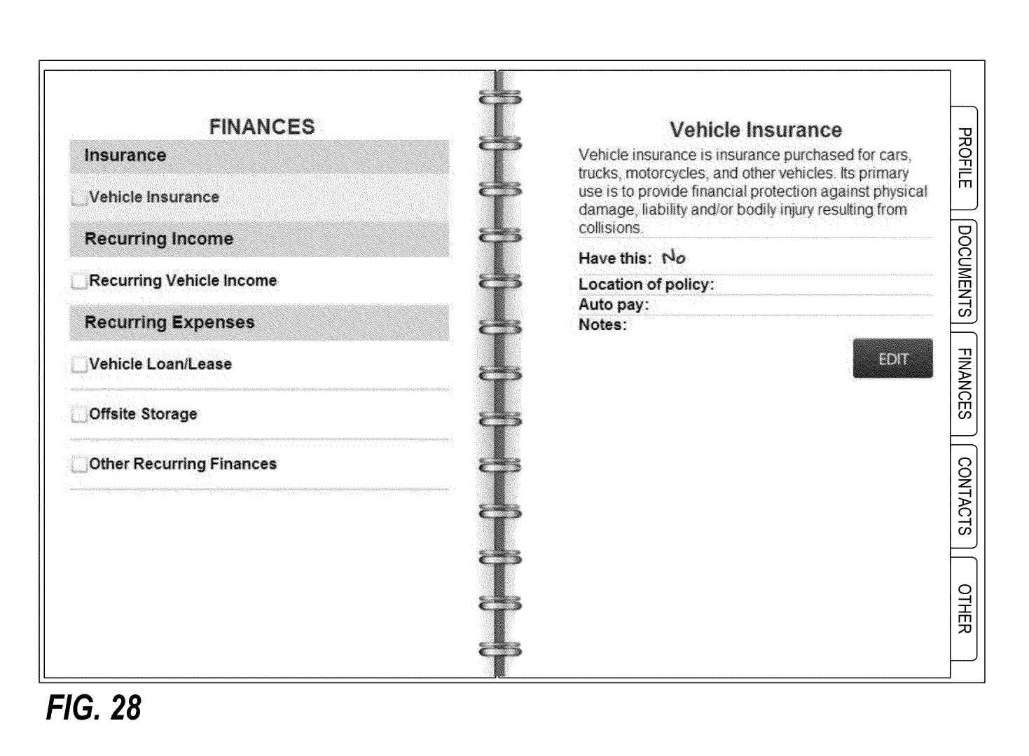

FIG. 28 is a graphical depiction of a vehicle notebook finances section of one exemplary graphical user interface in accordance with one or more preferred embodiments of the present invention. In particular, FIG. 28 graphically displays a “finances” page in a graphical depiction of a vehicle notebook for the estate owner. When the Finances tab on a Vehicles notebook is selected the page displays the Finances items. The page is pre-populated with expert recommended items. The detailed information includes, but is not limited to, specifics about how where to look for statements and if automatic deposits or payments are established.

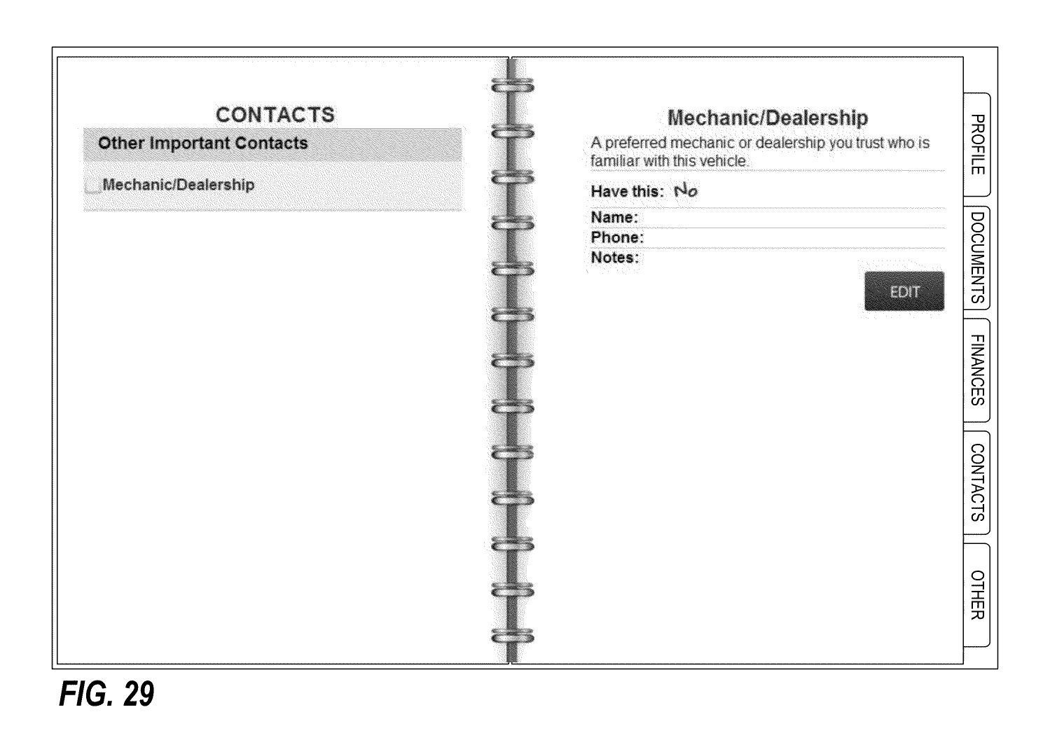

FIG. 29 is a graphical depiction of a vehicle notebook contacts section of one exemplary graphical user interface in accordance with one or more preferred embodiments of the present invention. In particular, FIG. 29 graphically displays a “contacts” page in a graphical depiction of a vehicle notebook for the estate owner. When the Contacts button on a Vehicles notebook is selected the page will display the Contacts item. The page is pre-populated with expert recommended items. The main items are on the left panel and the detailed information associated with those items is on the right panel. The detailed information includes, but is not limited to, specifics about names, phone numbers and notes.

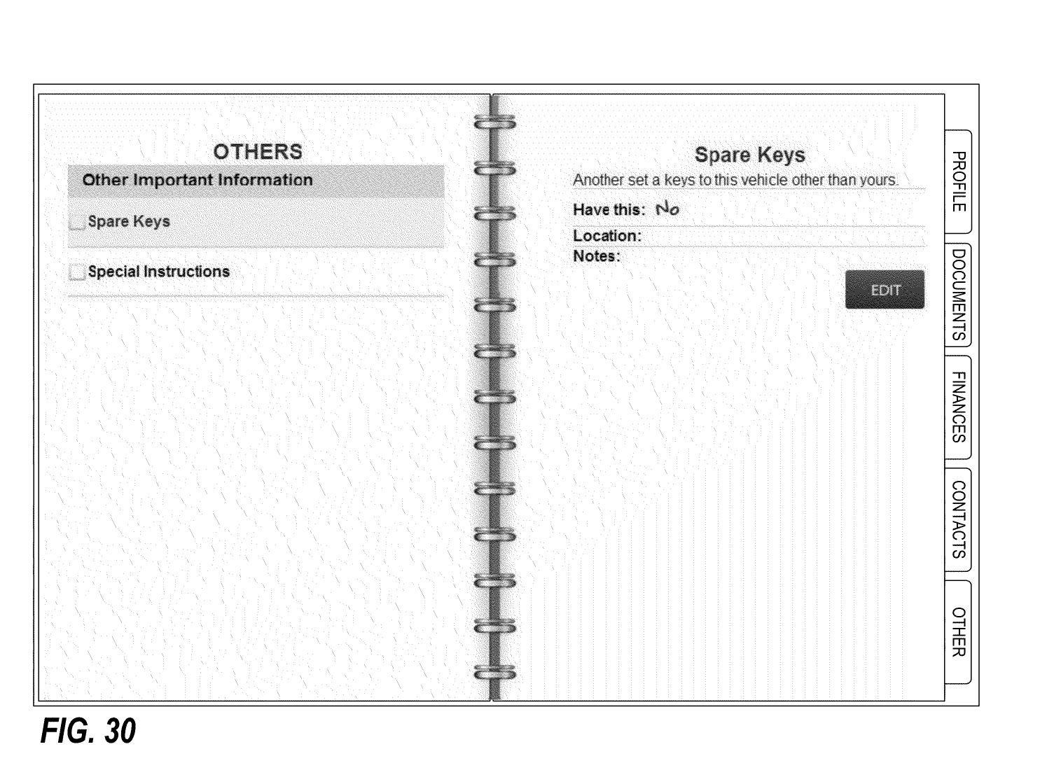

FIG. 30 is a graphical depiction of an additional vehicle notebook section of one exemplary graphical user interface in accordance with one or more preferred embodiments of the present invention. In particular, FIG. 30 graphically displays an “other information” page in a graphical depiction of a vehicle notebook for the estate owner. When the Other button on a Vehicles notebook is selected the page will display the Other items. The page is pre-populated with expert recommended items. The main items are on the left panel and the detailed information associated with those items is on the right panel. The detailed information includes, but is not limited to, notes and instructions.

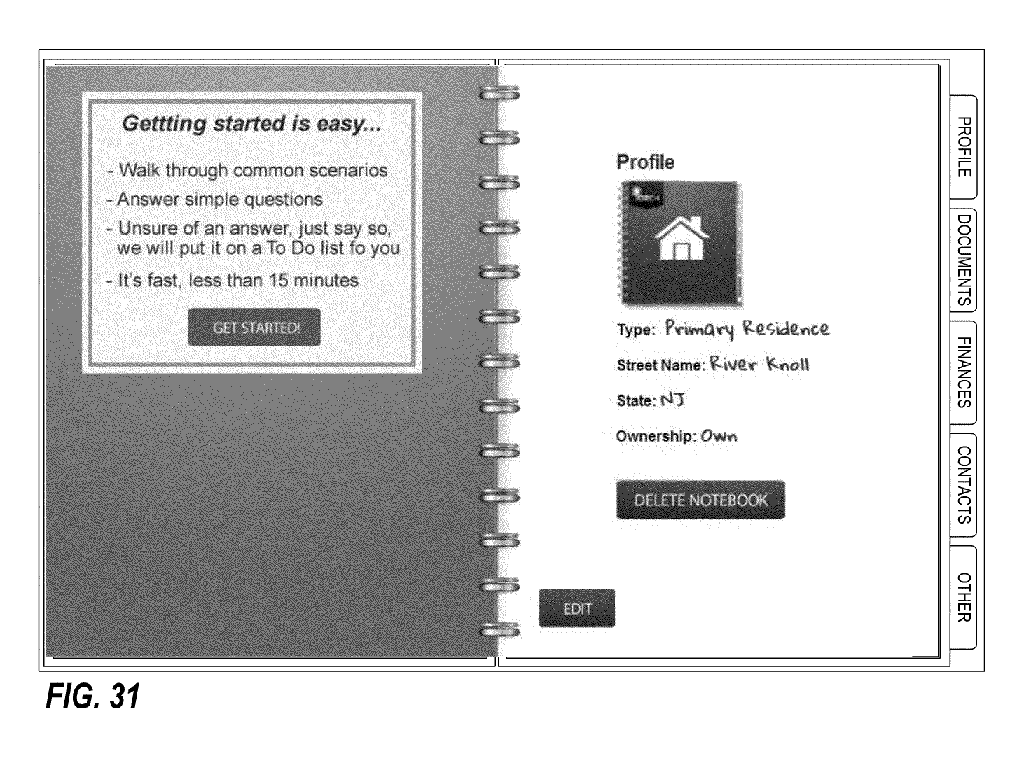

FIG. 31 is a graphical depiction of a real estate notebook profile section of one exemplary graphical user interface in accordance with one or more preferred embodiments of the present invention. In particular, FIG. 31 graphically displays a “real estate profile” page in a graphical depiction of a real estate notebook for the estate owner. In at least some embodiments, when a real estate notebook is selected, the notebook is graphically “opened” and this screen is displayed. In addition to displaying the profile information itself, tabs are provided (shown along the right edge) to allow the user to move through the different sections of the notebook. The edit button allows the user to change the values on the page.

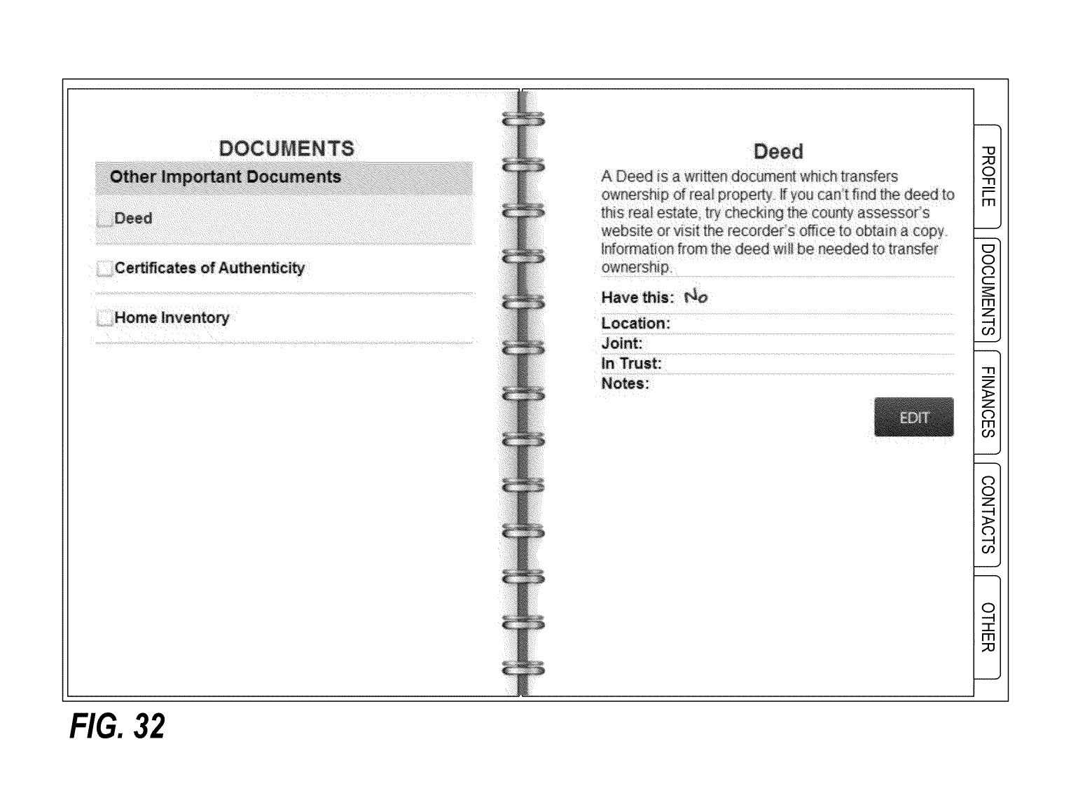

FIG. 32 is a graphical depiction of a real estate notebook documents section of one exemplary graphical user interface in accordance with one or more preferred embodiments of the present invention. In particular, FIG. 32 graphically displays a “documents” page in a graphical depiction of a real estate notebook for the estate owner. When the Documents tab on a Real Estate notebook is selected the page displays the Document items. The page is pre-populated with expert recommended items. The main items are on the left panel and the detailed information associated with those items is on the right panel. The detailed information includes, but is not limited to, specifics about where the document can be found.

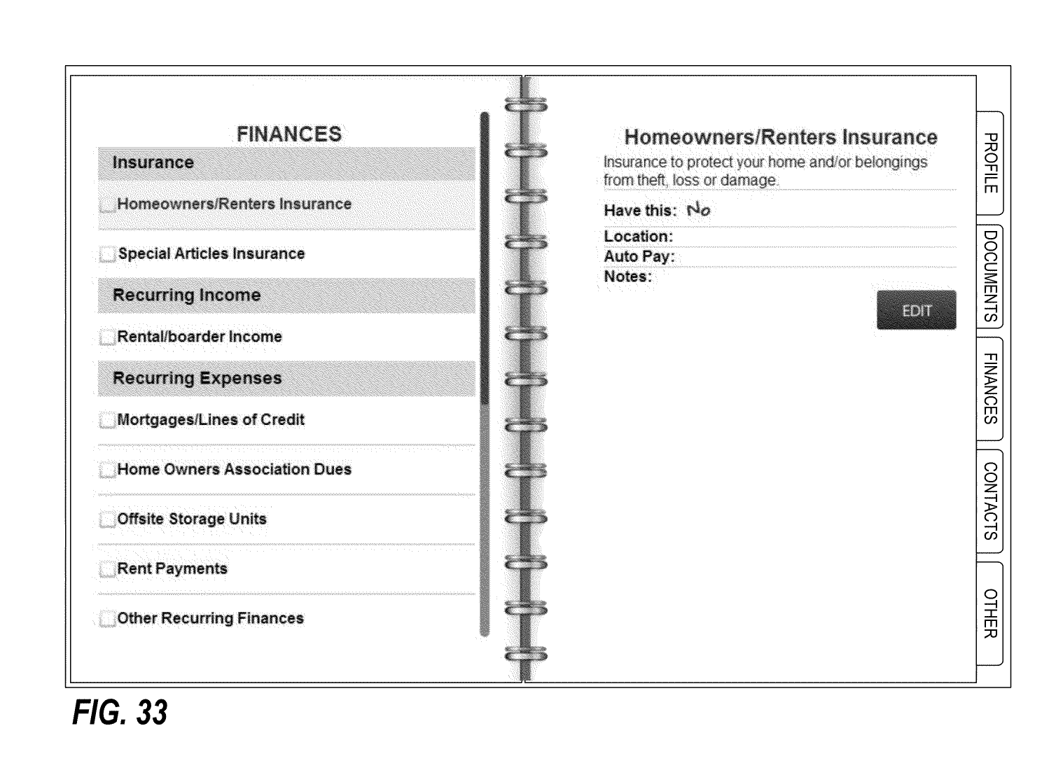

FIG. 33 is a graphical depiction of a real estate notebook finances section of one exemplary graphical user interface in accordance with one or more preferred embodiments of the present invention. In particular, FIG. 33 graphically displays a “finances” page in a graphical depiction of a real estate notebook for the estate owner. When the Finances tab on a Real Estate notebook is selected the page displays the Finances items. The page is pre-populated with expert recommended items. The detailed information includes, but is not limited to, specifics about how where to look for statements and if automatic deposits or payments are established.

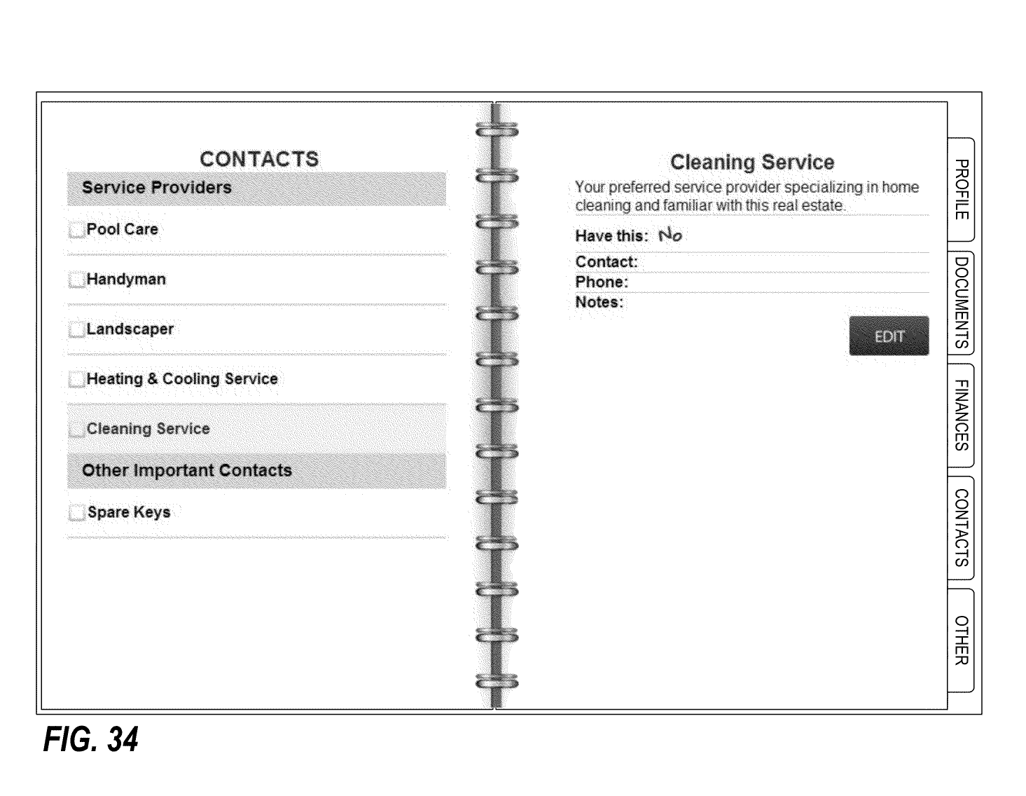

FIG. 34 is a graphical depiction of a real estate notebook contacts section of one exemplary graphical user interface in accordance with one or more preferred embodiments of the present invention. In particular, FIG. 34 graphically displays a “contacts” page in a graphical depiction of a real estate notebook for the estate owner. When the Contacts button on a Real Estate notebook is selected the page will display the Contacts item. The page is pre-populated with expert recommended items. The main items are on the left panel and the detailed information associated with those items is on the right panel. The detailed information includes, but is not limited to, specifics about names, phone numbers and notes.

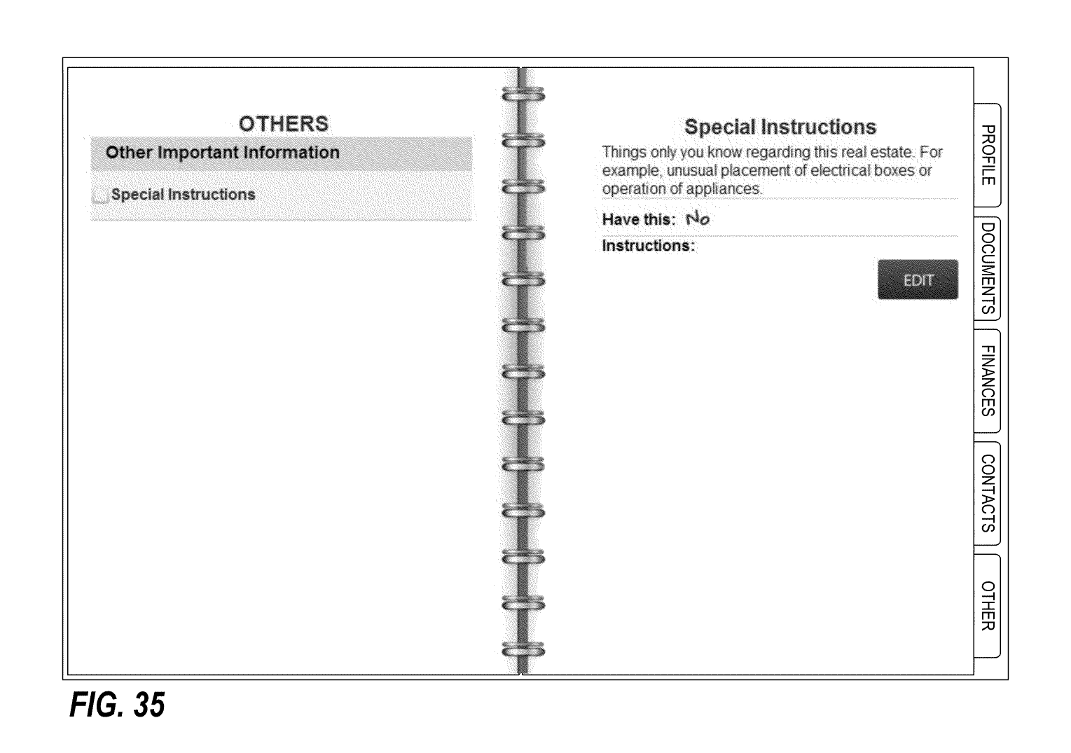

FIG. 35 is a graphical depiction of an additional real estate notebook documents section of one exemplary graphical user interface in accordance with one or more preferred embodiments of the present invention. In particular, FIG. 35 graphically displays an “other information” page in a graphical depiction of a real estate notebook for the estate owner. When the Other button on a Real Estate notebook is selected the page will display the Contacts item. The page is pre-populated with expert recommended items. The main items are on the left panel and the detailed information associated with those items is on the right panel. The detailed information includes, but is not limited to, specifics about instructions and notes.

Based on information entered into various notebooks by the estate owner, one or more checklists may be produced for use by the estate owner's loved ones in particular situations. Checklists are automatically generated based on predefined criteria. For example, the automatic generation of an executor checklist may be based on generally accepted estate planning guidelines stored in the system. A general purpose of a checklist is to provide such a loved one with a specific list or description of the role and responsibilities expected of them and/or actions to be taken, with regard to the estate owner's affairs, in a particular situation, such as upon the estate owner's death. In fact, in at least some embodiments, one specific checklist type pertains to that particular situation (death of the estate owner), but checklist types for other situations, such as a medical emergency for the estate owner, or paying the estate owner's monthly bills, may likewise be provided.

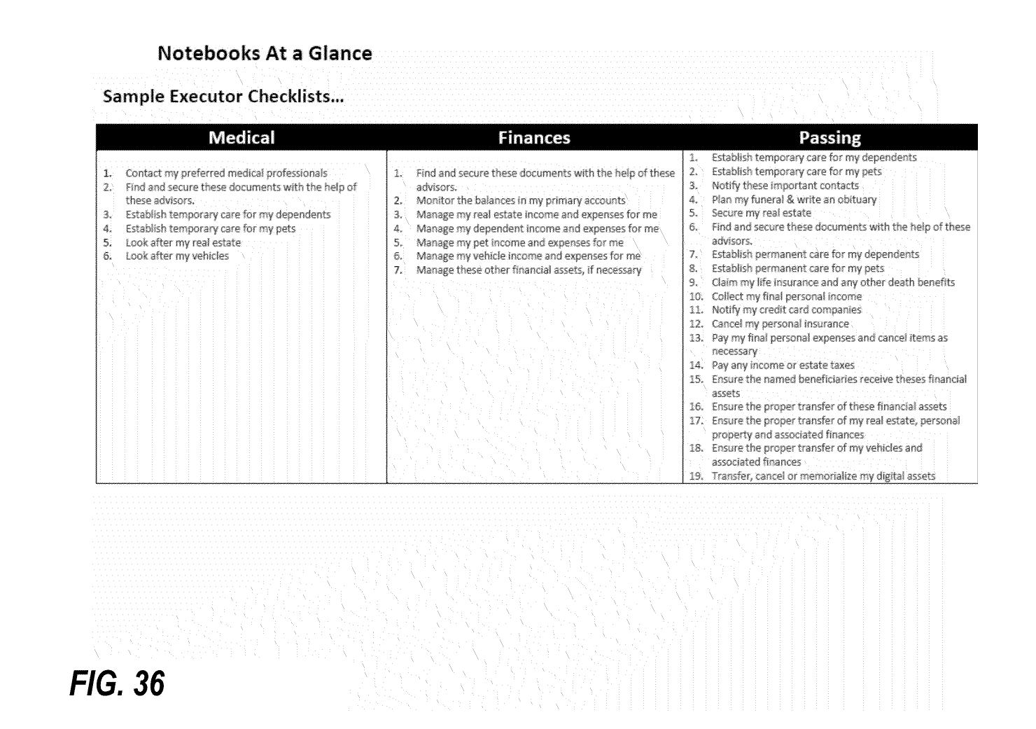

FIG. 36 is a tabular illustration of the executor checklist concept. In order to facilitate ease of use, each checklist may be generated automatically by the system 10 based on the information entered into and stored in the notebooks. More particularly, the notebook items necessary to complete the executor checklist will be automatically associated with the checklist item to ease the job of the loved one (or executor). For example, if the estate owner has a pet, then a checklist action item that might be generated is “Establish temporary care for my pet.” Notably, such an approach avoids the necessity for an estate owner to manually create such a checklist; instead, the system 10 recognizes the need for certain actions, and includes them in an appropriate checklist automatically. In at least some embodiments. checklist items may also be associated with local professionals, national professionals, online resources, and the like, to ease the burden of the person responsible for executing the items on the checklist.

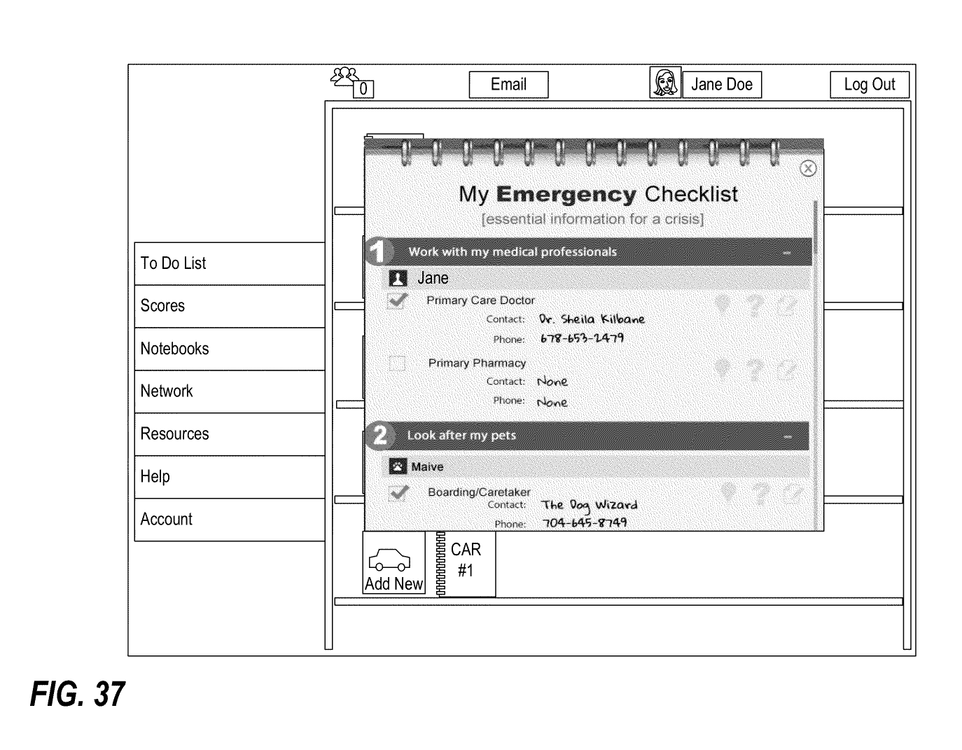

Specific checklists may be selected for viewing and updating from the dashboard. An estate owner may wish to review them in order to gain an understanding of what a loved one might later encounter when following through on the owner's estate in a particular situation. A purpose of each checklist type is to educate users as to the impact that the current state of their affairs may have on their loved ones in the event of their disablement or death. For example, users will be able to see which assets will go through probate and which ones will not. Based on reviewing “mock death” and “mock disablement” scenarios, users may elect to change how some assets are titled, may choose to organize their paperwork differently or add new estate planning documents. In addition, loved ones may actually review and use the appropriate checklist upon the occurrence of the corresponding situation. FIG. 37 is a graphical depiction of a sample emergency checklist screen of one exemplary graphical user interface in accordance with one or more preferred embodiments of the present invention. More particularly, FIG. 37 illustrates a summary checklist of all the responsibilities of a loved one (or executor) in a medical emergency and the notebook items associated with those responsibilities. The other checklists preferably have a similar format.

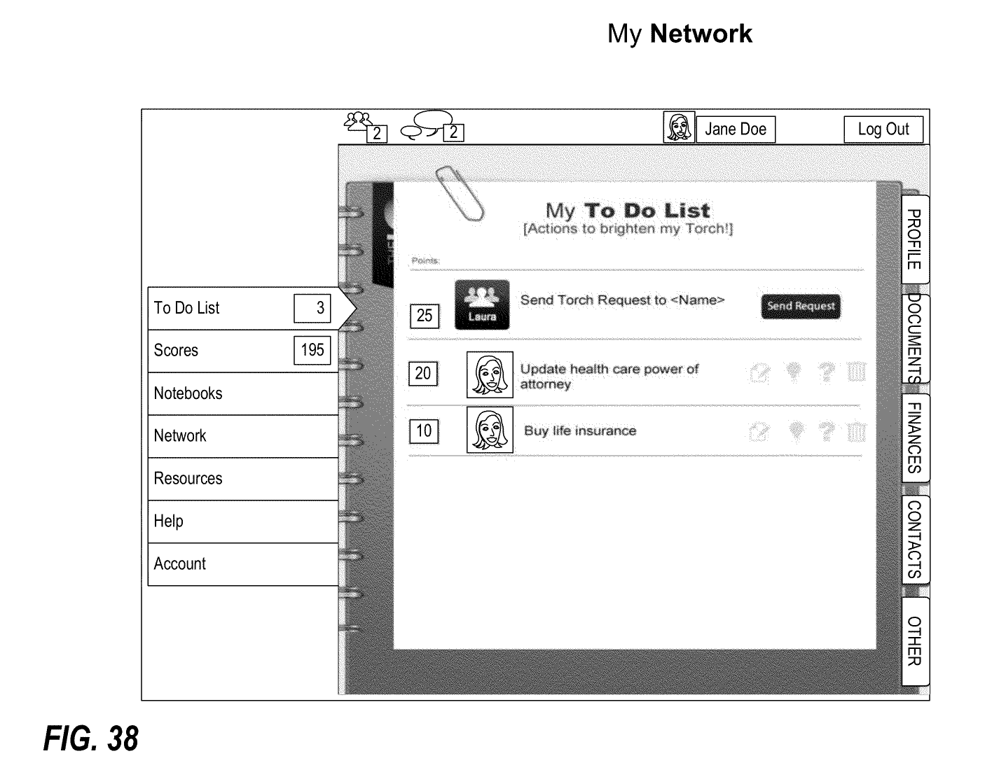

Another feature of the system 10 of the present invention is the automatic generation of a “To Do List.” As mentioned previously, it is possible to select a depiction of a “To Do List,” and accompanying functionality, from the dashboard. FIG. 38 is a graphical depiction of a “To Do List” display screen of one exemplary graphical user interface in accordance with one or more preferred embodiments of the present invention. As illustrated therein, selection of this functionality causes a graphical depiction of a “to do list” to be displayed. In at least some embodiments, this list is generated automatically. In at least some of these embodiments, items included in this list are those which were deemed mandatory by generally accepted estate planning guidelines and which were not yet provided by the user. There are four icons on the To Do Item: 1) edit allows the customer to edit the record to remove it from the To Do list, 2) find resources allows the customer to see local and online resources that can specifically help them with that To Do item, 3) see help text displays help text about why the item is important and 4) delete the item from the To Do list (note: If the item is deleted from the To Do list, it will still appear in the respective notebook.) Items in the To Do list will be sorted in priority order based on those items that will add the most points to their score. As items are on the list are completed, the user's score will go up.

### Scoring System and Methodology

Another feature of the system 10 of the present invention is a scoring system. As mentioned previously, it is possible to select a depiction of a “Scores,” and accompanying functionality, from the dashboard. FIG. 39 is a graphical depiction of a “Your Torch Scores” display screen of one exemplary graphical user interface in accordance with one or more preferred embodiments of the present invention. As described previously, use of the scoring system and methodology of the present invention offers an engaging way to provide individuals and the people relevant to that individual's estate with an indication of how well prepared they are for the occurrence of a life event. Although such a scoring system may be implemented in various ways, in at least some embodiments such a system involves both preparation activities carried out by the individual with the estate and preparation activities carried out by the people relevant to that individual's estate, sometimes referred to herein as “loved ones.”

In at least some embodiments, selection of another individual in the user's network (such as the user's mother or father, as shown in FIG. 39) results in the “bookshelf” of notebooks pertaining to that person's estate to be launched in view only mode.

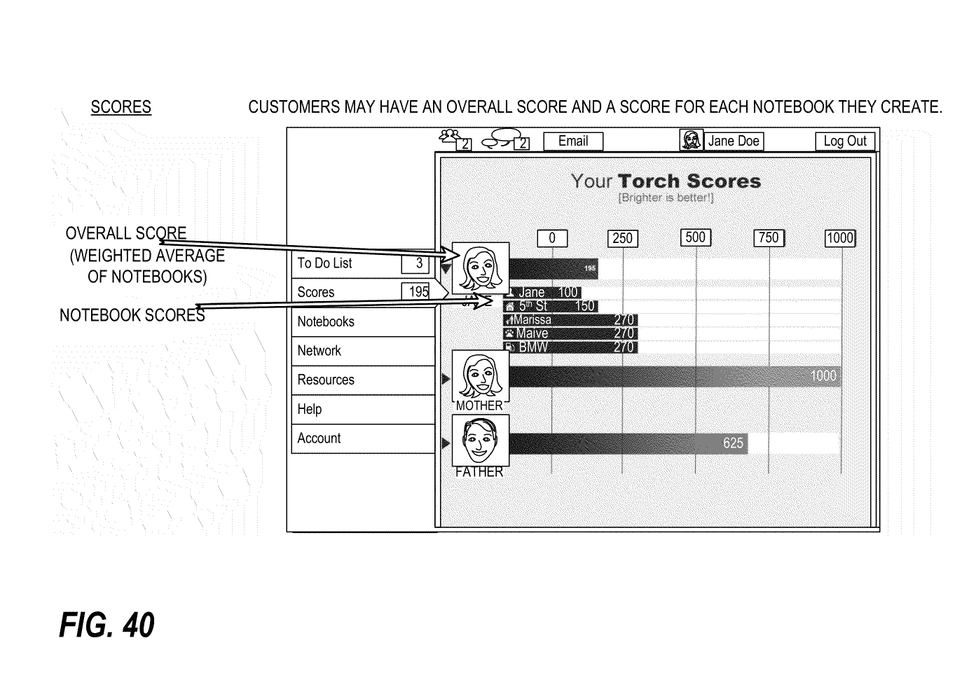

In at least one embodiment, a scoring methodology is next described with reference to FIGS. 39 to 3G. For example, in FIG. 39, a user received an “Overall Torch Score” of 195. As explained in FIG. 40, this “Overall Torch Score” is a weighted average of their notebooks. Each notebook type carries an importance weighting based on generally accepted estate planning guidelines. For example, a dependent notebook is weighted more heavily than a vehicle notebook given the importance of taking care of someone else versus an asset. An “Overall Torch Score” is calculated according to the following formula:

Torch Score=[(t1×T1)×R1)+(d1×D1)+(p1×P1)+(v1×V1)]/(t1+r1+p1+v1)

where:

t1=personal notebook importance weighting

r1=real estate notebook importance weighting

d1=dependent notebook importance weighting

p1=pet notebook importance weighting

v1=vehicle notebook importance weighting

and:

T1=personal notebook score

R1=real estate notebook score

D1=dependent notebook score

P1=pet notebook score

V1=vehicle notebook score

In at least one embodiment, the maximum possible score (a “perfect score”) is 1000.

Notably, for any given individual, one or more of the notebook categories may include zero, one, two, three, or any greater number of these notebooks, and thus the number of notebooks included in the formula may vary depending upon the individual.

In at least some embodiments, recognition, prizes and premiums may be given to high scoring customers.

In at least some embodiment, the decisions as to whether items in each estate organizer notebook are to be considered mandatory or optional are based on industry expert standards. A user preferably is required to have all of the mandatory items to reach 1000. The optional items are preferably not required to reach 1000, but if a user has them and has not completed all of the estate organizer requirements it will lower the user's score.

All items, mandatory or optional, will preferably meet at least one, and preferably all, of the following requirements:

Possession: The user has the item

Contact: The user has given the contact information for the service provider

Location: The user has provided the location of paperwork

Accuracy: The document and/or beneficiary is accurate

Automation: The user has provided guidance on direct deposit or auto pay for this item.

Some requirements are mandatory and some are optional. Points are assigned for each mandatory requirement for each item, for both mandatory and optional items. FIGS. 40 to 46 collectively represent a portion of an exemplary point scoring structure. Each one of these requirements carries a different point value based on priority. For example, having a will is higher priority than having the title to a car you own. The priorities are assigned based on generally accepted estate planning guidelines and the degree of future burden imposed on loved ones if the item is not available. The points associated will drive the priority ranking of items in the To Do list in order to encourage users to work on the items that will deliver the most benefit to their loved ones first. The points may or may not be displayed in the To Do list, a relative ranking or description may also be used. Some requirements may or may not have point values assigned to a specific answer to a requirement. For example, if a user responds their will is in their desk drawer, they may receive higher points if it was locked in a personal safe.

Preferably, the customer must enter their information into the estate organizer for the scoring to take place. The system will evaluate the responses in the database to calculate the score. In this regard, FIGS. 40 to 46 collectively represent a portion of an exemplary sample estate response.

“Notebook Score” may be calculated as follows:

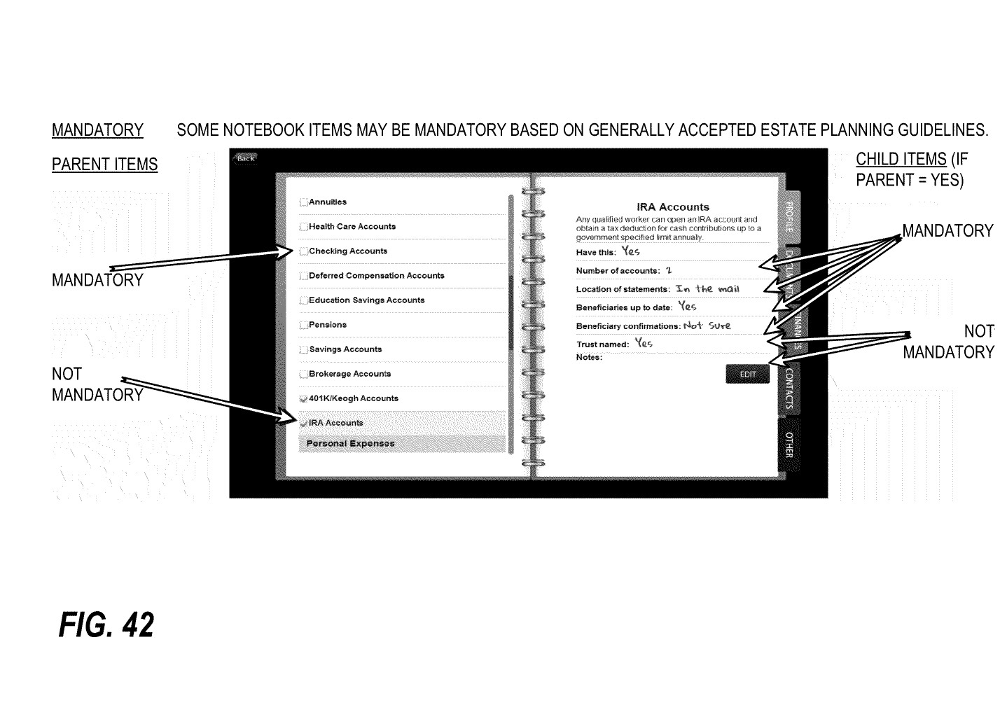

Notebook Score=(Total Pts Received/Total Pts Possible)×1000

where
Total Points=total # of points accumulated based on responses to estate organizer requirements
   Total Possible Points may be determined as follows. If the item is Mandatory, the total point value will be included in the total possible points. If the item is not mandatory and the customer does not have it, the total points will not be included in the total possible points. If the item is not Mandatory but the customer has it, the total points will be included in the total possible points. For example, a will is mandatory, if the customer does not have it, it will count against them in points. An IRA account is not mandatory, so if the customer does not have it, it will not count against them in points. If the customer has an IRA account, but does not know provide where the statements can be found or indicates that the beneficiaries are not up to date, then it will count against them in points. This is illustrated in FIGS. 42 to 44, where FIG. 42 is a portion of an exemplary point scoring structure for a situation where all items have been provided and all requirements have been met; FIG. 43 is a portion of an exemplary point scoring structure for a situation where only mandatory items have been provided; and FIG. 44 is a portion of an exemplary point scoring structure for a situation where all items have been provided, but some requirements have not been met.

Scores for each notebook and the overall Torch Score may be displayed on the “Scores” page. Users will be able to view their own Overall Torch Score and scores for each notebook and the same for all of the people who have passed their torch to them. They will not be able to see the scores of anyone who has not passed their Torch to them. Passing Torches is not mutual, it is only one way. Each user must pass a Torch to the other in order for them to view their score and their notebooks.

### Alternative Scoring Methodology

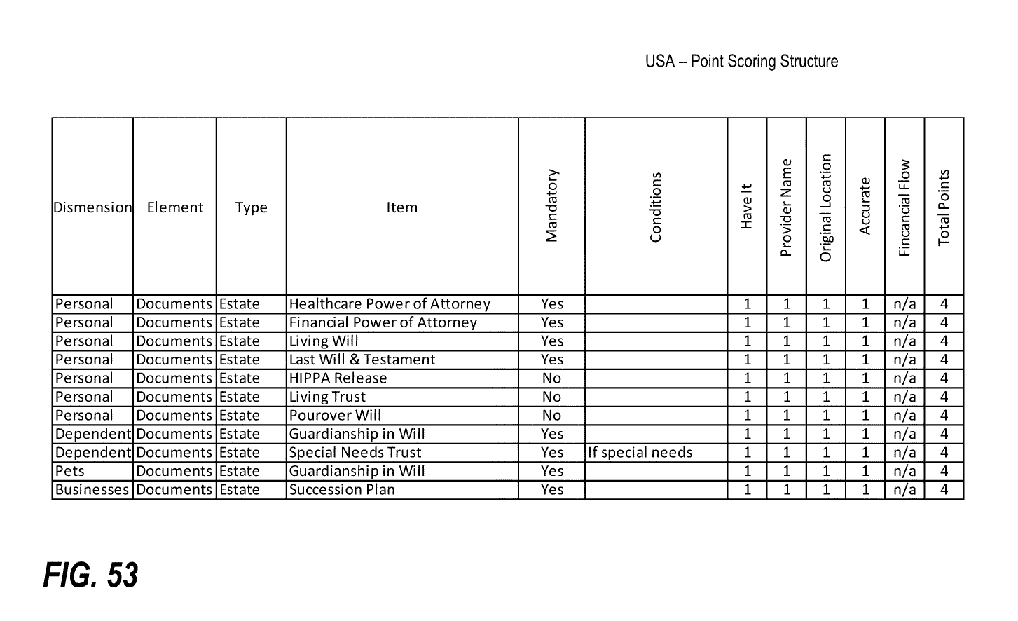

It will be appreciated that other scoring methodologies may alternatively be used, or that aspects and features of other scoring methodologies may be combined with the scoring methodology described above. One particular alternative scoring methodology is next described with reference to FIGS. 53 to 57.

In the alternative scoring methodology, a “Torch Score” is calculated according to the following formula:

Torch Score=((My Estate Score+Avg Relay Estate Score)/2);

where if:

Torch Score=100%

then Bonus Points (discussed below) may be added. Furthermore, in the above formula, “My Estate Score” represents the completeness of the estate organizer, with the goal being 100%, and “Avg Relay Estate Score” is the average of the completeness of the estate organizer's relay, with the goal once again being 100%.

In a first example, a user's Torch Score may be calculated as follows:

85%=((100%+70%)/2)−the customers relay are dimming the Torch Score

In a second example, a user's Torch Score may be calculated as follows:

103%=((100%+100%)/2)+3%

In this example, the bonus points are added if the Torch Score is greater than or equal to 100%.

In at least some embodiments, recognition, prizes and premiums may be given to high scoring customers.

Items in the estate organizer are considered mandatory or optional based on industry expert standards. A user preferably is required to have all of the mandatory items to reach 100%. The optional items are preferably not required to reach 100%, but if a user has them and has not completed all of the estate organizer requirements it will lower the user's score. Optional items will give the user bonus points.

All items, mandatory or optional, will preferably meet at least one, and preferably all, of the following requirements:

Possession: The user has the item

Contact: The user has given the contact information for the service provider

Location: The user has provided the location of the original document

Accuracy: The document and/or beneficiary is accurate

Money Flow The user has provided guidance on direct deposit or auto pay for this item. Points are assigned for each requirement for each item, for both mandatory and optional items. FIG. 53 is a portion of an exemplary point scoring structure for use in the United States.

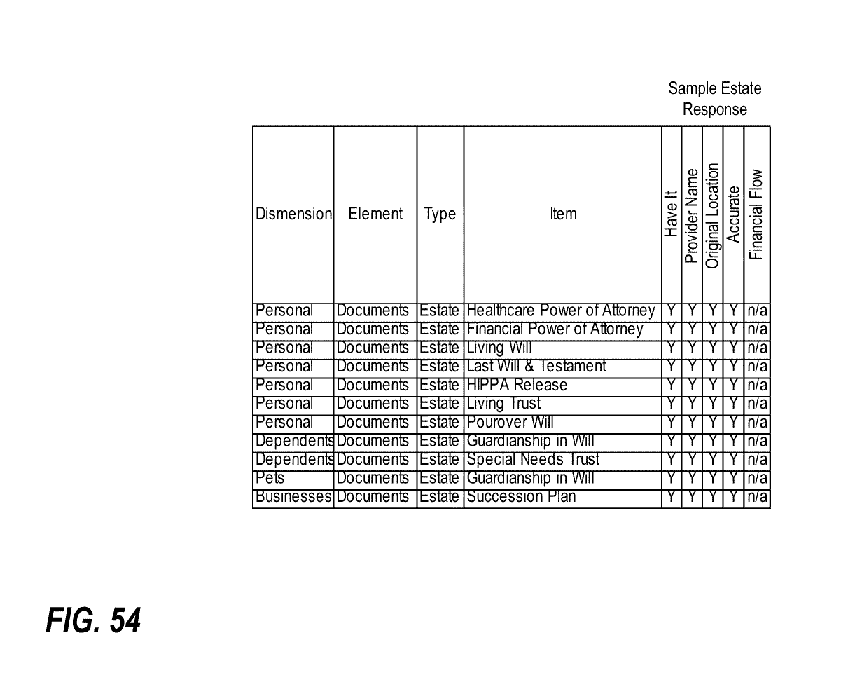

Preferably, the customer must enter their information into the estate organizer for the scoring to take place. The system will evaluate the responses in the database to calculate the score. In this regard, FIG. 54 is a portion of an exemplary sample estate response.

“Torch Score” may be calculated as follows:

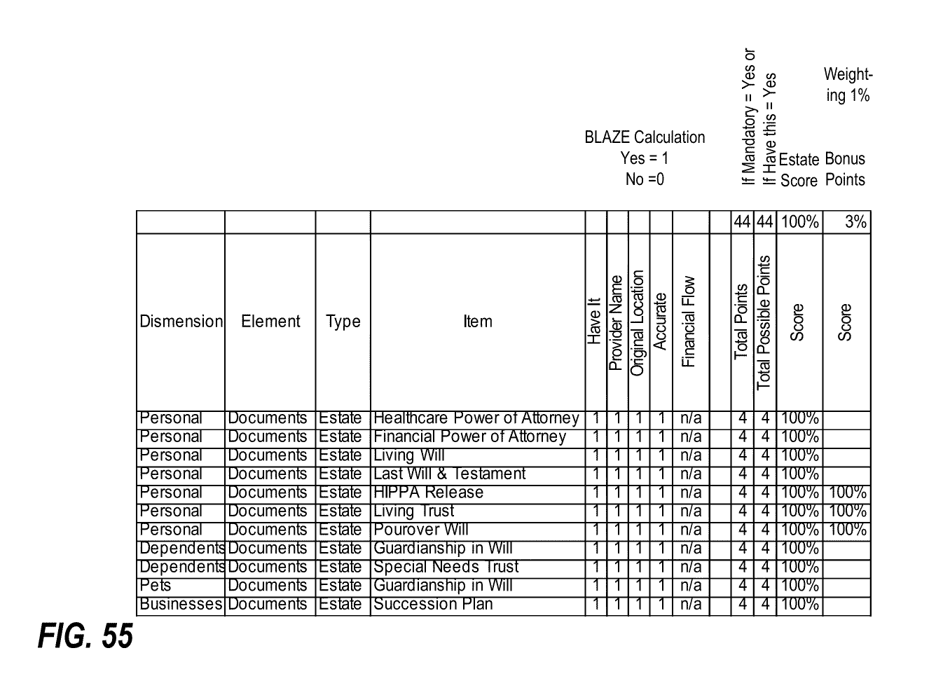

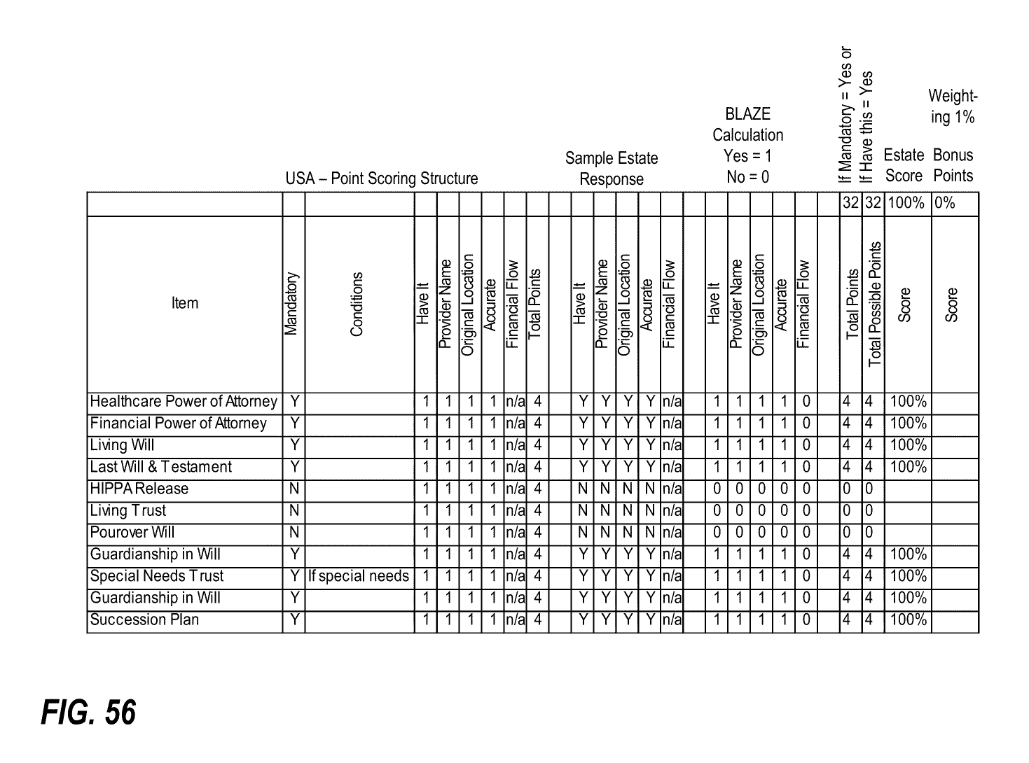

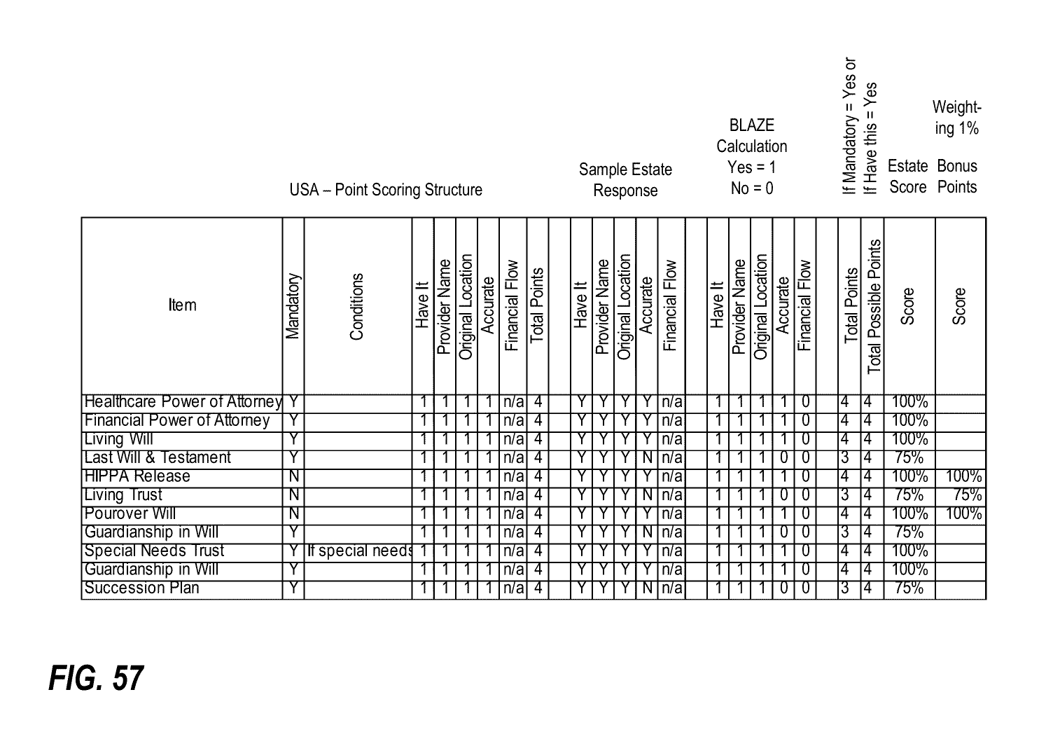

Total Points/Total Possible Points=Torch Score(shown as a percentage)

where
Total Points=total # of points accumulated based on responses to estate organizer requirements
   Total Possible Points may be determined as follows. If the item is Mandatory, the total point value will be included in the total possible points. If the item is not mandatory and the customer does not have it, the total points will not be included in the total possible points. If the item is not Mandatory but the customer has it, the total points will be included in the total possible points. For example, a will is mandatory, if the customer does not have it, it will count against them in points. A Trust is not mandatory, so if the customer does not have it, it will not count against them in points. If the customer has a Trust, but does not know where the document is located or indicates that it is not accurate, then it will count against them in points. This is illustrated in FIGS. 55-57, where FIG. 55 is a portion of an exemplary point scoring structure for a situation where all items have been provided and all requirements have been met; FIG. 56 is a portion of an exemplary point scoring structure for a situation where only mandatory items have been provided; and FIG. 57 is a portion of an exemplary point scoring structure for a situation where all items have been provided, but some requirements have not been met.

The “Average Relay Score” may be calculated as follows:

Average Relay Score=(Torch Score 1+Torch Score 2+ . . . Torch Score n)/Total Number of Estates

Put another way, the Average Relay Score may be determined by averaging the Torch scores for every estate for which the customer is a decision maker.

Bonus points may be treated as follows. If the base Torch Score is below 100%, the bonus points may remain in what may be called “Bonus Jail” (or some other term) until the Torch Score is at 100%. Once the Torch Score is equal to 100%, the bonus points may be added to the Torch Score. If at any point in time the base Torch Score falls below 100%, the bonus points may be removed and put back in “Bonus Jail” (or some other term) until the Torch Score is at 100%. Bonus points may be allotted for going above and beyond the mandatory requirements, signing up new customers or vendors to the system website, using vendors referred by the system website, and/or reviewing vendors referred by the system website.

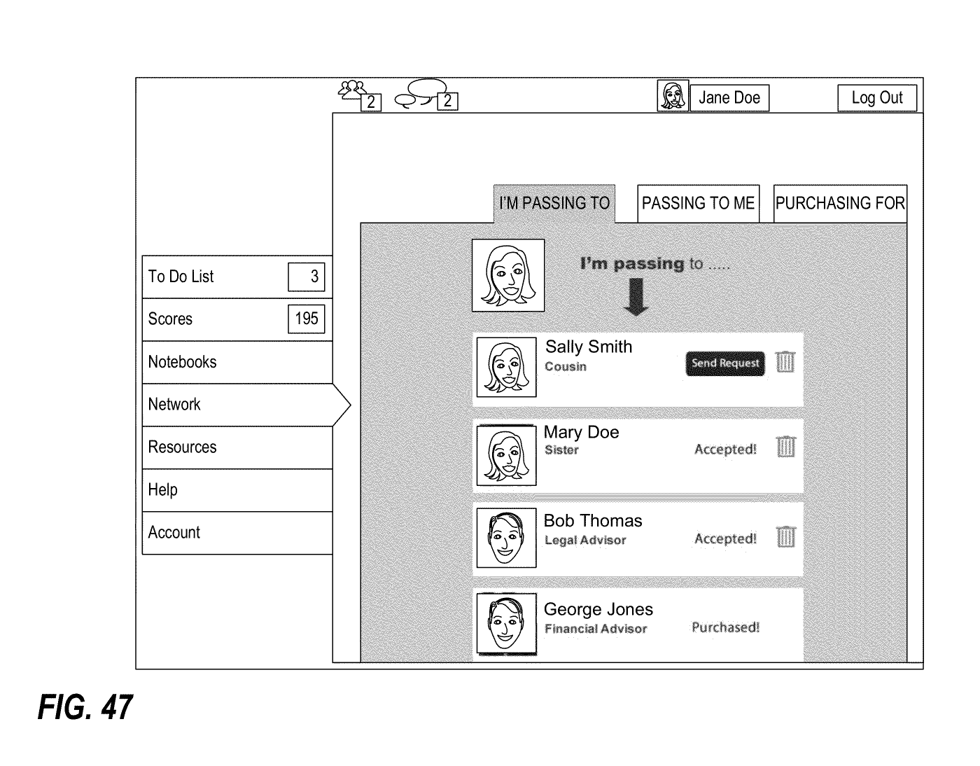

As mentioned previously, it is possible to select a depiction of “Network,” and accompanying functionality, from the dashboard. In this regard, FIG. 47 is a graphical depiction of a first network requests display screen of one exemplary graphical user interface in accordance with one or more preferred embodiments of the present invention. The user may enter the names of individuals to whom they wish to pass their torch (i.e, share their information). The user is then notified when a particular person accepts or declines such request. If the person accepts, then he or she will be able to view the user's notebooks.

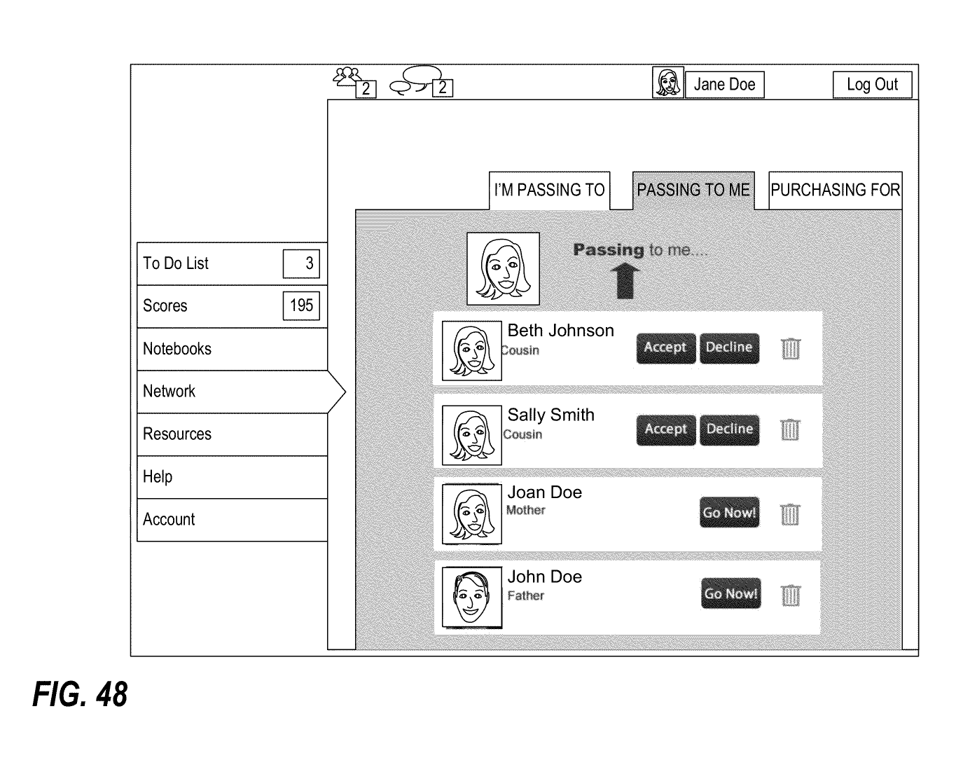

FIG. 48 is a graphical depiction of a second network requests display screen of one exemplary graphical user interface in accordance with one or more preferred embodiments of the present invention. Using this screen, another user can accept or decline a request from an estate owner with regard to sharing such estate owner's estate (via their notebooks). The other user has the option of accepting or declining the request, and the estate owner is notified when acceptance or rejection occurs.

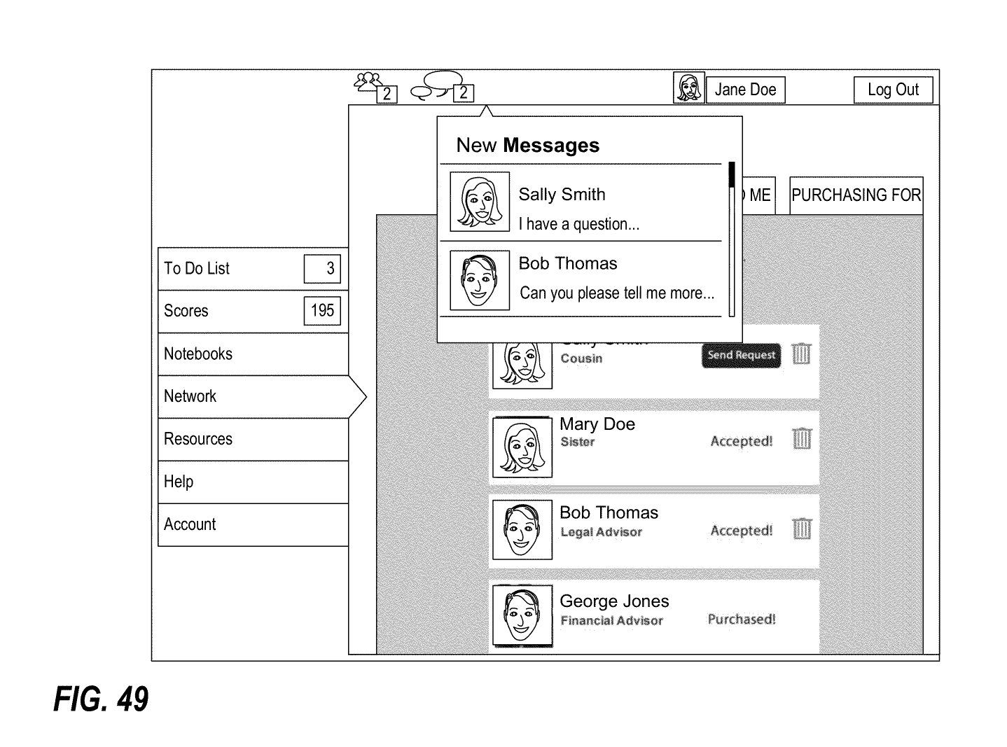

FIG. 49 is a graphical depiction of a network messages display screen of one exemplary graphical user interface in accordance with one or more preferred embodiments of the present invention. Using this screen, a user can display messages received from other people in the user's network, and can take various actions with respect to such messages.

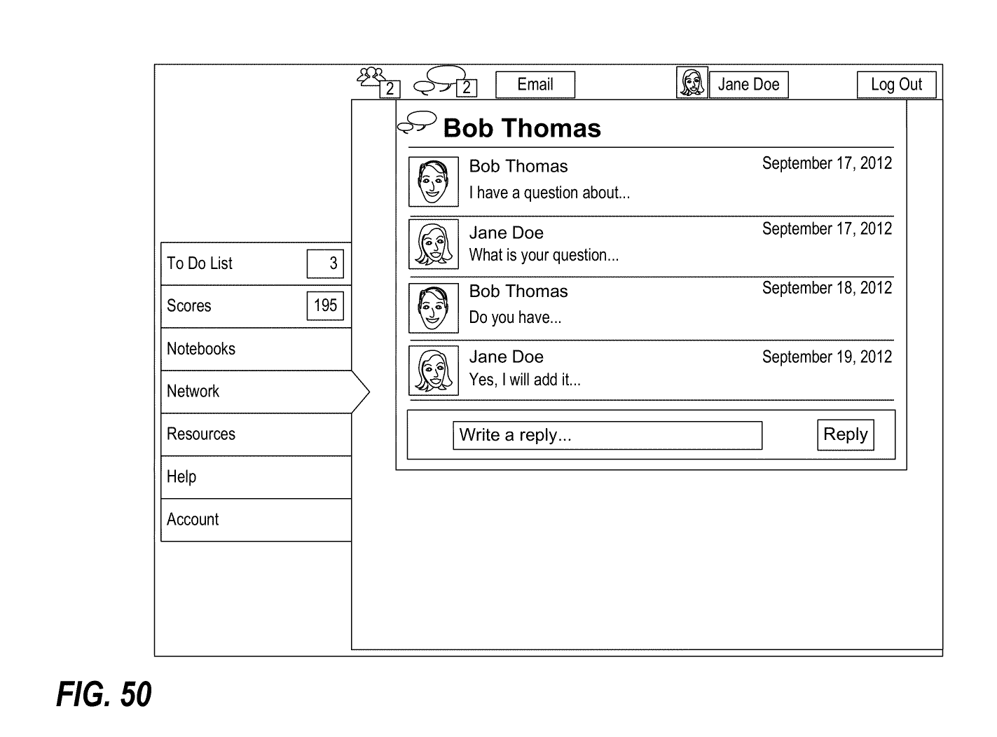

FIG. 50 is a graphical depiction of a message details display screen of one exemplary graphical user interface in accordance with one or more preferred embodiments of the present invention. By selecting the name of the person, the user may see a trail of messages between the user and the person selected, and can reply as desired.

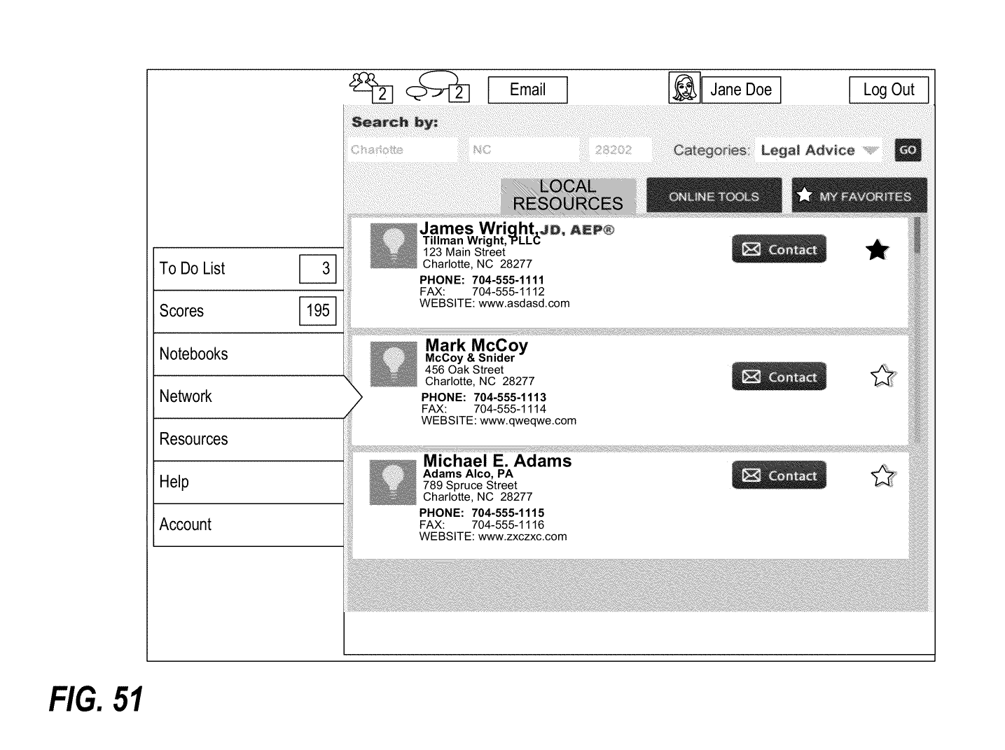

As mentioned previously, it is possible to select a depiction of “Resources,” and accompanying functionality, from the dashboard. In this regard, FIG. 51 is a graphical depiction of a local resources display screen of one exemplary graphical user interface in accordance with one or more preferred embodiments of the present invention. Using this screen, a directory of local resource contacts may be searched and accessed. Local professionals can arrange for the display or inclusion of an online profile consisting of logo, name, company, address, phone number and website. The Torch customer users can contact the local professional directly via an online form and it will be directly emailed to the owner of the profile. Professional profile categories include, but are not limited to, Legal Advice, Financial Advice, Funeral Services and Estate Liquidation Services.

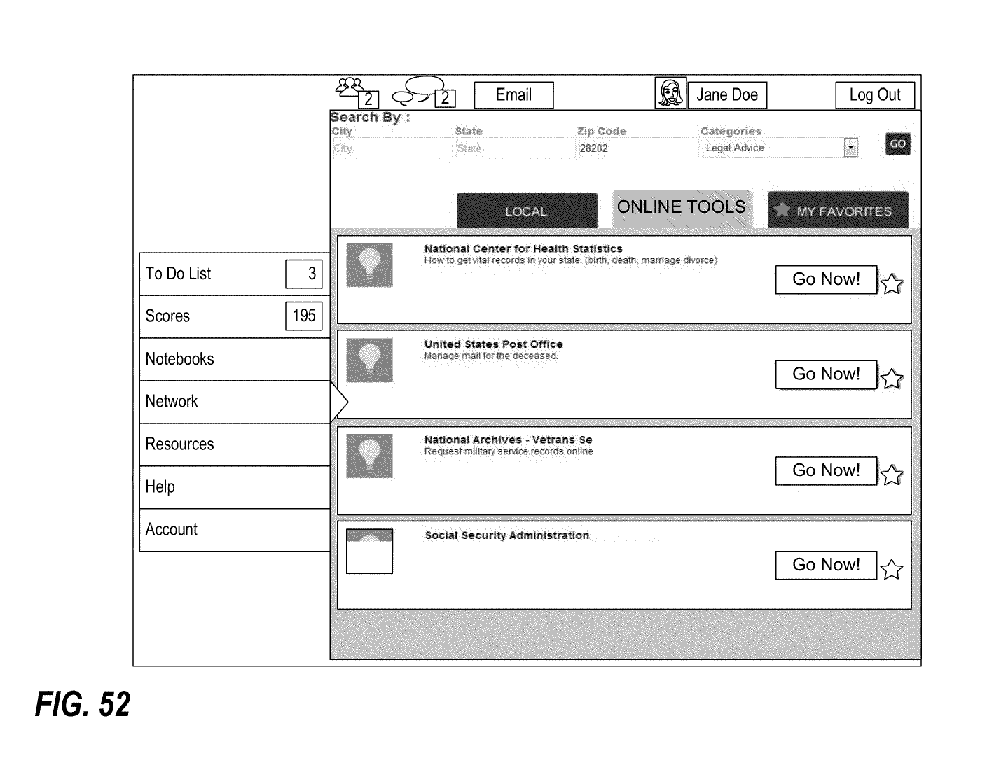

FIG. 52 is a graphical depiction of an online resources display screen of one exemplary graphical user interface in accordance with one or more preferred embodiments of the present invention. Using this screen, a directory of online resources may be searched and accessed. Such online resources may include, but are not limited to, government websites, retail sites, polices for closing online accounts, and the like. In at least some embodiments, users may click a button to be linked to the site.

### Alternative Exemplary Graphical User Interface

At least one exemplary graphical user interface has thus been described and illustrated. FIGS. 58-X70 are wireframe diagrams illustrating portions of an alternative exemplary graphical user interface in accordance with one or more preferred embodiments of the present invention. A short description of each such diagram is provided below.

FIG. 58 (“Dimensions”) is a picture of the torch Torch Score with a graphical representation of the scores of the people in the customer's relay. When a person is selected from the graph, the dimensions of that person's estate will be shown to the right. The customer will be able to add and delete dimensions from their own estate only.

FIG. 59 (Personal Items—General): When the personal button is selected, the right panel will display the general items for the personal dimension. The tab bar at the top will allow the customer to move through the different sections. All lists will be pre-populated with expert recommended items to reduce the amount of data entry. The next button will take the customer to the documents section, or they can tap the menu bar at the top.

FIG. 60 (Personal Items—Documents): When the documents button is selected, the right panel will display the documents for the personal dimension. All lists will be pre-populated with expert recommended items to reduce the amount of data entry. The next button will take the customer to the Finances section, or they can tap the menu bar at the top.

FIG. 61 (Personal Items—Finances): when the Finances button is selected, the right panel will display the finances for the personal dimension. All lists will be pre-populated with expert recommended items to reduce the amount of data entry. The next button will take the customer to the Insurance section, or they can tap the menu bar at the top.

FIG. 62 (Personal Items—Insurance): When the Insurance button is selected, the right panel will display the finances for the personal dimension. All lists will be pre-populated with expert recommended items to reduce the amount of data entry. The next button will take the customer to the Contacts section, or they can tap the menu bar at the top.

FIG. 63 (Personal Items—Contacts): When the Contacts button is selected, the right panel will display the finances for the personal dimension. All lists will be pre-populated with expert recommended items to reduce the amount of data entry. The next button will present a popup that will ask the customer if they have any dependents. If yes, it will present them with the dependent screens (see #12); if no, it will ask the customer if they have any pets. The routine will continue through all of the dimensions.

FIG. 64 (Personal—General—Detail): When an item on the general items panel is tapped, a detail panel will appear at the right and the left dimensions panel will disappear. The item detail panel will display fields unique to that item and will present pick lists for each field.

FIG. 65 (Personal—Documents—Detail): When an item on the documents items panel is tapped, a detail panel will appear at the right and the left dimensions panel will disappear. For each document in the list, the customer should preferably be required to answer 4 questions, (1) do you have it? (2) where is it? (3) is it accurate? (4) who has a copy?

FIG. 66 (Personal—Finances—Detail): When an item on the Finances items panel is tapped, a detail panel will appear at the right and the left dimensions panel will disappear. For each financial item in the list, the customer should preferably be required to answer 6 questions (1) Do you have it? (2) Who is the financial institution (3) Joint with anyone else? (4) (Only for assets that require a beneficiary) Are the beneficiaries accurate? (5) (Only if they have a trust and the item is an asset) Funded into a Trust?, (6) (Only for liabilities) Automatic Payments Established?

FIG. 67 (Personal—Insurance—Detail): When an item on the Insurance items panel is tapped, a detail panel will appear at the right and the left dimensions panel will disappear. The customer must answer 6 questions (1) Do you have it? (2) Who is the insurance company (3) Where is the policy? (4) Are the beneficiaries accurate? Only for life insurance (5) Funded into a Trust? Only for life insurance (6) Automatic Payments Established?

FIG. 68 (Personal—Contacts—Detail): When an item on the Contacts items panel is tapped, a detail panel will appear at the right and the left dimensions panel will disappear. The customer must answer 3 questions (1) do you have it? (2) Contact information (3) (Only for utilities and some services) Automatic Payments established? The item detail panel will display fields unique to that item and will present pick lists for each field.

FIG. 69 (Dependents—General): When the “plus” button on the dependents bar is selected, the right panel will display the general items for the dependent. The tab bar at the top will allow the customer to move through the different sections. All lists will be pre-populated with expert recommended items to reduce the amount of data entry. The next button will take the customer to the documents section, or they can tap the menu bar at the top.

FIG. 70 (Dependents—Documents): When the Documents button on a dependent is selected, the right panel will display the document items for the dependent. All lists will be pre-populated with expert recommended items to reduce the amount of data entry. The next button will take the customer to the Finances section, or they can tap the menu bar at the top.

FIG. 71 (Dependents—Finances): When the Finances button on a dependent is selected, the right panel will display the finance items for the dependent. All lists will be pre-populated items from the personal section and the customer can select those items that are designated for this dependent or add new items if they wish. The next button will take the customer to the Insurance section, or they can tap the menu bar at the top.

FIG. 72 (Dependents—Insurance): When the Insurance button on a dependent is selected, the right panel will display the Insurance items for the dependent. All lists will be pre-populated with information from the personal section and customer can select those items that also cover the dependent or add new items as they wish. The next button will take the customer to the Contact section, or they can tap the menu bar at the top.

FIG. 73 (Dependents—Contacts): When the Contacts button on a dependent is selected, the right panel will display the Contacts items for the dependent. All lists will be pre-populated with expert recommended items and the customer can add new items as they wish. The next button will take the customer to the Pets section and will ask them if they have a pet, if no, it will take them to the Business section, if yes, it will take them to the Pet General section.

FIG. 74 (Pets—General): When the General button on a Pets dimension is selected, the right panel will display the General items for the pet. The next button will take the customer to the Documents section.

FIG. 75 (Pets—Documents): When the Documents button on a Pets dimension is selected, the right panel will display the Document items for the pet. The lists will be pre-populated with expert recommended items. The next button will take the customer to the Finances section or they can press the tabs at the top.

FIG. 76 (Pets—Finances): When the Finances button on a Pets dimension is selected, the right panel will display the Finances items for the pet. The lists will be pre-populated with items from the personal finance section. The customer can select those items that are designated for the pet or add new items. The next button will take the customer to the Insurance section or they can press the tabs at the top.

FIG. 77 (Pets—Insurance): When the Insurance button on a Pets dimension is selected, the right panel will display the Insurance items for the pet. The lists will be pre-populated with expert recommended items or the customer can add new items. The next button will take the customer to the Contacts section or they can press the tabs at the top.

FIG. 78 (Pets—Contacts): When the Contacts button on a Pets dimension is selected, the right panel will display the Contact items for the pet. The lists will be pre-populated with expert recommended items or the customer can add new items. The next button will take the customer to the Business section and ask them if they have a business, if yes, it will present the General panel for a business, if not, it will take them to the vehicle dimension.

FIG. 79 (Businesses—General): When the General button on a Business dimension is selected, the right panel will display the General items for the business. The next button will take the customer to the Documents section.

FIG. 80 (Businesses—Documents): When the Documents button on a Business dimension is selected, the right panel will display the Documents for the business. The lists will be pre-populated with expert recommended items or the customer can add new items. The next button will take the customer to the Finances section.

FIG. 81 (Businesses—Finances): When the Finances button on a Business dimension is selected, the right panel will display the Finances for the business. The lists will be pre-populated with expert recommended items or the customer can add new items. The next button will take the customer to the Finances section.

FIG. 82 (Businesses—Insurance): When the Insurance button on a Business dimension is selected, the right panel will display the Insurance for the business. The lists will be pre-populated with expert recommended items or the customer can add new items. The next button will take the customer to the Contacts section.

FIG. 83 (Businesses—Contacts): When the Contacts button on a Business dimension is selected, the right panel will display the Contacts for the business. The lists will be pre-populated with expert recommended items or the customer can add new items. On set-up—the next button will take the customer to the Vehicles section and will ask them if they have any vehicles, if no, it will take them to the Real Estate section, if yes, it will take them to the Vehicle General Section.

FIG. 84 (Vehicles—General): When the General button on a Vehicles dimension is selected, the right panel will display the General items for the vehicle. The next button will take the customer to the Documents section.

FIG. 85 (Vehicles—Documents): When the Documents button on a Vehicles dimension is selected, the right panel will display the Documents for the vehicle. The lists will be pre-populated with expert recommended items or the customer can add new items. The next button will take the customer to the Finances section.

FIG. 86 (Vehicles—Finances): When the Finances button on a Vehicles dimension is selected, the right panel will display the Finance items for the vehicle. The lists will be pre-populated with expert recommended items or the customer can add new items. The next button will take the customer to the Insurance section.

FIG. 87 (Vehicles—Insurance): When the Insurance button on a Vehicles dimension is selected, the right panel will display the Inusrance items for the vehicle. The lists will be pre-populated with expert recommended items or the customer can add new items. The next button will take the customer to the Contacts section.

FIG. 88 (Vehicles—Contacts): When the Contacts button on a Vehicles dimension is selected, the right panel will display the Contacts for the vehicle. The lists will be pre-populated with expert recommended items or the customer can add new items. The next button will take the customer to the Real Estate dimension and ask them if they have any Real Estate, if no, will go the Report section, if yes, will go to the Real Estate General panel.

FIG. 89 (Real Estate—General): When the General button on a Real Estate dimension is selected, the right panel will display the General items for the real estate. The next button will take the customer to the Documents section.

FIG. 90 (Real Estate—Documents): When the Documents button on a Real Estate dimension is selected, the right panel will display the Documents for the real estate. The lists will be pre-populated with expert recommended items or the customer can add new items. The next button will take the customer to the Finances section.

FIG. 91 (Real Estate—Finances): When the Finances button on a Real Estate dimension is selected, the right panel will display the Finances for the real estate. The lists will be pre-populated with expert recommended items or the customer can add new items. The next button will take the customer to the Insurance section.

FIG. 92 (Real Estate—Insurance): When the Insurance button on a Real Estate dimension is selected, the right panel will display the Insurance for the real estate. The lists will be pre-populated with expert recommended items or the customer can add new items. The next button will take the customer to the Contacts section.

FIG. 93 (Real Estate—Contacts): When the Contacts button on a Real Estate dimension is selected, the right panel will display the Contacts for the real estate. The lists will be pre-populated with expert recommended items or the customer can add new items. The next button will take the customer to the Reports section.

FIGS. 94-X57 are wireframe diagrams illustrating various reports.

FIG. 94 (General) illustrates a summary report of all general items by dimension. The report displays the item name and more details will be defined when the prototype is built.

FIG. 95 (Documents) illustrates a summary report of all documents grouped by location. The report displays the name of document, provider of document, phone number and more items will be defined when the prototype is built.

FIG. 96 (Finance) illustrates a summary report of all finances by assets and liabilities. The report displays the item name, name of the financial institution, phone and more items will be defined when the prototype is built.

FIG. 97 (Insurance) illustrates a summary report of all insurance policies by location. The report displays the name of the insurance policy, the insurance company, phone and more items will be defined when the prototype is built.

FIG. 98 (Contacts) illustrates a summary report of all contacts by contact type. The report displays the contact item, contact name, contact phone, and more items will be defined when the prototype is built.

FIG. 99 (Action Plans) illustrates a summary report listing industry expert action items by event category. When the action item is selected details of the required items or actions are displayed.

FIG. 100 is a wireframe diagram illustrating a first exemplary action item. In order for the decision maker to make medical decisions for the individual they will need (1) Document—Health Care Power of Attorney, (2) Finances—Healthcare Savings Account, (3) Insurance—Medical Insurance, (4) Contact—Primary Care Physician, (5) Wishes & Wisdom—Allergies/Illnesses.

FIG. 101 is a wireframe diagram illustrating a second exemplary action item. In this example, the decision maker will need to resolve the financial accounts. The report will display all of the financial accounts.

FIG. 102 is a wireframe diagram illustrating a third exemplary action item. When the financial account is selected, details will show with the financial institution name, address and phone number, along with the instructions on how to resolve the account depending upon how it was set up (i.e., Payment on Death (POD), In a Trust or a regular account that must go through probate court). When feasible, there will be a button that will initiate an electronic process with the financial institution to process the account action.

FIG. 103 is a wireframe diagram illustrating a fourth exemplary action item. If the action item requires third party resources, relevant local resources will be displayed.

FIG. 104 (Asset Map): All of the assets will be displayed and grouped by trusts, beneficiaries and those items that need to go through probate.

FIG. 105 (Direct Deposit): All income is displayed grouped by those with direct deposit and those without direct deposit.

FIG. 106 (Auto Pay): All critical insurance, liability and utility bills are displayed grouped by those that are on Auto Pay and those that are not.

FIGS. 107-X70 are wireframe diagrams illustrating a “dashboard” portion of a graphical user interface.

FIG. 107 is a concept wireframe diagram for the initial splash page on the web version.

FIG. 108 (Estate organizer page) is a concept wireframe diagram for the initial page for the estate organizer, it will show a picture of a torch and the size of the Torch Score will be representative of the average aggregate score of the relay.

FIG. 109 (To Do page) is a concept wireframe diagram for the to do list, if all these items are completed, the score will increase.

FIG. 110 (To Do Resources): If the to do item is selected, there will be resources presented that can assist with completing the item.

FIG. 111 (To Do Complete): If the complete box is selected, the customer will be prompted to enter the necessary items. The item will not be considered complete until the necessary information is entered.

FIG. 112 (Relay Requests): The customer enters the names of the people to whom they will pass their torch, they are also given the option to see the names of the people who have passed a torch to them to carry.

FIG. 113 (Relay Request detail): If the name of the person is selected, details regarding if that person has accepted the request and has signed off on the dimensions of the customers estate organizer

FIG. 114 (Messages) is where any messages from people in the relay are displayed. Messages from people who the customer is passing their torch are displayed in one view, there is another view for messages coming from people who are passing their torch to the customer to carry.

FIG. 115 (Message Details): By selecting the name of the person, the customer will see a trail of messages between them and the person selected. They can reply in this screen.

FIG. 116 (Resources) is an online directory of resources, both local and national/do it yourself FIG. 117 (Resource Detail): If the customer selects a category, they have the option to enter a city, state and country. Lists of resources will appear.

FIG. 118 (Resource Page): If they select the icon for a resource, a resource page will appear with all the details for that resource. They will be able to save it as a favorite, share it with friends, email to someone or print the information. They will be able to email the vendor using the request more information button.

FIG. 119 (Resource Customer Rating): If the user scrolls down the page, there will be an area to see make and see customer reviews.

In another feature, financial and legal advisors with professional accounts will have a dashboard of all their clients and can easy purchase memberships for new clients. Advisors who purchase for their clients will have special features including, but not limited to, edit access and custom reports.

In another feature, service providers with profiles in the Resources section will have a dashboard with traffic and lead statistics.

In another feature, people can purchase a membership for someone else. For example, advisors can purchase a membership for their clients and adult children can purchase a membership for their elderly parents.

In another feature, people can share specific notebooks with specific people and restrict specific people from seeing specific notebooks.

In another feature, automated interface into digital document storage providers (i.e. Dropbox, Sky Drive, iCloud, etc) with a automated template of folders on how to organize and manage your electronic estate documents better.

In another feature, automated interface into digital asset storage providers (i.e. SecureSafe, Entrusted, LegacyLocker, MyPersonalDataSafe, etc) with an automated template of items you should store there.

In another feature, the application will provide the ability for the customer to post their Torch Score to social networking sites for others to see. In at least some embodiments, a Torch Leaderboard is provided where everyone can see the Torch Scores of all customers.

In another feature, additional action plan events may include: Going on a trip, losing your wallet, getting your car stolen, losing a pet, fire in your house, and the like. Each checklist or action plan will list all of the items in a user's estate organizer that are relevant to the event and then will provide instructions on what to do. Where possible, the application will automate notifications to the user's insurance companies or financial institutions. For example, if a user loses their wallet, the action plan will list all of their debit cards/credit cards and the numbers to call; and if feasible, the user will be able to initiate a notification to their card company via the software. It will also list the user's homeowners or renters insurance which may cover the situation. It will provide the number to the local Department of Motor Vehicles, the numbers to the credit bureaus and the local police department.

In another feature, the Torch score may include a tax optimization score reflecting if some of the estate items would be better “protected” from estate taxes in another state or in another financial vehicle.

In another feature, the Torch score may include document location optimization score reflecting if document are optimally protected from damage and/or theft.

In another feature, the Torch score may include an efficiency assessment, or efficiency score, reflecting if the customer has the potential to make the estate settlement process easier for loved ones by making changes in the way their estate is organized.

In another feature, the torch may include functionality for creating business notebooks for privately held business to be used by the owner and executive level managers.

In another feature, automated outbound telephone number verification calling may be provided to make sure telephone numbers for institutions are correct and have not changed.

In another feature, annual personal continuity test where the software or an employee of the Torch will verify all of the contact information (phone number, address, email) of all the items in the estate organizer to make sure the information is valid.

In another feature, font size change button automatically set by age.

In another feature, automated interface into social networks (i.e. Facebook, Linkedln, Twitter, etc) that will allow the customer to take a snapshot on a periodic basis of specific or all contacts. That list can be used by the decision maker to distribute news about the health and welfare of the customer.

In another feature, the application will allow the customer to upload a picture of document locations (filing cabinets, briefcases, etc.) with GPS locators to make it easy for the decision maker to find it in the house.

In another feature, the application will provide the ability define the disposition of digital assets. For example, online email accounts can be saved or there can be a “kill switch” that requires the decision maker to remove all items before closing the account with the provider. There will be specific instructions to the decision maker regarding all digital assets.

Based on the foregoing information, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention.

Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements; the present invention being limited only by the claims appended hereto and the equivalents thereof.

1. An estate and life event organization and management system, comprising:
a plurality of user computers;
a plurality of entity computers;
a network; and
one or more server computers implementing a software environment, wherein the software environment provides a graphical user interface and background functionality to:
receive, from a user, input representative of information describing an estate of the user,
organize the received information for subsequent presentation back to the user,
automatically analyze the received information to determine, based on the received information and on criteria predefined within the software environment, action items to be performed, by a person other than the user, with regard to various portions of the estate, and
automatically organize the action items into a checklist for use by the person other than the user.

2. The system of claim 1, wherein the user is a first user, and wherein the software environment further provides a graphical user interface and background functionality to present the checklist back to a second user.

3. (canceled)

4. The system of claim 2, wherein the second user is different than the first user, wherein each user is identified and distinguished within the software environment by a unique system account.

5. (canceled)

6. The system of claim 2, wherein the software environment further provides a graphical user interface and background functionality to organize the action items into a plurality of different checklists for use by the person other than the user.

7. The system of claim 6, wherein the software environment further provides a graphical user interface and background functionality to organize the action items into at least two of:
a checklist for action items to be performed upon the death of the first user,
a checklist for action items to be performed upon a medical emergency of the first user, and
a checklist for action items to be performed upon a financial emergency of the first user.

8. The system of claim 2, wherein the software environment further provides a graphical user interface and background functionality to present the checklist back to a second user in graphical format.

9-16. (canceled)

17. An estate and life event organization and management system, comprising:
a plurality of user computers;
a plurality of entity computers;
a network; and
one or more server computers implementing a software environment, wherein the software environment provides a graphical user interface and background functionality to:
receive, from a user, input representative of information describing a plurality of different dimensions of an estate of the user,
organize the received information into a plurality of groups, wherein each group pertains to exactly one of the different dimensions of the estate of the user,
after organizing the received information, presenting all of the groups to the user such that each group represents a selectable option, and
upon selection, by the user, of a particular group, presenting the information that was organized into the selected group to the user.

18-23. (canceled)

24. The system of claim 17, wherein the graphical user interface and background functionality is further adapted to prompt the user for specific input to be received from the user and to generate a list of action items, representative of a “to do” list, corresponding to all prompts for which the user failed to provide a specific input response to the respective prompt.

25. The system of claim 24, wherein the graphical user interface and background functionality is further adapted to display the list of action items, representative of a “to do” list, to the user.

26. The system of claim 24, wherein the action items on the represent items of information that a user should provide to the software environment in order to complete organization of the estate of the user.

27. The system of claim 24, wherein the action items correspond to prompts to which a user has failed to respond.

28. The system of claim 24, wherein the action items correspond to prompts to which a user has indicated that he or she is unsure of how to respond to the prompts.

29. (canceled)

30. An estate and life event organization and management system, comprising:
a plurality of user computers;
a plurality of entity computers;
a network; and
one or more server computers implementing a software environment, wherein the software environment provides a weighted scoring methodology to organize or manage a user's estate.

31. The system of claim 30, wherein points are given for completion of mandatory elements of an estate plan and bonus points are given for completion of non-mandatory elements of an estate plan.

32. (canceled)

33. The system of claim 31, wherein the bonus points are awarded only if all mandatory elements of the estate plan are completed.

34. The system of claim 31, wherein points are given when a second user confirms their understanding of a first user's estate plan.

35. The system of claim 31, wherein after first providing a total score, the scoring methodology later removes points at least partly as a function of one or more particular action items not been performed within a predetermined period of time.

36-38. (canceled)

39. The system of claim 30, wherein more points are given for completion of elements of a user's estate plan that have a higher priority than are given for completion of other elements of the estate plan that have a lower priority.

40. The system of claim 30, wherein both actual total points and maximum total points are calculated for a user's estate plan.

41. The system of claim 40, wherein possible estate plan elements that are not applicable to a particular user are not included in the calculation of the maximum total points for the particular user's estate plan.
